(19) United States
(12) Patent Application Publication
(10) Pub. No.: US 2016/0085955 A1
(43) Pub. Date: Mar. 24, 2016

(54) Secure Storing and Offline Transferring of Digitally Transferable Assets

(71) Applicant: Sergio, Demian LERNER, Capital Federal (AR)

(72) Inventor: Sergio Demian LERNER, Cuidad de Buenos Aires (AR)

(73) Assignee: Doosra, Inc., Austin, TX (US)

(21) Appl. No.: 14/890,396

(22) PCT Filed: Jun. 10, 2014
(86) PCT No.: PCT/US2014/041802

§ 371 Date: Nov. 10, 2015

Related U.S. Application Data
(60) Provisional application No. 61/833,239, filed on Jun. 10, 2013.
(60) Provisional application No. 61/904,464, filed on Nov. 15, 2013.

(51) Int. Cl. G06F 21/34; G06F 21/45

(52) U.S. Cl. CPC G06F 21/34; G06F 21/45

(57) ABSTRACT

A handheld electronic device enables securely transferring control of a valuable asset associated with a code. The device includes a processor, non-transitory data storage, and a communication component configured to transmit data external to the device. A case houses the components, and is mechanically tamper evident. Software stores within the data storage at least one code, prevents transmission of any code through the communication component without authorization by the user, invalidates the association of a particular code with respect to a particular asset when the software carries out at least one of (i) authorizing transmission of the particular code, and (ii) authenticating a valid transaction using the particular code and authorizing transmission of the digital signature through the communication component.

### CROSS REFERENCE TO RELATED APPLICATIONS

This application claims the benefit of related U.S. Patent Application No. 61/904,464 filed Nov. 15, 2013, entitled METHOD AND APPARATUS FOR ATTESTATION OF COMPUTING DEVICES, and U.S. Patent Application No. 61/833,239 filed Jun. 10, 2013, entitled METHOD AND APPARATUS FOR SECURE STORAGE AND OFFLINE TRANSFER OF DIGITALLY TRANSFERABLE ASSETS, the contents of each of which are hereby incorporated by reference.

### FIELD OF THE DISCLOSURE

The disclosure relates to a method and device for secure digital storage of asset rights, and in particular the transfer of those assets rights from one party to another party.

### BACKGROUND OF THE DISCLOSURE

The problem of tracking and trading assets by means of a physical object has been extensively studied and dates back to the origin of money. The history of money concerns the development of means of carrying out transactions involving a physical medium of exchange, where money is any clearly identifiable object of value that is generally accepted as payment for goods and services. Many things have been used as medium of exchange in markets including, for example, livestock and sacks of cereal grain, things directly useful in themselves, precious metals, coins and banknotes.

Banknotes have many advantages, such as a reduced manufacturing costs, but also have disadvantages, such as wear costs and transport costs. A system for transferring money without transferring a physical object include credit cards. With the advent of the Internet, several systems for paying remotely were developed, such as Paypal, which allowed transactions to be performed using a pre-existing standard monetary units.

The appearance of virtual currencies has resulted in the creation of new units of account. A virtual currency that can be bought with and sold back for legal tender is called a convertible currency. It can be centralized as in Linden Dollars in the online virtual economy of Second Life or decentralized, as for example Bitcoin. In both cases, the owner of each asset is managed by an asset tracking system. The owner needs not be an identified individual and each asset is associated with a code, so the real entity owning the asset may remain anonymous. A cryptocurrency (also called peer-to-peer currency) is a virtual currency which can be traded by using cryptography, and the use of digital signatures. With digital signatures the transfer of the asset is allowed by the owner by signing a specific message (called a transaction) with a private-key, and making the message and the signature available to the asset tracking system.┐

### SUMMARY OF THE DISCLOSURE

In an embodiment of the disclosure, a handheld electronic device usable by a user for securely transferring control of a valuable asset associated with a code, comprises at least one computing processor; non-transitory data storage connected to the at least one processor; at least one electronic communication component configured to transmit data external to the device, the at least one electronic communication component communicative with the at least one processor; a case configured to house the at least one processor, the data storage, and the at least one communication component, the case configured to be mechanically tamper evident; software stored within the data storage and executable by the processor, the software configured to: store within the data storage at least one code; prevent transmission of any code of the at least one code through the at least one communication component without authorization by the user; invalidate the association of a particular code of the at least one code with respect to the particular asset when the software carries out at least one of (i) authorizing transmission of the particular code through the at least one communication component, and (ii) authenticating a valid transaction using the particular code and authorizing transmission of the digital signature through the at least one communication component.

In various embodiments thereof, the software is further configured to store a particular one of the at least one code in the non-transitory data storage, in response to the computing device receiving a message that proves that a particular asset is associated with the particular code in a secure external asset tracking system; when the software invalidates an association of a code with an asset, the associated code is erased from non-transitory storage; the non-transitory memory is further configured to store information pertaining to an asset that is associated with a particular code; at least one of the at least one code is a private-key, and authenticating is carried out by digitally signing with the private-key; at least one of the at least one code is a private-key, and wherein the software is further configured to sign a message which is not a valid transaction to determine a relationship of a public-key and the private-key, without revealing the private-key; the non-transitory memory is further configured to store a public-key identifying a trusted key pair issuer, and the software is further configured to use the public-key to verify the authenticity and enable loading of a new trusted key-pair, associated with an asset, provided by the trusted key pair issuer in encrypted form; the software is further configured to generate a new key-pair randomly or pseudorandomly, privately, to be associated with one or more external assets, the private-key of the key-pair constituting one of the at least one code; the software is further configured to associate one code of at the at least one code with an asset, using proof data that the asset has been associated with the code in an external asset tracking system; and/or the software is further configured to provide a software attestation function.

In other variations thereof, the at least one processor, the data storage, and the at least one communication component within the case are immersed in a transparent material that becomes solid during the manufacturing process; the randomized physical features include at least one of scratches, colored threads, and colored particles; the randomized visible physical feature is configured to be rendered, as a part of the manufacturing process, into at least one storable image after the transparent material becomes solid, the stored image thereby useable to uniquely identify the contents of the case; the software is further configured to enable external validation of the stored private-key by digitally signing a message which is a not a valid transaction using the private-key related to the public-key, and providing access to this signature using the at least one communication component; the device further includes a display responsive to a signal from the at least one processor, the display configured to display information pertaining to an asset associated with one or more of the at least one code; the case encloses an image indicative of an asset associated with at least one of the at least one code stored in the non-transitory memory, and where the device further includes an indicator configured to indicate if the asset is currently associated with the code; the device further includes a photovoltaic cell housed within the case and configured to power the data storage, computing, and at least one communication component; and/or the device further includes a NFC transceiver, connected to the computing device, and configured to power the data storage, computing, and at least one communication component using power supplied from an NFC RF signal.

In a yet further variation thereof, the software is further configured to: a) generate a first key-pair using a random or pseudo-random number generator; b) communicate the public-key external to the device; c) receive a random or pseudo-random number generated external to the device; d) transform the private-key of the key-pair using the received random or pseudo-random number; and e) associate the transformed private-key with an external asset.

In other variations thereof, the case is transparent; the valuable asset is legal tender; the case is configured to be tamper evident by sealing the at least one processor, data storage, and at least one communication component whereby mechanical contact with any portion of the at least one processor, the data storage, and the at least one communication component not extending to an exterior of the housing would be visibly evident; the software is further configured to provide information through the at least one communication component pertaining to the valuable asset; a public-key is created which corresponds to the private-key that is each of the at least one code; at least one of the at least one code corresponds to a cryptographic private-key; the software is further configured to authenticate itself by providing a copy of the loaded software upon demand in less time than a predefined time limit; the non-transitory memory is configured to store a message signed by a certification party, where the message identifies unequivocally a block-chain block; an asset is an unspent transaction output; the unspent transaction output corresponds to a Bitcoin transaction; the display information corresponds to an amount of money; invalidating an association of a particular code comprises modifying data stored in the data storage; the proof data comprises a transaction that associates a code with an asset, a Merkle branch of a Merkle tree whose leaf node uniquely identifies the transaction, and a block chain header which uniquely identifies the Merkle tree root; the proof data comprises a certification signed by a trusted party; the device further includes a button associated with the case, the button configured to signal the at least one processor regarding an authorization by the user; and/or invalidating the association further includes, for (i) transmitting the particular code, and for (ii) transmitting the digital signature.

In still further variations thereof, the transparent material is selected from the group consisting of: an olyester (PET), a polyimide (PI), a polyethylene napthalate (PEN), a polyetherimide (PEI), a fluropolymers (FEP), and a copolymer polyimide film; a randomized visible physical feature configured during the manufacturing process is additionally immersed; digitally signing is carried out with any of the asymmetric signature schemes: RSA, DSA, ECDSA, Lamport, Merkle, Rabin, ElGamal, BLS, Schnorr, Pointcheval-Stern; authenticating is carried out with a Message Authentication Code using at least one of the at least one code as the key; at least one of the at least one code is transmitted to an external asset tracking system in order to transfer control of an asset; the non-transitory memory is further configured to store a public-key associated with the private-key; providing information includes providing information pertaining to whether a particular code of the at least one code is associated with a particular asset.

In another embodiment of the disclosure, a method for securely transferring control of a valuable asset associated with a code, comprises using at least one computing processor, the at least one processor configured to execute software stored on non-transitory data storage, the at least one computing processor communicatively connected to at least one electronic communication component configured to transmit data external to the device, the at least one processor, the data storage, and the at least one communication component housed by a case configured to be mechanically tamper evident, the software configured to: store within the data storage at least one code; prevent transmission of any code of the at least one code through the at least one communication component without authorization by the user; provide information through the at least one communication component pertaining to the valuable asset; invalidate the association of a particular code of the at least one code with respect to the particular asset when the software carries out at least one of (i) authorizing transmission of the particular code through the at least one communication component, and (ii) digitally signing a valid transaction using the particular code and authorizing transmission of the digital signature through the at least one communication component.

In a further embodiment of the disclosure, a handheld electronic device usable by a user for securely transferring control of a valuable asset associated with a code, comprises at least one computing processor; non-transitory data storage connected to the at least one processor; at least one electronic communication component configured to transmit data external to the device, the at least one electronic communication component communicative with the at least one processor; a case configured to house the at least one processor, the data storage, and the at least one communication component, the case configured to be mechanically tamper evident; a display responsive to a signal from the at least one processor, the display configured to display information pertaining to an asset associated with one or more of the at least one private-key; software stored within the data storage and executable by the processor, the software configured to: store within the data storage at least one private-key corresponding to the code for each asset to be securely transferred; prevent transmission of any private-key of the at least one private-key through the at least one communication component without authorization by the user; provide information through the at least one communication component pertaining to the valuable asset; invalidate the association of a particular private-key of the at least one private-key with respect to the particular asset when the software carries out at least one of (i) authorizing transmission of the particular private-key through the at least one communication component, and (ii) digitally signing a valid transaction using the particular private-key and authorizing transmission of the digital signature through the at least one communication component and the digital signature is thereby transmitted.

In a variation thereof, the asset is an amount of money.

### BRIEF DESCRIPTION OF THE DRAWINGS

A more complete understanding of the present disclosure, and the attendant advantages and features thereof, will be more readily understood by reference to the following detailed description when considered in conjunction with the accompanying drawings wherein:

FIG. 1 shows an embodiment of the disclosure including an asset control transfer device, referred to herein as “FirmCube”.

FIG. 2 shows a flowchart for a protocol of the disclosure for an asset control transfer device of the disclosure termed herein as ‘Firmcoin’, to prove the association of an undisclosed private-key.

FIG. 3 shows a flowchart for a protocol of the disclosure for the Firmcoin to prove that the loaded firmware and non-private memories are authentic using firmware decompression at start-up.

FIG. 4 shows a flowchart for a protocol of the disclosure to detect cloned tokens using random features introduced during manufacturing.

FIG. 5 shows a flowchart for a protocol of the disclosure to track potentially counterfeit Firmcoins by detecting assets associated with more than one Firmcoin.

FIG. 6 shows a flowchart for a protocol of the disclosure to allow users to securely load new assets into a device without requiring a connection to the issuer, by providing the device a proof that the assets have been associated with the device public key.

FIG. 7 shows a flowchart for a protocol of the disclosure to extract the private-key associated with an asset and at the same time (as an atomic operation) invalidate the device association with the asset.

FIG. 8 shows a flowchart for a protocol of the disclosure to allow the device to build a signed transaction that transfers the associated assets to the destination address provided by the user.

FIG. 9 shows an alternate embodiment of the disclosure, in which the device has a photovoltaic cell which harvests energy from a light source in order to power the microcontroller, and an indicator LED.

FIG. 10 shows an alternate embodiment “FirmBanknote”

FIG. 11 shows an alternate embodiment “FirmChip”

FIG. 12 shows a roulette table providing NFC communication with a computer.

FIG. 13 shows an alternate embodiment “FirmChip” with embedded battery, which can be queried through Bluetooth BLE.

FIG. 14 illustrates a computing system including components that can be used to carry out the disclosure.

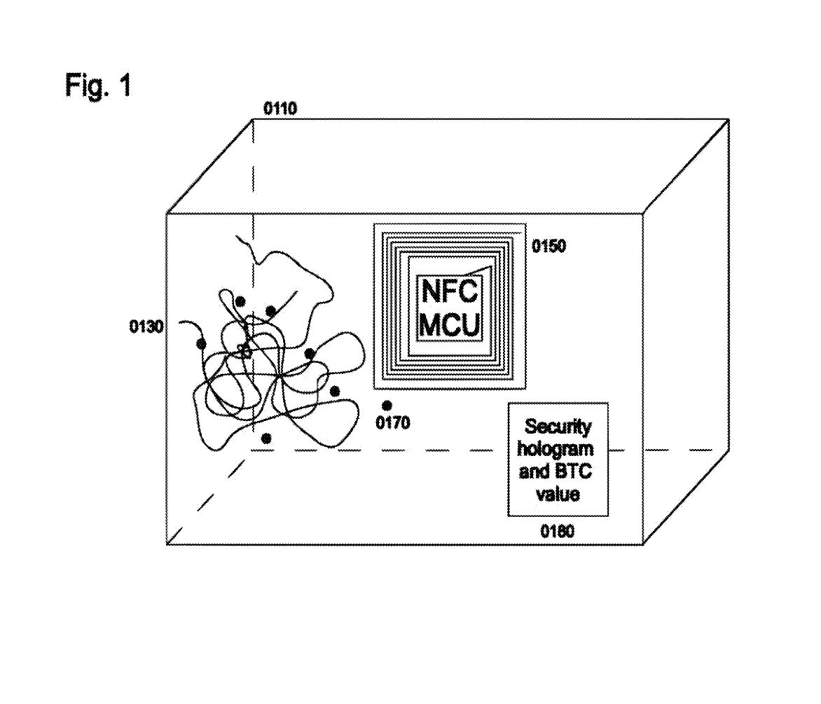

### DETAILED DESCRIPTION OF THE DISCLOSURE

As required, detailed embodiments are disclosed herein; however, it is to be understood that the disclosed embodiments are merely examples and that the systems and methods described below can be embodied in various forms. Therefore, specific structural and functional details disclosed herein are not to be interpreted as limiting, but merely as a basis for the claims and as a representative basis for teaching one skilled in the art to variously employ the present subject matter in virtually any appropriately detailed structure and function. Further, the terms and phrases used herein are not intended to be limiting, but rather, to provide an understandable description of the concepts.

The terms “a” or “an”, as used herein, are defined as one or more than one. The term plurality, as used herein, is defined as two or more than two. The term another, as used herein, is defined as at least a second or more. The terms “including” and “having,” as used herein, are defined as comprising (i.e., open language). The term “coupled,” as used herein, is defined as “connected,” although not necessarily directly, and not necessarily mechanically.

In accordance with the disclosure, all previously known intents of storing virtual currencies in money-like objects have failed because either they were insecure to double-spends or required the users to be online connected to at least one asset tracking node of the asset-tracking system. Examples include smartcards, Bitbills, and Casascius coins.

The present disclosure addresses these problems by providing a token that:

a) can temporarily hold the rights for assets (tangible, intangible or even fiat),

b) can be traded off-line

c) allows the assets to be transferred to an external storage account (for example to a Bitcoin address, an web-wallet, or a bank account) without the need of physically transporting the token (exchanged asset).

This disclosure relates to a method and apparatus (herein alternately a Hard-ECoin, or FirmCoin) for secure digital storage of asset rights (which can be tangible or intangible) and the transfer of those assets rights from one party to another party without the requirement of an Internet connection nor any other network connection to an external computer handling the accounting of asset rights ownership. The transfer of an asset rights is carried by just physically delivering the Firmcoin to the receiving party. This gives the advantage of banknotes to electronic money (such as more anonymity) and presents new challenges related to counterfeit Firmcoins that are not present in attempts to use personal computing devices as transmitters of the asserts by means of communication. The Firmcoin behaves as a bearer instrument, being impersonal, and not as a personal object, such as a credit card or a PIN protected smart-card, which is associated with personal information pertaining to the presenter, such as an identification of the presenter.

In one possible implementation, a centralized virtual currency can be traded by sending to the asset tracking system a transaction authenticated with a private key by means of a Message Authentication Code (MAC) algorithm which produces an authentication tag, and the Firmcoin can store a MAC private key associated with the currency, and the MAC private key is unique for each Firmcoin.

In another possible implementation, the Firmcoin can securely and privately generate, hold, prove ownership, and deliver private-keys and public keys of an asymmetric signing scheme (like RSA, DSA, ECDSA, RSAL, or Schnorr) where the public keys identify assets in an system that tracks owners of those assets (like Bitcoin or Ripple), and where the private-keys allow these assets to be transferred to another party (generally by digitally signing special documents that allow the transfer to take place). The digital signature being a special case of an authentication tag. The assets related to a key-pair can be very diverse, such as crypto-currencies, tangible property, licenses, commodity certificates, smart property, and other financial instruments such as stocks and bonds, and the only requirement is that those assets can be transferred by digitally signing a message using a private-key associated with the asset.

In another possible implementation, the Firmcoin can receive an encrypted secret message from a central authority which commands the Firmcoin to be associated with an asset. The message contains a code, such as a private-key, which need not be a key for an asymmetric signature scheme, but just a secret data. The Firmcoin verifies the authenticity of the message before establishing the association. The user can command the Firmcoin to send him a second message containing the private-key which allows the user to claim for the associated asset in an asset state tracking system, and the Firmcoin then destroys the association of this asset by modifying its non-volatile memory.

A possible implementation of the disclosure is an electronic token that is associated with some assets, the electronic token being able to be traded physically, like fiat money, a coin, a bill, a bond, or a stock certificate, in order to trade the associated asset. As is needed with a bill, the Firmcoin has security measures to detect counterfeit tokens, tampering and non-evident modification of internal components or external imprints. But unlike a bill, the same token can be associated with different assets at different times or it can be associated with multiple assets simultaneously, without breaking the security protections. The association to an asset is realized by storing a private-key which controls that asset. In further distinction to a bill, any user holding a Firmcoin can transfer an asset currently associated with the Firmcoin to his own account and/or account of a different party by commanding the token to extract a private-key, or commanding the token to sign a transaction with a private-key. The user can also command the token to generate a new private-key-pair, in order to load a new asset association, without requiring the issuer of the Firmcoin to verify or approve the change.

In another embodiment of the disclosure, a Firmcoin can support protocols so that the user can load low-value assets into the Firmcoin without asking the issuer, but the Firmcoin must be remotely authorized by the issuer to hold a high-value asset. Also the Firmcoin can support protocols so that it can be remotely certified by the issuer that the asset associated with a certain Firmcoin was verified by the issuer to be associated with this Firmcoin only, as an additional protection measure against double-spends, specifically, transferring all or the same portion of the asset to two different parties to each hold simultaneously. This can give Firmcoin holders higher confidence that another copy of a private-key held in a Firmcoin does not exist apart from the code or private-key within the Firmcoin.

Firmcoin can be implemented in a variety of physical objects, such as smart cards, flexible electronics, transparent thin plastic film with embedded electronics (herein “FirmBanknote”), paper with an embedded microchip, coins, chips (herein “FirmChip”), and solid cubes (herein “FirmCube”). Additionally, apart from the disclosure, which is based on an electronic device, there is no prior art of any physical solution (paper, plastic, etc.) that can achieve the anti-counterfeiting measures and at the same time provide the ability to change the asset associated with the object, as a Firmcoin can do. Viewed in the perspective of fiat money (a government issued currency), this would be akin to converting a legitimate one dollar bill into a legitimate one hundred dollar bill, upon the payment of the differing amount of 99 dollars to the bill itself.

Accordingly, the disclosure provides a method and apparatus for secure storage and transfer of digitally transferable assets, using an electronic device, offering a very high level of security and at the same time is low cost and being highly convenient to use.

The Firmcoin can include these properties:

a0) comprise a computing device;

a1) allow external communication to the computing device;

a2) prevent passive communication attacks;

a3) prevent active communication attacks;

a4) prevent the impersonation of the firmcoin in communications;

a5) be durable;

a6) not have mechanical parts;

a7) be smooth;

a8) be clean;

a9) be ecosystem-friendly;

a10) comprise a protected non-volatile memory to store secrets;

a11) be cheap to manufacture;

a12) be portable;

a13) reduce the attack surface for side-channels.

a14) allow only authorized commands; and/or

a15) be tamper-evident

Th Firmcoin can further:

P1) store one or more asset private-keys in a tamper-evident way;

P2) store the asset public keys;

P3) clearly indicate to users if the Firmcoin is associated with an asset;

P4) clearly indicate to users the assets associated with the Firmcoin;

P5) allow users to extract an asset private-key from the Firmcoin such that Firmcoin shows clear evidence that the assets associated with the extracted asset private-key are no longer associated with the Firmcoin;

P6) allow the creation of a valid transaction signature of a transaction that transfers all or a part of an asset controlled by an asset private-key to a destination address provided by the user and show clear evidence that the asset transferred is no longer associated with the Firmcoin;

P7) send to the user a proof possession of an asset private-key associated with a public key;

P8) generate a new private/public key-pair;

P9) accept an external key-pair created by the Firmcoin issuer, verify its authenticity and store the corresponding asset private-key in non-volatile memory;

P10) store third party certifications of asset associations;

P11) receive a message that intends to prove that a private-key stored in non-volatile memory has an asset associated in the external asset-tracking system, verify this message and if considered enough proof (with enough confidence), store it in non-volatile memory or show a clear indicator that such a proof was found to be correct (or both);

P12) provide a software attestation system;

P13) provide physical authentication measures;

P14) provide hardware attestation methods to enable users to detect if the Firmcoin is authentic by its logical properties; and/or

Following is described how the foregoing properties are implemented, in accordance with the disclosure.

A0) Comprise a computing device

A computing device is required to manage the storage of asset private-keys, and particularly to manage a private-key protection logic which allows disclosure of the asset private-key only after the system has switched to a state indicative of not being associated with such asset private-key. This computing device could be a microprocessor, a microcontroller, an FPGA, an ASIC or other kind of computing device. It could also be part of the controller of a non-volatile memory.

A1) Allow external communication to the computing device

The Firmcoin can allow users to communicate with the internal computing device by means of an electric, RF, inductive, magnetic, auditory, tactile or any other suitable means of communication. Preferably the communication should allow the transfer and reception of digital information to an external computer, such as a PC, a smart-phone, or other electronic gadget or a wearable device.

A2) Prevent passive communication attacks

The Firmcoin should prevent eavesdropping of a communication with the computing device (passive-attacks) for at least certain communications. During the process of extracting an asset private-key, it is important that no attacker can eavesdrop the communication and grab a copy of the asset private-key. One possibility to achieve this is by establishing a secure encrypted communication channel, using a method that withstands passive attackers. This is commonly achieved using Diffie-Hellman (DH) key exchanges or ECDH.

A3) Prevent active communication attacks.

The Firmcoin should prevent the modification of messages, or insertion of messages, or replay old messages of a communication with the computing device (active-attacks) for at least certain communications. This is achieved by a secure encrypted and authenticated communication channel, such as the channels provided by the SSL/TLS protocol.

A4) Prevent the impersonation of the Firmcoin in communications.

One way to attempt to impersonate the Firmcoin would be to carry out a man-in-the-middle attack such that the user believes he is communicating with the Firmcoin but in fact he is not. One prevention is to make the Firmcoin enclosure transparent, and make the communication means very short range (e.g. physical contact or NFC). This way the user can check that no other antenna or counterfeit component is attached to the Firmcoin and be assured that he is communicating with the correct computing device.

A5) It should be durable

It should use components that have a long life-time, such as more than 3 years. A 30-year life-time can be achieved. For example, electrical contacts may wear off, and so they may not be a good choice. Using RF for communications may imply a more durable Firmcoin. Generally, the fewer the components, the lower the risk of malfunction. Also having all components be embedded in a solid enclosure (without internal free space), helps to protect components from shocks and tampering.

A6) Do not have mechanical parts

Mechanical parts may break after repeated use.

A7) Be smooth

The Firmcoin should have smooth surface or at least a shape without any bump that can get hooked into other objects. Since the Firmcoin will be handled and treated as cash, it must withstand drops, hits, shocks and being washed with water and cloths. A smooth surface may protect the Firmcoin (and the cloths), and reduce staining and obfuscation of the contents within a transparent case or housing.

A8) Be Clean

It should prevent the passing of bacteria and viruses when transferring the Firmcoin from one party to another party. A sealed design with no holes and no electrical contacts which might leak fluids to the interior would enable the Firmcoin to be washed or even sterilized.

A9) Be ecosystem-friendly

It should not have a type of battery whose careless disposal may be dangerous to the ecosystem. Preferably it should not have a battery at all.

A10) Comprise a protected non-volatile memory to store secrets.

Non-volatile memory could be accomplished by Flash memory, or other passive memory, or by a low consumption battery-powered memory. The memory could be embedded in the microcontroller or be separate, although being embedded may be preferable since it reduces the chances of an attacker being able to tamper with the communication bus.

A11) Be cheap to manufacture

The cost of the Firmcoin should be low compared to the cost of the asset whose rights are being stored. Preferably the Firmcoin should cost less than 1% of the assets associated, although the Firmcoin could cost more than the stored asset. This is because the payee can return to the payor another empty Firmcoin when a payment is made, compensating the cost of the physical object.

A12) Be portable

Portability can be achieved by manufacturing the Firmcoin as a small cube, a coin, a stamp, a banknote or a card shaped object. The Firmcoin can be small enough to be easily carried by hand by people of all sizes and strengths; for example a plurality of Firmcoins can be easily held by a single hand.

A13) Reduce the attack surface for side-channels

Electrical contacts accessible from outside of the Firmcoin, while usable in accordance with the disclosure, can be disadvantageous if connected to the computing component or processor. Electrical contacts can be used to measure power consumption of the computing device and the computing device could be probed in order to reveal the asset private-keys while they are accessed. This should be considered in conFIG.uring exterior electrical contacts, which, for example, can be configured to only connect to a communication device. Similarly, buffering or other means can be used to mask electronic processes within the Firmcard.

A14) Allow only authorized commands

A device of the disclosure can prevent an attacker from sending critical commands to the computing device without a proper authorization. For example, the Firmcoin can prevent requesting the revelation of a private-key from a long distance using a powerful antenna. The protection can be accomplished by adding to the Firmcoin a physical input interface, such as buttons. As an example, two buttons can be required to be pressed in a specified sequence to allow critical commands to be accepted by the Firmcoin. Capacitive buttons would provide this ability and prevent mechanical wear and maintain a fully sealed Firmcoin design.

A15) be tamper-evident

The device of the disclosure should resist some intents to induce hardware fault attacks such as an attacker changing temperature above or below the normal operating temperature of the device, or by changing voltage levels, or using electromagnetic radiation, light or lasers. This is generally done by parallel and redundant computations, blinding in arithmetic operations and protection of program flow with program flow fingerprints. For those attacks intents not resisted, the device of the disclosure should leave evidence (a fault detection mechanism). For example, if a hardware fault is detected (such an error in memory parity bits or an error in a an integrity check stored in memory) the device retains evidence and the presence of the evidence is informed to the user. For example, in a display. Internally the evidence can be the memory error itself (error not corrected) or a flag stored in non-volatile memory, or a flag stored in write-once memory. The evidence need not to be logical, but can physical. For example, a non-reversible record of out-of-range exposure to temperature in an chemical strip embedded in the device case.

P1) Store one or more asset private-keys in a tamper-evident way

One option is to use a smart-card type micro-controller, which generally has tamper-proof non-volatile memory embedded, in the Firmcoin. Smart-cards are generally protected against timing, RF and power side-channels, which would be beneficial for the Firmcoin.

Nevertheless smart-card micro-controllers can be expensive compared to alternative low-cost microcontrollers. Another option is to use a low cost and low power micro-controller having internal flash or EEPROM memory, and communicating using RF with the user's personal computer. The micro-controller and exposed buses can be shielded with semi-transparent RF shielding (as in a Faraday cage), and filtering the antenna for EM emissions in the frequency ranges where the microcontroller operates. If RF emissions are still detectable, the firmware can be particularly designed to prevent the leakage of private-key data by performing the private-key related operations at random intervals, and to limit the amount of private-key operations that can be done for each private-key stored.

The private-key associated with the asset is prevented from being externally accessible through the communication interface by means of a logic barrier (a program) or a hardware barrier (a circuit). The barriers can be lifted by the computing device.

P2) Store the asset public keys

This can be done electronically (e.g. in a non-volatile memory) and/or physically (e.g. in a QR code or in text). The asset public-keys are the public keys related to the asset private-keys stored in non-volatile memory. An asset private-key is a private-key that controls (totally or partially) one or more asserts in an external assert-tracking system. A total control means that the private-key by itself allows the transfer of an asset rights. A partial control means that the asset private-key controls the transfer of the assert rights in conjunction with other asset private-keys, but the other asset private-keys by themselves (even used together) cannot control the transfer of the asset rights. It can be the case that one asset private-key controls many asset rights, for example, a single Bitcoin related private-key can control many transaction outputs, each one representing a different amount of Bitcoins.

If the Firmcoin is holding one or more assets associated with a single private-key, the related public key can be shown as a QR code in a display in the Firmcoin. This allows easily checking the existence of the asset association by taking a photograph with a smart-phone. The scanner public key can be looked up in a database of funded public keys already present in the payee's PC/Smart-phone or the payee can access the asset-tracking system with the PC/smart-phone over an Internet connection to check the funds associated with the public key. If the Firmcoin is able to store many different private-keys, then the different public keys may be available one at the time at the display, allowing switching them with a button or switching them automatically at regular intervals. The public keys can also be stored in the non-volatile memory of the Firmcoin and read by the user by sending to the Firmcoin a query command.

A Firmcoin could use a single private-key and never reveal it (only sign transactions and associate it with new assets). Then the public key associated with the private-key could be hard printed in the Firmcoin, either as text or as a QR code. But this Firmcoin would provide lower security, since a malicious user could try to retrieve the private-key from the Firmcoin in order to be able to steal the asset rights of any asset loaded in the future to that Firmcoin. Also it provides lower privacy, since a user may track future uses of the same Firmcoin after having transferred it. However, this method can be of lower cost or complexity to implement, and can still be useful, particularly for lower value assets.

P3) Clearly indicate to users if the Firmcoin is associated with an asset

A Firmcoin is associated with an asset if it is storing in non-volatile memory the asset private-key. The fact that the Firmcoin private-key is associated with an asset can be made evident to the user, in accordance with the disclosure, in a variety of ways, including using an active LCD display, a liquid-crystal segmented display, a passive display (e-ink), or a LED or a mechanical indicator. The indication can be a single Boolean signal or a signal having additional information. It can also be indicated as a sound played on user request, or advertised wirelessly so that a smartphone can receive the signal and show in its display when the user slides the Firmcoin near the smartphone. Also the signal can be interpreted by an augmented reality display, and projected virtually over or near the Firmcoin.

If the device itself indicates the association with an asset by an active display or LED, then the device can either power the display by an internal battery or harvest power from a photovoltaic cell included within or attached to the device.

The indication could also be auditory, visual, and tactile or via electronic communication. It can also be broadcasted by NFC, WiFi or Bluetooth (or other RF mode) as long as the message allows the secure pairing with the device by, for example, including a device identification number in the message, however another electronic device is required to verify the broadcasted message.

P4) Clearly indicate to users the assets associated with the Firmcoin

The asset description can be a monetary amount (if the asset is money) or a short description of the asset. For example, in case the asset is some company's shares, the name of the company and the amount of shares may constitute the description. If the asset is a car, the legal identification of the car, such as the VIN, registration or license number, may constitute a description.

The asset can be fixed, for example “100 BTC” or it can be dynamic. In the former case, the asset description can be printed in the Firmcoin. In the later, a display should show the asset description continuously or at user request. As the previous property, the indication can be of several kinds. A possible approach is to use a modulated visual or infra-red signal transmitting the information (e.g. amount, name) of the assets, so that the indication can clearly be seen with augmented reality systems over the Firmcoin. The user is then able to clearly verify the asset amount using an augmented reality display, such as a Head-mounted, Eyeglasses, Contact lenses, vitual retina, EyeTap, standard LCD, or other displays. The system would project this information right over the Firmcoin.

Further, one of the following two properties, P5 or P6, can enable the user to control the asset in the asset-tracking system.

P5) The Firmcoin should allow users to extract an asset private-key from the Firmcoin such that Firmcoin shows clear evidence that the assets associated with the extracted asset private-key are no longer associated with the Firmcoin.

Extracting a private-key is the process by which an asset private-key stored on the non-volatile memory is made available to a user. This can be done by enabling the user to read part of or all the non-volatile memory, or by sending the private-key over the communication channel. For a Firmcoin that can be associated with a single asset, this means that the extraction of the asset private-key must at the same time (as in an atomic operation, either by software or hardware means) make the Firmcoin enter a new special state “empty”, and this is advantageously clearly visible to the users, for example, clearing a passive e-ink dot, or turning off a LED. If the Firmcoin is storing a single private-key, then an “empty” state would be shown. If the Firmcoin is storing more than one asset's private-keys, and all the asset private-keys stored are associated with the same kind of measurable asset, such as a certain virtual money currency, then the indication may be an LCD display that summarize the amount of the asset still associated. Here the atomic operation of extraction and asset association breakage is not meant to be restricted to an operation occurring in a single machine instruction, since the extraction is a process of communication that is not generally performed in a single instruction. Generally atomicity is done by a software, which is that if any part of the private-key is communicated, then the asset association is also broken, and the Firmcoin prevents the first action to be performed without the second taking place. One way to achieve this is by first breaking the asset association, and then communicating the private-key. This allows the repetition of the communication step if a previous communication attempt fails.

P6) Allow the creation of a valid transaction signature of a transaction that transfers any or all or a part of an asset controlled by an asset private-key to destination address provided by the user and shows clear evidence that the assets transferred are no longer associated with the Firmcoin.

The Firmcoin can receive a destination address (valid in the asset-tracking system) supplied by the user, and additional information required to create a valid transaction signature, e.g. in Bitcoin, the parent transactions, or meta-data. The user would then send the transaction to the asset-tracking system for it settle the change in control or ownership of the asset. As in the previous property, if the Firmcoin can be associated with a single asset, it then enters a special state “empty” clearly visible to users of the device, where signing the transaction and entering the “empty” state as is an atomic operation in the context of software. The special state “empty” may last forever, or until a new private-key is generated in the token, or until some amount of time elapses. There also may be a timed intermediate state “wiping” before entering the state “empty”, while the device may accept repeated requests to perform the same operation (extracting the private-key or signing a transaction to a preestablished destination address) because previous attempts may have failed. The intermediate state “wiping” may have a timeout and afterwards the device enters the “empty” state automatically. Going into the “empty” state may include an automatic device reset, the wiping the private-keys associated with the delivered asserts. To support timeouts the Firmcoin can have a real-time clock.

If the Firmcoin is storing private-keys for more than one asset, and all the asset private-keys stored are associated with the same kind of measurable asset, a cumulative balance amount corresponding to all of the assets may be shown using a display or indicator.

A device of the disclosure can provide additional benefits and attributes, as follows:

P7) Send to the user a proof possession of an asset private-key associated with a public key

This enables users to challenge the Firmcoin (preferably in zero knowledge) for the possession of an asset private-key associated with a user supplied public key. The signing of a message which cannot be reused and that is not a valid transaction may serve this purpose.

One possible protocol to do this is as follows: 1) The verifier sends a short message to the device. 2) The device appends to the message a fixed message provided by the issuer, for example a unique serial number. If the message is a serial number, this number could be printed or embedded in the device package for additional security. 3) The device hashes the resulting message with a cryptographic hash function and signs this hash using the stored private-key (the hash is part of the signing function in some signature algorithms). 4) The user verifies the signed message using the public key he already has.

P8) Generate a new private/public key-pair

This would enable users to force the Firmcoin to generate a new private/public key-pair, in order to associate an asset to the stored private-key at a later time. If the asset is a monetary asset, then this association is similar to a “recharge”. The protocol to generate a key-pair for an asymmetric signature scheme is always part of the signature scheme standard. Other secure protocol variations can include: 1) The Firmcoin generates a new key-pair securely using a random or pseudo-random number generator. 2) The Firmcoin sends the public key to the user. 3) The user transforms the public key using a privately generated random number. 4) The user sends this random number to the Firmcoin. 5) The Firmcoin applies the same transformation to the public and private-key, replacing the previous key-pair. At the end of the protocol, the user is assured that the issuer cannot have manipulated the device in order to generate key-pairs in a manner predictable to the issuer.

The transformation method depends on the signing scheme, and it may be multiplication by a scalar value in modular arithmetic. Also, for signing schemes like ECDSA, the protocol may be as follows: 1) The Firmcoin generates a new key-pair. 2) The user generates a new key-pair. 3) The users sends this key-pair to the Firmcoin. 4) The Firmcoin add both key pairs (Firmcoin private-key added to user private-key, and Firmcoin public key added to user public key). 5) The Firmcoin replaces the previous key-pair with the composed key-pair.

Another possibility is as follows: 1) The Firmcoin generates a new key-pair. 2) The user generates a random number. 3) The user sends this random number to the device. 4) The Firmcoin multiplies both the private and public key with this user supplied random number, and replaces the previous key-pair with the new one. For any of these proposals, it is better that after the first key-pair is chosen, the Firmcoin is committed and not made available to the user until the user has chosen the random number or second key-pair. The firmcoin would open the commitment after receiving the user random number or second key-pair, and the user would check the commitment correctness.

P9) Accept an external key-pair created by the Firmcoin issuer, verify its authenticity, and store the corresponding asset private-key in non-volatile memory

This enables users to associate a new asset to the Firmcoin by connecting another computer to the Firmcoin issuer, receiving from the Firmcoin issuer a new key-pair that has already been associated with an asset in the asset-tracking system, and sending this key-pair to the Firmcoin. If the asset is a monetary amount, then this corresponds to unspent funds. The key pair is then transferred to the Firmcoin locally. The key-pair is sent by the trusted issuer in encrypted form, using an encryption private-key known to the Firmcoin, but prevented from being disclosed to the user, and is not shared with other Firmcoins manufactured by the Firmcoin issuer.

This can be done by the following protocol: 1) The user pays the issuer for some assets. 2) The user allows the Firmcoin to connect securely to the issuer by providing an Internet connection. 3) The issuer sends a signed and encrypted message containing a new key-pair which is associated with the assets the user has paid for, and the descriptions of the associated assets. 4) The Firmcoin verifies the message and, if it is correct, accepts the new key-pair and accepts descriptions.

P10) Store third party certifications of asset associations

Certifications attest that a certain public key has a certain asset associated at a certain time, generally by digitally signing a message. These allow users to solicit a trusted third party (such as the Firmcoin issuer) additional certifications relating the assets associated with a Firmcoin and store this certifications in the Firmcoin non-volatile memory. Users can then verify if the asset associations of the Firmcoin are certified by the third party or the issuer. To obtain useful certification, the user records the public key related with a private-key stored on the Firmcoin non-volatile memory, and transfers this public key to the third party, which builds the certification and the user then transfers the certification to the Firmcoin, which stores it in non-volatile memory.

This can be done by a protocol in which the Firmcoin device sends and receives messages to and from the issuer securely over a connection provided by the user. The protocol can function as follows: 1) The Firmcoin generates a new key-pair. 2) The user queries the Firmcoin for the public key and loads funds/assets himself, associating them with the Firmcoin public key, using a computer connected to the asset-tracking system. 3) The Firmcoin connects to the issuer and sends its public key. 4) The issuer verifies the funds/assets associated and, if the association is correct, sends a signed message certifying the association, and may also inform the Firmcoin which are the associated assets. 5) The Firmcoin verifies the signed message and if it is correct, enters a special “certified” state which can be view externally or queried electronically.

Another type of third party certification that a Firmcoin can hold could include a certification that a certain block is part of the Bitcoin best chain at a certain time. Certification parties are not required to know the exact transaction the user wants to certify: they certify all transactions in a specified block. One of the possibilities is that certification contains the block hash signed by the certification party. For this possibility, the Firmcoin stores the Merkle branch of the transaction associating the asset with a Firmcoin private-key, and the transaction itself, so the transaction can be traced to the certificate scope.

P11) Receive a message that intends to prove that a private-key stored in non-volatile memory has an asset associated in the external asset-tracking system, verify this message and if it is considered enough proof (with enough confidence) store it in non-volatile/non-transitory memory, or show a clear indicator that such a proof was found to be correct (or both).

This would enable users to securely load new assets into a Firmcoin without requiring a connection to the issuer, by providing the Firmcoin a proof that the assets have been associated with the device public key. For Bitcoin and systems alike, “SPV” proofs may be used. These proofs can be stored in the Firmcoin non-volatile memory and be made available to other users at any later time. The manner of achieving this protocol depends on the asset tracking system. In the case of Bitcoin, a proof that the asset public key (related to an asset private-key stored on the non-volatile memory) is associated with some funds may be constructed by providing the block header of the block which contains the transaction that transfers the funds to the asset public key, along with the hashes of the Merkle branch from the root of the Merkle tree to the leaf (the transaction hash), along with the transaction itself, along with a chain of block headers following the one containing the transaction. If the sum of proof of work in the chain headers is sufficiently high, and the transaction is correct, the device may accept this message as a proof that the transaction was actually a part of the Bitcoin best chain. For example, the threshold may be set so that, if a block reward is 25 BTC, loading N BTC into the device requires that the user shows a valid chain of at least N/25 blocks. Also in Bitcoin it is desirable that the user provides at least 144 block of confirmation, which corresponds to approximately one day. This allows the construction of small cheap and portable devices “FirmVerifiers” without a continuous wireless Internet connection that are able to verify the assets associated with any Firmcoin, by only being connected to the Internet once per day (for example, at night, while at the same time the device recharges its internal batteries). These FirmVerifiers can function with a limited hardward set, including for example a microcontroller/processor, a flash memory, an LED or other indicator, a USB connector or other data transfer mechanism, and an NFC reader or the like.

For other asset tracking systems of the disclosure, a signature of the transaction by a central authority of the system may be sufficient. Still for some other systems, the collection of many signatures of the transaction made by non-colluding parties of a distributed system can be required.

P12) Provide a software attestation system

This enables users to detect if the Firmcoin firmware has been tampered. The system can be software-only or can be hardware assisted. In the next section are presented two possible software attestation methods, one of them hardware assisted, as options for the disclosure.

P13) Provide physical authentication measures

Physical security measures enables users to detect if the Firmcoin is authentic by its physical properties. Any existing tamper-evidence protection can be added to the device to help users verify its authenticity. In accordance with the disclosure, an option includes manufacturing the Firmcoin with non-reproducible random features, for example visible features. Counterfeit Firmcoins can be detected by comparing these features with a database of the features of all Firmcoins manufactured. This is more secure than adding a similar non-reproducible security feature in all Firmcoins (such as a security hologram), while both methods may coexist. An example of the former is to add to each Firmcoin random scratches during manufacturing, photograph the scratches, and upload the photographs to a central and secure database. A user that wishes to verify the authenticity of the Firmcoin can photograph the Firmcoin and compare the taken photograph with the photographs in the database, for example by a special purpose image-comparing algorithm. The resulting protocol is as follows:

Preparation

1. A certification party (which may be the issuer or other semi-trusted entity) extracts physical features of all manufactured Firmcoin tokens (generally photographs).

2. For each manufactured Firmcoin, and for every image taken, the certification authority publishes a signed cryptographic hash of the image binary data.

3. The certification authority provides a service to verify the authenticity of Firmcoins, generally by a server on the Internet.

4. The certification authority publishes its signing public key.

When a user wants to authenticate a device:

1. The user extracts high-entropy physical features of the Firmcoin (generally by taking photographs).

2. The user connects to the certification server in a secure connection.

3. The user uploads the images to the server.

4. The server compares the uploaded images with a database of images taken to each token in the manufacturing process. The server may use an image comparing algorithm specially designed to detect matches and reject mismatches with high confidence using digital pre-processing of images and feature extraction algorithms to narrow the search space.

One embodiment is packaging the components of the Firmcoin in a polymeric matrix, which can be for example an acrylic prism, where it is possible to randomly disperse small colored particles and/or colored nested threads into the acrylic box during the filling process, and then use front, angular or lateral photographs of the prism as a fingerprint of the Firmcoin. Patterns produced by three dimensional nested threads or yarn are very difficult to copy, so it serves as a low cost fingerprint to prevent copying. This has the advantage that the user can check that the particles/threads are not layered in a plane by turning the prism, since layering of the particles would suggest that a planar copy of the particles has been attempted. But even a planar layer of nested wool or other thick yarn would be difficult to reproduce. To prevent an attacker of using the database images stored on the central server to create counterfeit Firmcoin, the server may not publish the images, but a hash of each image as a commitment, and force the image test to be performed privately on the server when the users uploads a photograph.

Alternatively, if images are published, then the server may mix the lateral and frontal images, such that the user does not know the correspondence between them. Still another alternative is that the server publishes low resolution versions of the database photos and keeps private the high resolution versions. Also it must be noted that the transparent case of the disclosure enables the user to visually check the contents of the enclosure, including the serial numbers and product identifiers of the chips used, adding elements to improve confidence of the authenticity of the Firmcoin.

P14) Provide hardware attestation methods

This allows users to detect if the Firmcoin is authentic by its logical properties.

One possibility is that each Firmcoin carries a unique private signing key Kt-priv, for a public key Kt-pub, stored in a tamper-proof memory. Periodically, when a user connects to the Firmcoin, a protocol is executed. If the Firmcoin does not have a real-time clock, then a sub-protocol must be executed so the Firmcoin can securely obtain the current time-stamp from a trusted source. The key-gen-time-stamp can be acquired in the same way at the moment the key was generated. Here we describe the protocol after the trusted time-stamp was obtained. Let Sign(key,message) be a digital signature algorithm. The Firmcoin sends a message A to the user:

A=Sign(Kt-priv, key-gen-time-stamp∥current-time-stamp∥counter∥k′), where k′ is the public key related to an asset associated to the Firmcoin.

An additional measure to prevent reply attacks is that the Firmcoin can include an always increasing value (“counter”) in each signed message.

The user then re-sends this message A to a secure central server database provided by the issuer. The central server tracks the public keys k′ of all manufactured Firmcoin, and only accepts messages signed by one of the manufactured Firmcoin. Using the time-stamps, the issuer can detect if two Firmcoin are associated with the same assets at the same time, and inform the user. If the issuer is not fully trusted, it is important that the signing scheme chosen does not provide a side-channel that could be used to send the Firmcoin assets private-keys to the central server without user knowledge.

If the asset is a Bitcoin output, then the key-gen-time-stamp and the current-time-stamp can be replaced by the block hash of a recent block on the best chain. This provides a higher bound on the time the Firmcoin uses to generate the key, and the message and the current time when the server receives the message provides a final bound on the time the Firmcoin generated the message. Although it eliminates the need of a trusted time server, it reduces the ability to detect simultaneous use of the same private-key.

To provide anonymity to the connection with the central server, messages can be sent using an anonymous broadcast system, such as the Tor network.

The disclosure proves to the card holder whether the card is actually holding any private-key which has associated funds. The Firmcoin can prove to the Firmcoin holder that the Firmcoin is associated with some assets, and also prove with high confidence that no other Firmcoin is associated with the same assets. Additionally, the Firmcard can be re-associated with a new asset by the user.

A Firmcoin provides the additional novel functionality described herein, and further provides a reduced size, weight, and cost, relative to other asset transfer devices.

Devices of the disclosure do not require the use of a PIN (PERSONAL identification number), password, or any other information associated with the user, before any operation using the private-keys can be executed. In this manner, not only is privacy enabled, but trading of Firmcoins do not require the accounting of related PINs, as the Firmcoin is impersonal or non-personal.

The Firmcoin can indicate which assets are associated with the Firmcoin, for example in a printed form, magnetic form, accessible wirelessly, visible in a digital passive display (e-ink), or in a display that can be easily turned on without going through the user authentication process. Since Firmcoins can be traded off-line, a clear indication of the asset associated with the device is useful. The display technology e-ink, while not the lowest cost today, is advantageous due to low power consumption. In an embodiment, the asset name/amount can be written within the device itself, in a visible and tamper evident way.

In embodiments, Firmcoins do not keep private-keys in memory after extraction. Extraction and deletion of a private-key is a single atomic operation. This enables use of the Firmcoin as a mean to exchange digital assets by exchanging the devices themselves. Thus, the Firmcoin thwarts a double-spend attack which might otherwise be accomplished by first extracting the private-keys from the device, using another computer system to build a transaction signed by the extracted private-key in order to transfer the assets to himself, rendering the token useless to hold or transfer those assets, and handing the token to another party as if it were useful.

The disclosure provides firmware tamper-evidence, which proves to the device holder that as long as the hardware has not been visibly tampered with, the firmware has not been tampered with, as well. The disclosure additionally provides a method to check physical authenticity and hardware authenticity.

Software Attestation

While the Firmcoin has hardware tamper-evident measures built in, enabling the user to easily detect if the Firmcoin has been opened or physically modified, the user may additionally wish to detect if the firmware code has been replaced with malicious code. The disclosure presents a solution that can be applied not only to the Firmcoin, but to any computing device that runs program code from memory. More particularly, the disclosure provides for having all of the components of the device identifiable from exterior to the device.

One manner is by eye inspection: the device is packaged in a transparent filled case, such as an acrylic cube or prism. Other materials which can be used include an olyester (PET), a polyimide (PI), a polyethylene napthalate (PEN), a polyetherimide (PEI), a fluropolymers (FEP), or a copolymer polyimide film. All components contained in the enclosure can be located to be easily identifiable from the outside. Part numbers of contained electronic components can be readable directly or using a magnifying glass. The user inspecting the device can confirm that the subcomponent identifications conform to the hardware specification created by the issuer. For example, it can be evident to the user that an unspecified chip has been added, or that a component containing digital memory has been replaced by another component that contains a different kind or higher amount of digital memory. The total storage capacity (RAM/EEPROM/FLASH/etc.) of the contained components in the enclosure can be computed by the user by identifying hardware components, and this capacity matches a value specified by the token issuer. Such comparison can alternatively be carried out by experts or software.

The Firmcoin issuer can publish, for each model manufactured, the binary data of all non-private memories (the “original memory”) or a cryptographic hash of the binary data contained in all non-private memories present in the device. This publication can exclude the memories that hold private data, such as private-keys. This binary data can have the property that it is “practically incompressible”, as defined herein. The description of tamper-proof firmware herein includes that if the original memory is practically incompressible, and a verifier challenges the device to send a copy of the firmware, then an authentic firmware can do it very easily by reading it is own firmware. But a modified firmware cannot send the original copy right away, it must be able to reconstruct it or store a copy of it somewhere. If it was stored, then it has to be compressed to a higher compression ratio to make room for the attacker's new code. Thus, to provide the original copy, the attacker firmware must decompress the original on-the-fly and re-compress it at a lower ratio to match the original compressed data, which is time consuming and detectable.

An attacker's algorithm may carry this out when it is powered up and pre-compute the decompression and re-compression to RAM. Both approaches are prevented by the protocol of the disclosure by limiting the response time and precluding the device from using the RAM to respond to the challenge. Since a highly compressed data has high entropy, there is no easy way to reconstruct a highly compressed data from another data set which is not by actually re-compressing the data from the uncompressed version. There is no bibliography on methods from converting a highly compressed data into a compression of the same data with lower compression ratio by applying any kind of a differential patch, without doing decompression and re-compression, in real-time, and without using RAM.

Formal Definitions

Let Comp(M) be a compression of the string M under an compression algorithm C. Let Dec(W) be the decompression of the string W under the decompression algorithm Dec, so that M=Dec(Comp(M)). Let size (M) be the size in bits of a string M. Let min-prg-size (Dec) be the size of the shortest program written for the architecture A that executes the algorithm Dec. Let time(Dec, M) be the time it takes for the decompression algorithm Dec to decompress M in the architecture A. The time can be given in the number of CPU clocks, in seconds or in the number of instructions cycles executed.

Herein, it is “feasible to create an algorithm C using the string z”, noted C is in FC(z), if when creating such an algorithm accessing additional information z, we're not breaking a security assumption of a cryptosystem we rely on. For example, for a cryptographic hash function H, currently nobody can feasibly create an algorithm that given H(z) it responds z, without using z in the first place. So any practical algorithm to compute H(z) belongs to FC(z). Also without being given z, nobody can feasibly create an algorithm that given H(z∥0), . . . , H (z∥n) outputs z.

Herein, a binary string M is practically incompressible in a hardware architecture A, execution time bound b and some additional information z, if for any compression scheme (Comp,Dec) that can be feasibly created using z, at least one of these two conditions is met:
1. size(Comp(M))+min-prg-size (Dec)>=size (M)
2. time (Dec, M)>b

Let PI(A,b,z) be the set of all strings that are practically incompressible for A,b and z.

We can say “M is practically incompressible in a hardware architecture A and a time bound b and additional information z” (or in other words, it is impractical to compress M in A in less time than b, using z) simply as: M is in PI(A,b,z).

We say that a user U has access to the string z_{U} if the string z_{U} is readily available from a memory in constant time (it does not require to break a security assumption, nor to do exponential steps)

Now suppose each user U has access to some secret information z_{U}. We can say that a user U can feasibly create an algorithm C if C is in FC(z_{U}). So we may extend the definition of practically incompressible for users. We can say “M is practically incompressible for user U (and for A, and b)” if M is in PI(A,b,z_{U}).

Suppose the issuer keeps some secret string z₁ which is not available to the attackers. A binary string M is “practically incompressible for an attacker” if for any attacker X, M is in PI(A,b,zₓ).

A binary string is “practically incompressible for the issuer” if M is in PI(A,b,z_{I}).

In the “original memory”, all unused space of the memories must also have the property to be “practically incompressible”, if not, then the unused space of a memory could be used to store additional non-authentic firmware. We'll call “padding” all unused non-private memory space, and “content” to the part of the original memory which is not padding.

If we want to the original memory to be practically incompressible for an attacker, then both the content and the padding must be practically incompressible for an attacker. Since the content contains by definition some information, it has lower than maximum entropy, and so it is theoretically compressible. We must make sure that either:

1. it cannot be compressed much (because it is already compressed)

2. the time it takes to compress or decompress it exceeds the bound b

3. The compression/decompression routine is greater than the size gained by compressing the content.

4. The volatile memory required for compression/decompression in not available when the device requires it.

We'll see that each one of these approaches solves the problem for certain architectures.

Regarding the padding, it can just be random generated bytes, so the attacker had no way of compressing them (except with extremely low probability). However, what if the issuer is itself an attacker, or the issuer is colluding with an attacker? If we think this may be a possible attack scenario, then first we must make sure that the original memories (essentially the program in firmware) is not malicious. So we assume that the issuer publishes the firmware source code and binaries so everyone can verify the correctness of the software.

Now if we want to M to be practically incompressible for the issuer, then we must make sure that there is no hidden compressible information. Preventing hiding information in program memory (“opcodes”) is relatively easier, since it is generally sufficient to show the high-level source code that compiles to the assembler program or to show that every instruction of an assembler program has a clear meaning, with non-random arguments. If the source code of the assembler opcodes is available, along with the required compiler, then everyone can verify that the opcodes do not hold hidden information as long as the source does not. And it is very easy to audit the source code looking for hidden compressible information (it must reside in initialized constants, probably long vectors of values for an unknown functionality, for example by means of “steganography”). However, attention should be paid to the original memories padding.

Padding should have been created in such a way that either:

1—It is incompressible algorithmically (a property called “Algorithmically random sequence”)

2—Use a public verifiable source of random.

3—It can be compressed, but the time it takes to decompress it is greater than the bound b.

The use of an algorithmically random sequence like Chaitin's halting probability Ω, should be discarded, since creating such sequence is uncomputable. The second is practical. For example, one could take the last 1000 numbers that won the national lottery. The disadvantage is that the users should have access to the historical records of the national lottery to verify the correctness of the firmware. The third has the advantage that it does not require external information, and afterward the disclosure shows how to achieve this property for the padding.

The bound b is chosen for each architecture A by the firmware code writer so it takes more time to decompress a modified firmware than the time that is given to the device to respond to a challenge (or the time from cold-boot until the time of the challenge response).

The property of data to be practically incompressible is difficult to prove, because it involves finding the smallest executable code fragment that outputs a certain binary string. And this problem, in an unbounded memory and time setting, is undecidable. Nevertheless we can answer if a certain memory is practically uncompromisable with very high confidence. Most part of the non-volatile memory of a device is used by the program memory. Compression of program memory varies depending the CPU architecture, compression algorithm, decompression performance, and decompression program size. Also, there are compression algorithms specially adapted to executable code compression. In [1] it is claimed that GZIP offers a reduction in the largest reduction of the software size, on average by a factor of 0.44. In [3] compression factors as low as 0.23 are accounted for x86 code. Also [1] the unpacker size varies from 1.5 to 8 KBytes. Other authors [2] made a LZ decompressor fit in 300 bytes, using hand-optimized assembler x86 code (although an equivalent C routine compiled for a PIC 8-bit micro-controller requires more than 2 KBytes).

Suppose our platform has 400 bytes of FLASH memory that is used to store our original authentic program, which it is made purely of machine opcodes, without any constant variables or tables. Suppose that the best compression ratio for machine code for a certain platform ever achieved by a compressor program is 0.4 (final data size is 40% of the original data size). Suppose that this best compressor also has the smallest unpacker size of 300 bytes. And also suppose the unpacker can unpack 400 bytes in less than 1 second. Then the unpacker plus the compressed data will require 460 bytes for storage. Clearly the authentic program is not practically compressible. For this architecture, almost any firmware will be practically incompressible. But 400 bytes is not realistic for a state-of-the-art microcontroller flash memory size. The disclosure provides a solutions to make a binary string M practically incompressible, providing that the device architecture:

A—Can decompress code and execute it on the fly OR

B—Has enough volatile memory so the non-volatile memory can be used to store the program memory in a compressed form, and this memory is uncompressed into the volatile memory at start-up or when execution of some part is required. Many microcontrollers allow for storing code in FLASH, copying it to RAM, and executing it there, in order to avoid the performance penalty of fetching each instruction from FLASH memory.

In accordance with the disclosure, the solution is to store the compressed form of the string M, along with the unpacker code (and with enough padding to fill the memories) in non-volatile memory, and uncompressed it to volatile memory when it is necessary to execute it.

If the compression ratio achieved by the issuer compression program is not optimal, then still an attacker has to manage to achieve a higher ratio and store the attacker unpacker program (along with any other malicious code) in the free space left by the difference of space freed. But then, to be able to respond to the verifier challenge to send the original memory, the counterfeit memory must hold the attacker's decompression routine and the original compression routine (which must produce a result that matches exactly the original compressed form). This is actually more challenging, since the issuer may have used a 500 KByte program, running on a 1 GHz CPU, left running over a whole day, and using 1 Gb of RAM to compress the plain original memories M into a string D of its lowest possible size. Then the attacker must reproduce this compression in a microncontroller in a few seconds, running for example an 80 Mhz CPU, with a program of minimal size, and almost no RAM memory. It may be the case that compressing under these limited resources produces a compressed string D′ that does not differ much from the original string D, and so an ad-hoc compression method could turn D′ into D, but this is highly improbable.

Also it is possible that the attacker reuses the same decompression routine (or parts of this routine) and uses a more powerful algorithm to compress M offline before deploying it. Nevertheless, it still needs to add the re-compression routine, which was not present in M before.

In an example, suppose that M (the uncompressed authentic memory) is 32 Kbytes long, and the device issuer achieved a compression ratio of 0.40, and the issuer unpacker size is 2 Kbytes. Then M compressed is only 32*0.4+2=14.8 Kbytes. The remaining space is filled with practically incompressible padding. Suppose that the attacker manages to compress M using a new algorithm developed by the attacker, achieving a 0.39 compression ratio. Then the resulting compressed string is (32+2)*0.39=13.26 Kbytes. The attacker also has to add the re-compression routine. Suppose the re-compression routine is 2 Kbytes long. Then the attacker would require 15.26 Kbytes to store the counterfeit replacement for M, which is impossible since M was restricted to 14.8 Kbytes.

It is observed that the issuer should choose the optimal existent technology to compress the memory M, since any significant improvement can render the protection worthless. Also it is generally not important the time taken to compress M, as long a the decompression is fast. For example, the PAQ8HP8 algorithm outperforms almost any competitor, although the compression running time can be as 600 times slower than other standard algorithms [4]

Also it is further observed that if an attacker manages to compress M more than the issuer can, and an effective attack is executed, then the issuer may be able to access the counterfeit device. If the attacker uses a new algorithm for the unpacking routine, then the issuer may be able to reverse engineer the unpacking routine and possibly provide the same level of compression for the next release of the device, rendering any new attempt to attack much more difficult for the same attacker.

It is further observed that if the decompression routine provided by the issuer is stored in uncompressed form, if this routine is big enough (say more than 1 Kbyte), then it could be possible to compress the decompression routine using an algorithm that requires a much shorter decompression routine. In that case, the issuer must decompress in two stages: first decompress the second decompression routine using a first shorter decompression routine, and then decompress the remaining content using the second decompression routine.

### REFERENCES

[1] Efficient Sensor Network Reprogramming through Compression of Executable Modules (http://www.sics.se/˜adam/tsiftes08efficient.pdf)
[2] http://fgiesen.wordpress.com/2011/01/24/x86-code-compression-in-kkrunchy/
[3] http://www.maximumcompression.com/data/exe.php
[4] http://en.wikipedia.org/wiki/PAQ)

The disclosure describes next a protocol that allows a device (“prover”) to prove to a user (“verifier”) that the firmware and additional memories stored on the device are authentic, and have not been tampered with. The verifier uses a secure computer to receive and verify the responses sent by the device. Also the verifier either knows the contents of the authentic memories, or has a hash of each block of those memories, provided by the issuer. This gives us two possible protocols:

Protocol A (the verifier has a copy of the original memories)

Let M′ be the original memories. Let M be the non-private memories of the token, concatenated in the same predefined order as the original memories. Let P be the private contents of the private memory unused, that must be filled with padding. Let P′ be the padding of private memory as computed by the verifier.

1—The device informs the verifier how much of the private memory is using.

2—The verifier checks that this in fact the device is expected to use that amount of private memory.

3—The verifier chooses a random binary string C (the challenge) and sends C to the token. it waits a predefined short amount of time for the answer, such as 1 second.

4—The device computes R=Hash(C∥M∥P), where R is the response. The device sends R to the verifier.

5—The verifier (who has knowledge of M′, because it is provided by the token issuer) computes R′=Hash(C∥M′∥P′). Then the verifier compares R and R′. IF they are unequal, the firmware has been modified.

6—The verifier verifies that the response received is within the time bound b. If not, then the firmware cannot be considered authentic, and the test should be repeated.

As previously stated, P represents the memory buffers that are specially manufactured to hold private data, but are not holding private data at the moment, and must also be filled with padding and must be appended to M. If the response is not received within the specified time, the test can be repeated. If it fails multiple times, then the firmware is assumed to have been tampered with.

It may be the case that the issuer does not want to make the original memories public, and the memory contents are kept private. We'll show protocols that allow the verifier to prove the memory has not been tampered with, without the knowledge of the original memories. Instead of M′, the issuer gives the verifier a long binary message D′ where the size of D′ is greater or equal than the size of the original memories.

The message D′ has the following properties:

1. As the original memories, D′ cannot be practically compressed (see the definition herein).

2. Has the same properties as a cryptographic hash message digest of M′ (infeasible to invert, and digest indistinguishable from random output).

3. Can be computed by the device using M′ as input, where the code to compute D′ from M′ either resides in ROM, is fixed in hardware modules, or is contained in M′ itself.

Protocol B

The protocol is exactly the same as A, but instead R is computed as R=Hash(C∥D∥P) (and also R′ is computed in a similar way).

We'll give three possibilities for the algorithm to compute D from M:

B1) To build the message D, it is broken into blocks of fixed length in the following sequence: D(1) . . . D(n).

Let M[i] be the binary string M divided in fixed-length blocks suitable to be inputs of a hash function.

Then D(i)=Hash(M[i])

Note that block-chaining is not required. Since W is practically incompressible, there is a very low probability of two different blocks of M being equal (M[i]=M[j] for i< >j). Then it won't be possible to an attacker to try to create a code book to infer properties of M.

2) Let k=private-key, stored in the device ROM or in M′ or computed as k=Hash(M)

Then D=CTR-Encrypt(k,M), with a zero IV.

3) Use a hash function with unlimited digest length, such as SHA-3 (Keccak). Let S be a Keccak hash digest of M, with the same length as M.

S=Keccak-hash (M)

D=Bit-xor(M,S)

If the device has RF or any non-cable communication capability, then the prover has to make sure that the device is not receiving or sending data to other devices not being tested. If the device supports NFC communication only, then the prover must make sure that there are no other devices that could collude with the device under test within the NFC reach range. If the device supports a longer range of non-cable communication, such as Bluetooth, then the device must have a mechanical switch to turn off these links, or the device must be forced by the hardware to communicate only with a single destination at the time (the verifier).

If the token is battery-powered, than all volatile memories must be included in M, because they may contain program memory temporarily. If the token is not battery-powered, then volatile memory can be excluded from the check as long as the verifier is assured that the device was powered-off and no communication with other devices has taken place before the proof protocol begins. It is also possible to assure the volatile memory is unused by the protocol D described later.

In accordance with the disclosure, a method to create practically incompressible padding by making padding compression/decompression take too long is shown. We start by dividing the padding in blocks, where each block size corresponds to the size of the message digest of a standard cryptographic hash function, such as SHA-2. Let pad[i] be padding block i. Then pad[i] is constructed as pad[i]=Hash^{N}(i), where Hash^{N}( ) is the application of the cryptographic hash function N times (where each application except for the first one is applied to the previous hash digest). N must be large enough that the time taken to generate pad[n] exceeds the time given to the device to send the response. For example, N can be made so the CPUs in the token take at least 1 minute to compute each padding. Since the device computing processing power is generally much lower than a general purpose computer processing power, a computer can verify that the issuer provided padding was generated as specified in a few seconds of computer processing, and this can be done only once per distinct original memory M.

If the verifier has control of when the device is powered-up, then he can simply power-up the device just before doing the challenge-response verification protocol described before. Then the device has no time for precomputation. USB devices, for example, can be disconnected and re-connected by software. If there is no control of when power-up occurs, we can achieve the same initial state. We add a protocol to verify that the device has not done any precomputation to respond to the challenge in a shorter time, and thus avoiding surpassing the time bound b. The precomputation we want to prevent is the recompression of the original memories from the compressed data created by the attacker to the original compressed data. This is done by asking the device to store a random string whose size matches the device RAM and then asking the device to retrieve the same string (and making sure that there is no information buffered in the connection layer before asking for the string).

To prevent the use of the communication buffers as temporary memory, we then can ask the device to return the string in reverse order. Or alternatively, to reduce the connection usage, we ask the device to respond with a hash of the string in reverse order. Let Hash( ) be a cryptographic hash function which for which the hash routine resides in the original memory. Let v be the total number of volatile bytes available (generally as RAM and the internal micro-controller registers) not counting the memory that the Hash function algorithm requires for computing a hash digest. Let h size of the hash internal input block. For simplification, let v be a multiple of h. Let d=v/h. Let C be a string and C(i) be the i-block of the string C, where the block size is h.

Let ReverseHash(C)=HASH (C[d−1]∥C[d−2]∥ . . . ∥C[1]∥C[0]) (which is hashing in reverse order in fixed length blocks)

Protocol C

1. The verifier chooses a random string C of length v and sends C to the device.

2. The device computes h=ReverseHash(C) and sends h to the verifier

3. The verifier computes h′=ReverseHash(C) and verifies that h=h′

It is clear that the microcontroller must store the values C[0] . . . C[d−2] somewhere in order to hash the block C[d] and so all previous values in RAM must be overwritten with C[0] . . . C[d−2].

The same protocol can be used to prevent an attacker provided decompression and compression routines to use any RAM. By executing the protocol B between the step 2 and 3 of protocol C, and by keeping the last block of C hidden until step 3, we force the firmware to either waste all RAM, or to copy the string C temporarily to non-volatile memory. Both compression and decompression routines require the use of RAM tables. State-of-the art compression algorithms may require much more RAM memory than decompression routines, in the order of megabytes.

Protocol D

1. The verifier chooses a random string E of length v and sends almost all E to the device, with the exception of the last block of length h of E (e_last). h should be not less than 80 bits.

2. Execute the protocol B.

3. Send e_last to the device

4. The device computes h=ReverseHash(E) and sends h to the verifier

5. The verifier computes h′=ReverseHash(E) and verifies that h=h′

6. Re-verify the time bound b for the executed protocol. Abort if used time is greater that bound b.

Table 1 includes examples of architectures where this tamper verification method can be applied. For all architectures the best protocol in terms of security may be protocol D, but some other simpler protocol can be used as shown in the last column.

TABLE 1
Architecture Examples

| | FLASH | RAM | Can the software | Minimum protocol to |
|---|---|---|---|---|
| | MEMORY | MEMORY | power-down the | achieve protection against |
| CPU | SIZE | SIZE | device? | counterfeit memories. |
| any | Small | any | any | Store M uncompressed. |
| | (<1 Kbyte) | | | Use practically incompressible padding |
| | | | | Verify execution time bound b. |
| | | | | Use protocol A |
| Very slow | any | any | any | Store M uncompressed |
| | | | | Use practically incompressible padding |
| | | | | Verify empty RAM before main protocol. |
| | | | | Check that the device responds withing a |
| | | | | tight time bound b. |
| | | | | This prevents on-the-fly |
| | | | | compression/decompression. |
| | | | | Use protocol A |
| any | any | Small | yes | Store M compressed in FLASH |
| | | (<512 | | Use practically incompressible padding |
| | | bytes) | | Verify execution time bound b. |
| | | | | Use protocol B |
| any | any | any | any | Store M compressed in FLASH |
| | | | | Use practically incompressible padding |
| | | | | Verify execution time bound b. |
| | | | | Use protocol D |

In the following description, an illustrative system involving a tamper-evident apparatus to be associated with a fixed amount of Bitcoins will be described as one example embodiment (Bitcoin-Firmcoin or FirmCube). The Bitcoin-Firmcoin comprises an NFC transceiver with a built-in low-power ECC/SHA-2 crypto-accelerated tamper-proof microcontroller (with integrated RAM and FLASH memories, and a secure random number generation), an antenna, a security hologram, a plastic surface with imprints, and a randomly distributed set of colored particles packaged in a solid transparent rectangular prism. The microcontroller is powered is given by the NFC transceiver, which receives the power by RF. The FLASH memory of the microcontroller is used to store a the firmware in compressed form, along with an unpacking routine. The imprints on the plastic surface show the amount of Bitcoins associated with the Bitcoin-Firmcoin (e.g. “1 BTC”) in a big font, and a QR code representing a serial number in a small font. The microcontroller is programmed to:

Store a private-key in a tamper-proof memory of the microcontroller.

Store the related public-key in the FLASH memory of the microcontroller.

Enable to be queried by NFC if the device is associated with a Bitcoin private private-key and that private-keys is holding funds.

Clearly indicate the amount of Bitcoin associated by embedded text imprints.

Enable users to challenge the device in for the possession of a private-key associated with a user supplied public key, by signing other messages with the ECC private-key, but before signing appending a fixed string before hashing to prevent the challenge method to be used to sign arbitrary messages.

Enable users to force the device to generate a new private/public key-pair, in order to recharge it later.

Enable users to securely load new assets into a device without requiring a connection to the issuer, by providing the device a proof that the assets have been associated with the device public key.

Enable users to detect if the device is authentic by its physical properties, using a central database of device images.

Enable users to detect if the device is authentic by its logical properties, using a unique private-key stores in each device.

Enable users to extract the private-key and at the same time (as an atomic operation) the device will enter a new special state “empty”.

With reference to the drawings, 0110 is an solid acrylic rectangular prism; 0130 are random positioned color threads that form a 3D pattern which is very difficult to copy; 0150 is an a NFC active tag antenna, including in the same chip a NFC powered micro-controller with accelerated cryptographic operations (ECC and SHA-2), and a hardware random number generator; 0170 are random colored particles distributed in an unique random pattern to prevent copying the device; 0180 is a security hologram printed in a plastic tag. Also the amount of Bitcoins associated with the bill are printed (e.g. “1 BTC”); 0910 is an solid acrylic rectangular prism; 0920 is an NFC antenna; 0930 are random positioned color threads that form a 3D pattern which is very difficult to copy; 0940 is a printed circuit; 0950 is a NFC transceiver with serial communication to the micro-controller. The NFC can also power the micro-controller and the LED; 0955 is an indicator LED; 0960 is a photovoltaic cell to power the micro-controller and the LED; 0965 is a low-power micro-controller with accelerated cryptographic operations (ECC and SHA-2), a hardware random number generator, a serial communication port with the NFC, and a I/O pin to turn on the LED; 0970 are random colored (or non-colored) particles distributed in a unique random pattern to prevent copying the device; 0980 is a security hologram printed in a plastic tag. Also the amount of Bitcoins associated with the bill are depicted (e.g. “1 BTC”); 0985 is an IR-LED; 0990 is a security hologram; 1010 is a thin plastic film that encloses the components; 1020 is a flexible printed circuit; 1025 is a first capacitive button; 1026 is a second capacitive button; 1030 is a flexible passive e-ink display; 1110 is a printer denomination; 1120 is a coin sized enclosure; 1130 is a NFC transceiver with serial communication with the micro-controller; 1210 is a Roulette table; 1220 is the active NFC part of the roulette table; 1230 are antennas for NFC communication; 1240 is an NFC master transceiver; 1250 is a computer connected with the NFC transceiver; 1260 is a BlueTooth BLE transceiver; 1310 is a BlueTooth BLE module with embedded antenna; and 1310 is a battery

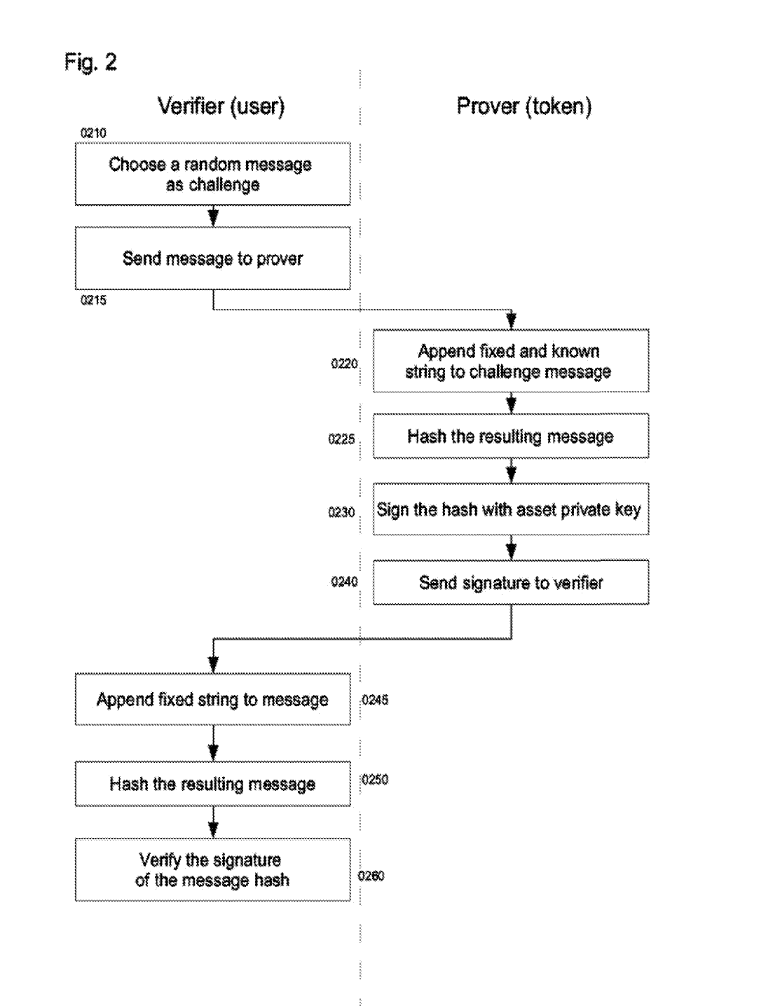

In FIG. 2 a protocol for the Bitcoin-Firmcoin to prove the possession of the Bitcoin private-key is depicted. In 0210 the user who which to verify the Bitcoin-Firmcoin (by using a computer) chooses a random message challenge C. In 0215 the user sends C to the Bitcoin-Firmcoin through a NFC communication channel. In 0220 the Bitcoin-Firmcoin appends a fixed message (known also by the user) to the message C received. In 0225 the Bitcoin-Firmcoin hashes with SHA-2 the new message C. In 0230 The hash is signed with the Bitcoin ECC private-key. In 0240 the signed message is sent to the user through a NFC communication channel. In 0245 the user appends the known fixed string to the original message C. In 0250 the user hashes with SHA-2 the new message C built. In 0260 the user verifies that the received signature is a correct signature of the computed hash, using the public key of the Bitcoins associated with the Bitcoin-Firmcoin, which is available by another query procedure.

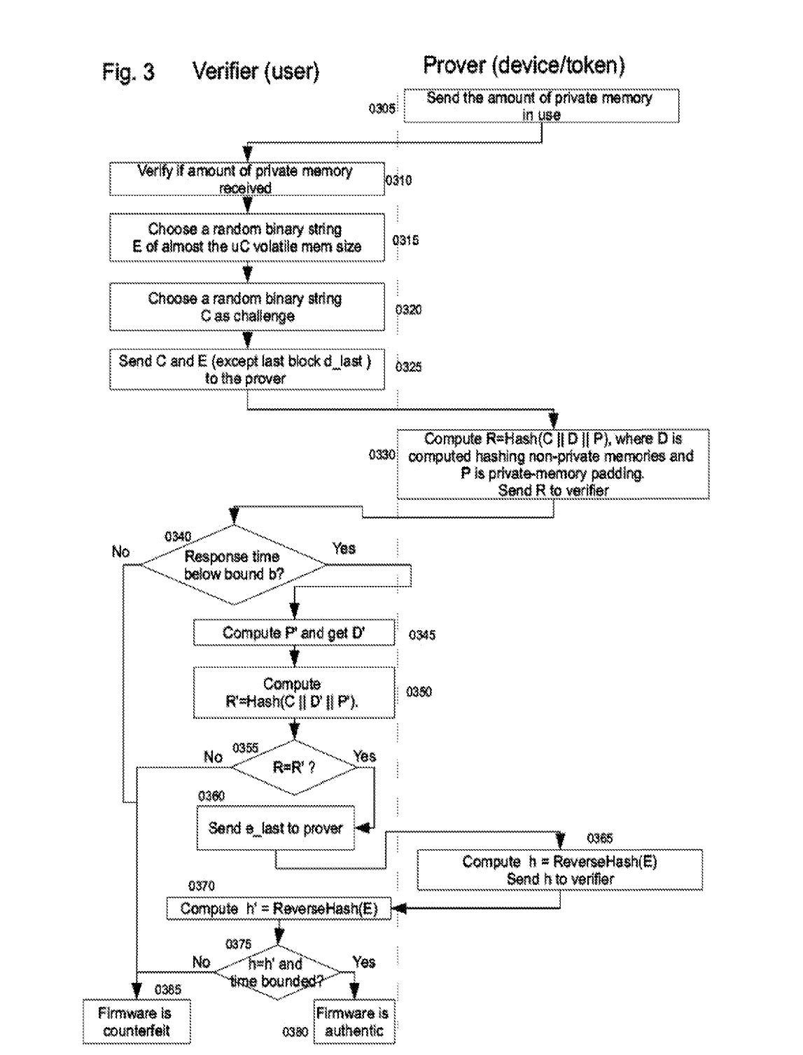

FIG. 3 shows a flowchart for the protocol for the Firmcoin to prove that the loaded firmware and non-private memories are authentic using firmware decompression at start-up. In 0305 the devices informs the verifier how much of its private memory is in use. In 0310 the user checks if the private-memory informed by the device is correct according to the number of private-keys that it is storing. If more private memory is advertised than the expected amount, then the device may be trying to fool the verifier by storing information in its private memory. The user should abort the protocol and the device firmware should be considered non-authentic. In 0315 the user chooses a random binary string E, whose size is almost the size of the volatile memory available to the target device. The difference between the maximum capacity and the length of E must be only enough to store temporal variables required to compute the pee-established steps in the protocol. Micro-controller registers also considered part of the volatile memory. In 0320 a random binary string C of length at least 80 bits is chosen by the prover. In 0325 the string C is sent to the device. Also almost all the string E is sent to the device. The last part of string E is (defined as e_last) is not sent to the device. The length of e_last should be at least 80 bits. In 0330 the devices computes R=Hash(C∥D∥P), where D is computed hashing all non-private memories present in the device (which may included padding) and P is a padding of all the unused private-memory. The device sends R to verifier. In 0340 the user verifies that the response of the device was sent before a maximum allowed response time of b. The time interval b is set so the verifier can detect if the device is performing other operations rather than just copying information from non-volatile memory to the communication buffers and sending such buffers. In 0345 the verifier computes P′ using the method described in section P12 to create pseudo-random bytes that are practically incompressible. Also P′ can be previously stored and precomputed by the verifier. The verifier also gets D′ from the device issuer. D′ must be verified to be authentic by other means, such as a electronic signature of D′ send by the issuer. In 0355 a decision is made regarding the equality of R and R′. If R is not equal to R′, then the protocol aborts and the firmware is considered counterfeit. If they are equal, the protocol continues in 0360. In 0360 the verifier sends e_last (the last block of E) to the device. In 0365 the device computes the reverse hash of E (as specified in section P12) into h, and then sends h to the verifier. In 0370 the verifier computes h′ as the reverse hash of E (as specified in section P12). In 0375 a decision is made regarding the equality of h and h′. If h is not equal to h′ then the protocol aborts in 0385 and the firmware is considered counterfeit. In they are equal, then the time bound is checked again against a preestablished bound. If the bound was surpassed, he protocol aborts in 0385 and the firmware is considered counterfeit. Otherwise, in 0380 the non-volatile memories of the device are considered authentic. In 0380 the non-volatile memories of the device are considered authentic and this is informed to the user with a message. In 0385 the non-volatile memories of the device are considered counterfeit and this is informed to the user with an alert message.

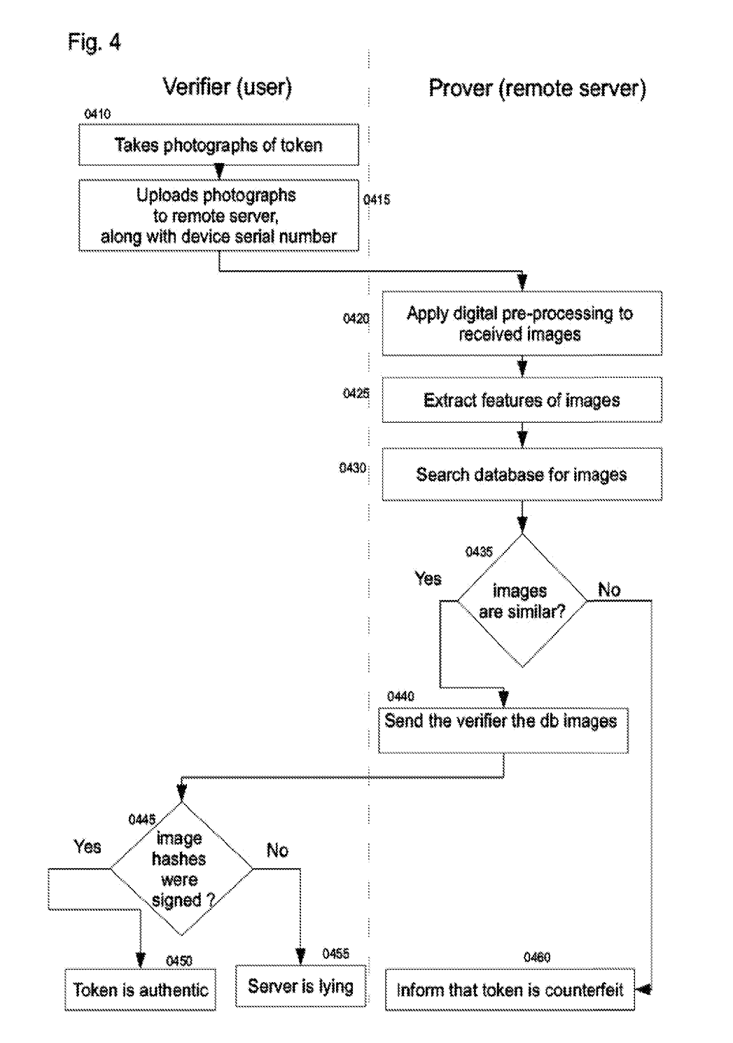

In FIG. 4. a protocol of the disclosure to verify the authenticity of a device based on random features specially introduced during the manufacturing process is presented. This protocol shows the verification steps required to verify a device after the system has been set up. The setup requires the device manufacturer to obtain images of each device, in an embodiment at different angles, and store those images in a private database indexed by the device serial number. Also, features are extracted from the images by a 2D feature extraction image-processing algorithm. These features are useful for identification of a device even if the serial number is unavailable. The manufacturer also publishes commitments to each one of the images using a cryptographic hash of each image file, along with the device serial number, signed with the manufacturer's private-key. The manufacturer setups an Internet service (a remote server) to authenticate online the devices.

In 0410 the user takes pictures of the device using a normal camera after laying the device against a white background. Pictures are taken in rotating the device into different preestablished positions. In 0415 the user queries the device for its serial number, and then uploads the photographs and the serial number to the remote server using a secure connection over the Internet. In 0420 the remote server applies image processing algorithms to the images to correct color, size or angle distortion, enhances desired features, and removes undesired features from the images. In 0425 the remote server extracts features of the images useful to index the images in the image database. In 0430 the remote server searches the database for images of the device indexing by the serial number provided by the user. If the lookup fails, it can also look up for similar images using the extracted features as index. In 0435 if the remote server checks that the user provided images and the database images are similar, using feature extraction or by computing a vector distance between the images (treated as linear vectors) and checking that the distance is lower than a preestablished threshold. If a hit is found, then the flow continues in 0440. If the images in the database do not match the images provided by the user, then the flow continues in 0460. In 0440 the server sends to the user the images found. In 0445 the user checks that the received images where previously committed to by the manufacturer by searching the commitment database of the commitments associated with the device serial number. These commitments can be verifies because the user has received the original images used to create the commitments. If the signature for the commitment is correct and the hash committed corresponds to the received db images, then the Bitcoin-Firmcoin is authentic and the flow continues in 0450. If there is a commitments mismatch, then the server is lying and the flow continues in 0455. In 0450 the protocol establishes that the Bitcoin-Firmcoin is authentic. In 0455 the user establishes that the server is lying and the Bitcoin-Firmcoin cannot be verified to be authentic or not. In 0460 the server informs the user that the Bitcoin-Firmcoin is not authentic.

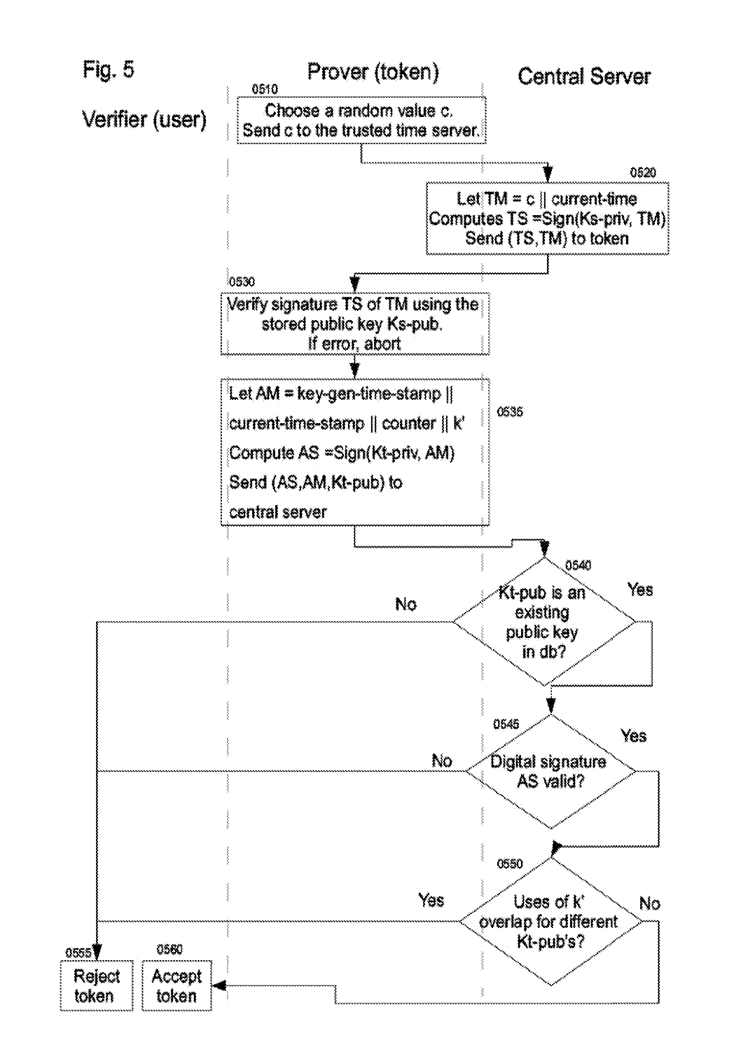

In FIG. 5 a protocol to verify that the there are no more than a single Bitcoin-Firmcoin associated with an asset at the same time is depicted (also described in section P14). The protocol relies on a trusted central server that tracks with Bitcoin-Firmcoins are associated with which assets at some sparse points in time. The server has a key-pair (Ks-priv, Ks-pub) for a public key signature scheme. Each devices carries an unique private signing key Kt-priv, for a public key Kt-pub, stored in a tamper-proof component, for a public key signature scheme. Also each Bitcoin-Firmcoin carries the central server public key Ks-pub. The verifier is a user who has a computer that can connect to the Internet and also has a connection to the Bitcoin-Firmcoin.

In 0510 the Bitcoin-Firmcoin chooses a random value c, using the hardware random number generator present in the device. The value c is forwarded by the verifier computer to a central server over the Internet. In 0520 the central server computes the message TM as TM=c∥ current-time. Then is computes the digital signature TS as TS=Sign(Ks-priv, TM). Afterward the server send (TS,TM) to the Bitcoin-Firmcoin (the verifier computer forwards these message from the central server to the Bitcoin-Firmcoin). In 0530 the Bitcoin-Firmcoin verifies the signature TS of TM using the stored public key Ks-pub. If this verification fails, the protocol is aborted. In 0535 the Bitcoin-Firmcoin creates the message AM as AM=key-gen-time-stamp ∥current-time-stamp∥counter∥k′. key-gen-time-stamp is the timestamp when the key associated with the asset was created. current-time-stamp is the current time. Counter is an increasing counter to prevent message reply attacks to the central server. The time-stamps may be created by an internal real-time block or by an external trusted time service in the Internet, accessible from to Bitcoin-Firmcoin using the users computer as gateway. Then the Bitcoin-Firmcoin creates the signature AS as AS=Sign(Kt-priv, AM). The Bitcoin-Firmcoin send (AS,AM,Kt-pub) to central server, using the verifiers computer as a gateway. In 0540 the central server checks that Kt-pub corresponds to the public key of an existing manufactured and non-banned device. If the public key is not found then the server informs the user that the Bitcoin-Firmcoin is rejected because it is counterfeit, and the flow continues in 0555. If the public key was found, the flow continues in 0545. In 0545 the digital signature AS is checked for validity. If not, hen the server informs the user that the Bitcoin-Firmcoin is rejected because it is counterfeit or it is malfunctioning, and the flow continues in 0555. If the signature is valid, the flow continues in 0550. In 0550 the central server check the database of all previous executions of this protocol against the same Bitcoin-Firmcoin (identified by the public key Kt-pub) and all the previous associations of the same asset (identified by k′) at the same time interval (identified by key-gen-time-stamp to current-time-stamp). If there are overlapping records, then the Bitcoin-Firmcoin is rejected and the flow continues in 0555. If there are no overlaps then the server checks the asset-tracking system (in case of Bitcoin, then block-chain) for the transactions that spend the asset associated with k′. If there are transactions gogin out from the address k′ in the middle of the association intervals, then the Bitcoin-Firmcoin is counterfeit, and the flow continues in 0555. Otherwise, the flow continues in 0560 and the Bitcoin-Firmcoin is accepted. In 0555 the Bitcoin-Firmcoin is rejected and the user's computer shows an error message and alarm. In 0560 the Bitcoin-Firmcoin is accepted as authentic and the user's computer shows an information message saying so.

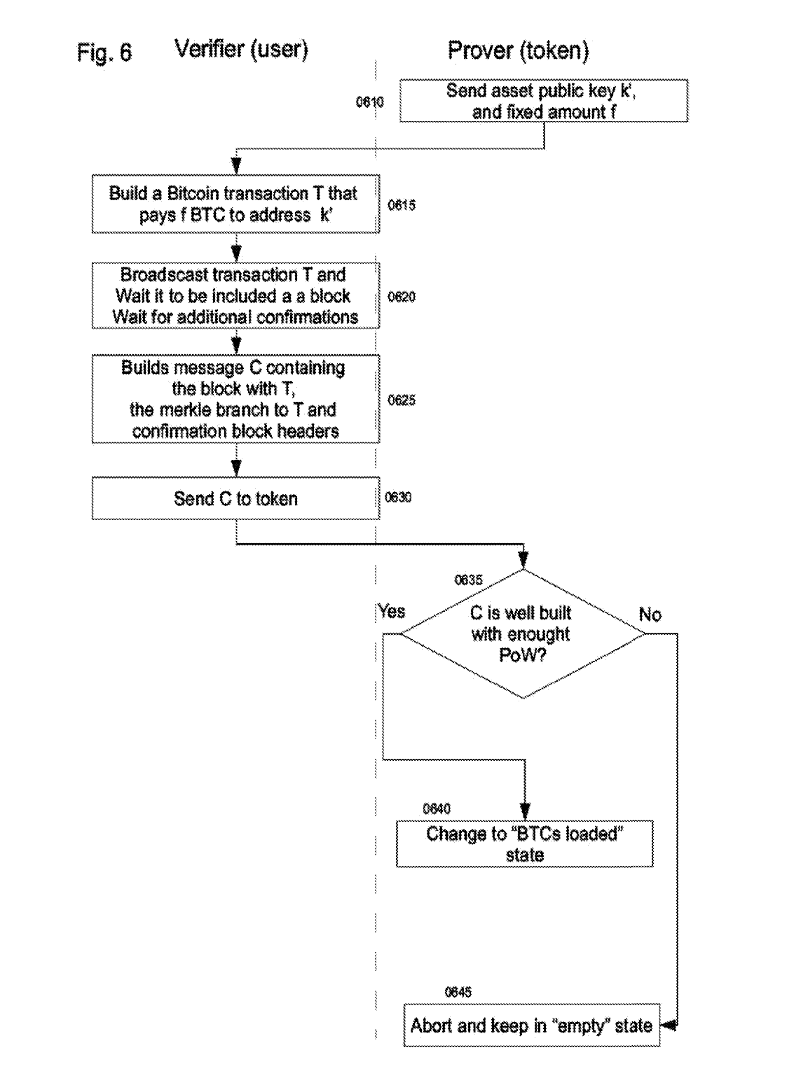

In FIG. 6 a protocol to associate a Bitcoin-Firmcoin with Bitcoin funds is depicted (see section P11). In 0610 the Bitcoin-Firmcoin informs the user which is its asset public key k′ (for Bitcoin, it is an ECC public key) and which is the amount of money fixed for this Bitcoin-Firmcoin that is displayed in the Bitcoin-Firmcoin imprints. Note that in other embodiments described in P11 this value can be dynamic. In 0615 the user builds a Bitcoin transaction that pays f bitcoins to the address k′. In 0620 the user broadcasts T to the Bitcoin network. Then the users waits until the transaction is included in a Bitcoin mined block. Then the user waits some additional confirmation blocks. The number of confirmations is preestablished depending on the f to associate. In 0625 the user builds a message C that contains the block where T was mined, the Merkle branch of hashes from the root hash to the transaction hash, the block headers of the confirmation blocks following the block that contains T. The Bitcoin-Firmcoin can optionally require the whole header chain from a pre-established checkpoint to the block where transaction T was mined. In 0630 the users sends the message C to the Bitcoin-Firmcoin. In 0635 the Bitcoin-Firmcoin verified that the message C is well-formed: the chain hashes, the proofs-of-work, the Merkle branch, the transaction output address. Also it verifies that the number of confirmation blocks is more or equal than a function of the amount f. One possible function is confirmation-blocks=chain-block-reward/f, where chain-block-reward is the reward to miners of the block sub-chain specified in C. This assures that is more profitable to mine for the Bitcoin network than to try mine privately, using the same hashing. In other words, it is less profitable to cheat this protocol using a privately mined sub-chain than to mine openly for the Bitcoin network. If the message C is not well built then the Bitcoin-Firmcoin does not associate the new funds and the flows continues in 0645. If the message C is correct, the funds are accepted and the flow continues in 0640. In 0640 the Bitcoin-Firmcoin changes to a special state “Bitcoins loaded”. In 0645 the Bitcoin-Firmcoins keeps in the “empty” state, with no funds associated.

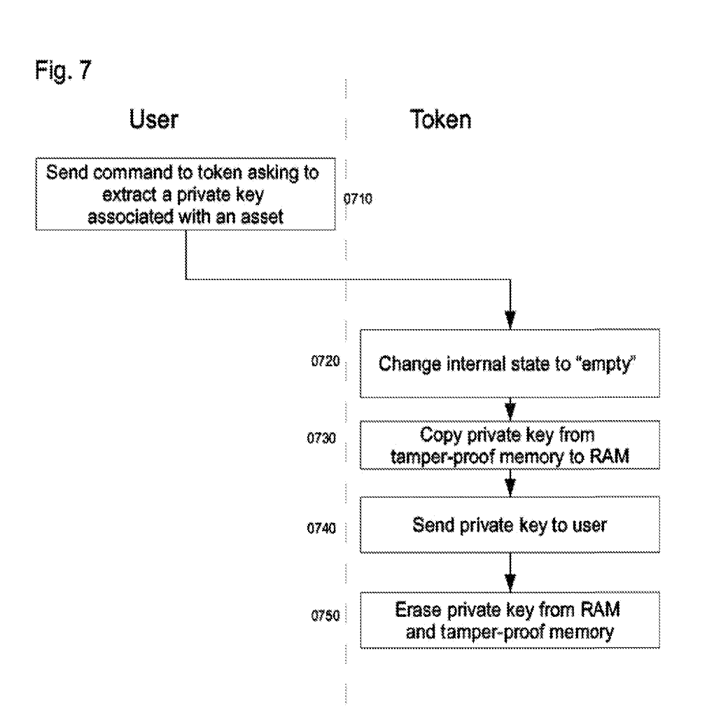

In FIG. 7 a protocol to extract the private-key associated with an asset is presented (this protocol is described in section P5). In 0710 the user sends a command to the Bitcoin-Firmcoin asking the Bitcoin-Firmcoin to send a certain asset private-key, by giving the Bitcoin-Firmcoin the associated public key. In 0720 the Bitcoin-Firmcoin changes its internal state to “empty”. This state change in advance prevents the failure of the protocol in some later time to be used to keep the Bitcoin-Firmcoin in a “assets loaded” state while the asset private-key has been extracted. In 0730 the private-key is copied from a tamper-proof memory to RAM memory. In 0740 the private-key is sent to the user. In 0750 after the user confirms the private-key was received without errors, the private-key is securely wiped from RAM and from the tamper-proof memory.

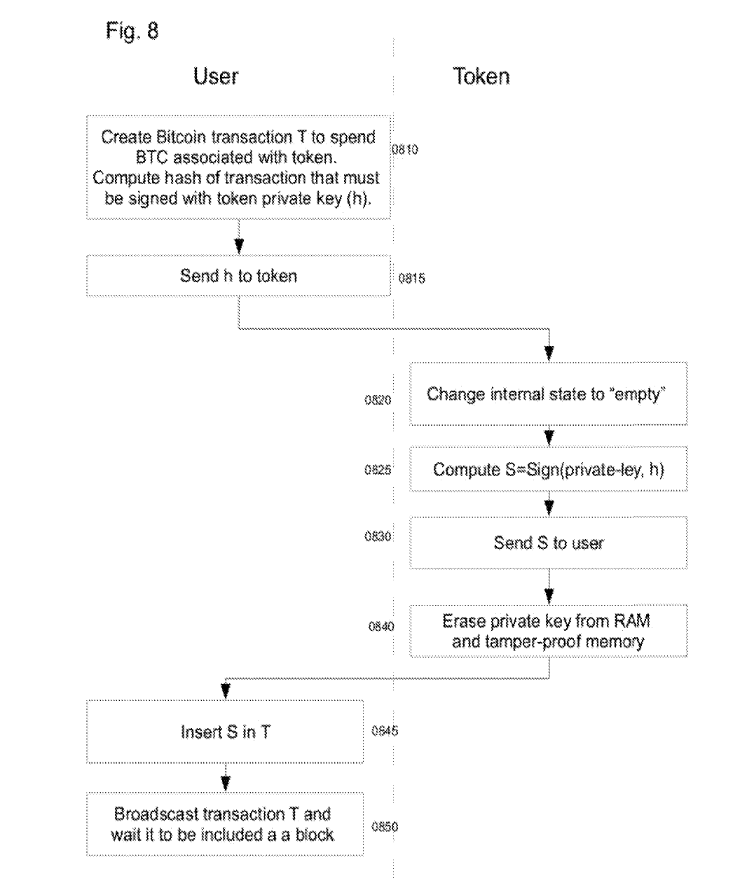

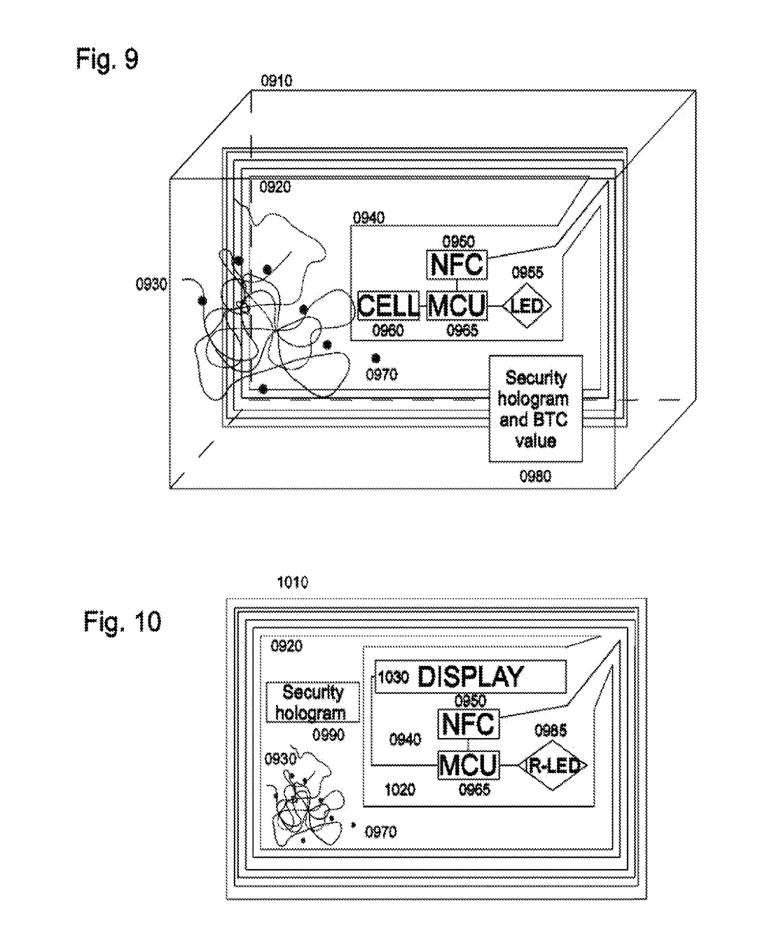

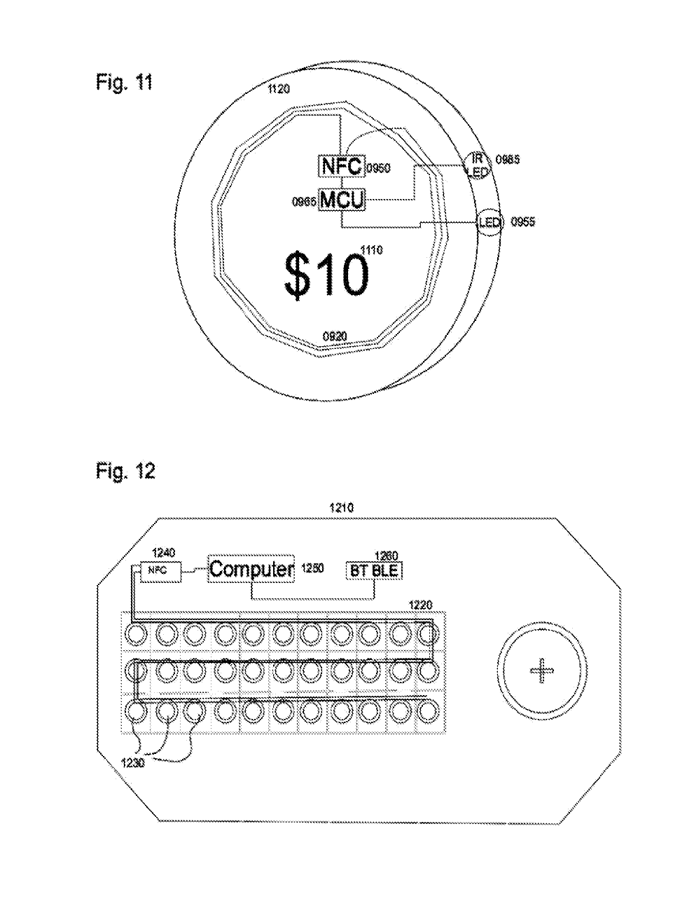

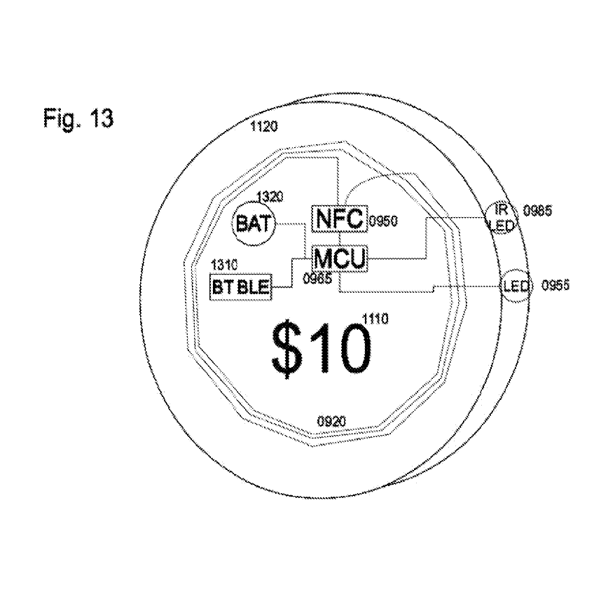

In FIG. 8 a protocol that allows the user to transfer the assets associated with a public key to another destination address, where the Bitcoin-Firmcoins itself creates the transaction signature is depicted. This protocol is also referenced in section P6. In 0810 the users creates Bitcoin transaction T to spend BTC associated with a public address reported by the Bitcoin-Firmcoin. The Bitcoin transaction T should be complete, with the exception of the signature that allows the funds to be transferred from the input that refers to the Bitcoin-Firmcoins public address. Let h be the hash that must be signed by the Bitcoin-Firmcoin in order to make the transaction valid. In 815 the hash h is sent to the Bitcoin-Firmcoin. In 0820 the Bitcoin-Firmcoin changes its internal state to “empty”. This state change in advance prevents the failure of the protocol in some later time to be used to keep the Bitcoin-Firmcoin in a “assets loaded” state while the asset private-key has been extracted. In 0825 the Bitcoin-Firmcoin signs h using the private-key associated with the funds, and builds the signature S. In 0830 the Bitcoin-Firmcoin sends S to the user. In 0840, after the user acknowledges it has received S correctly, the the private-key is securely wiped from RAM and from the tamper-proof memory. In 0850 the signature S is inserted in the input scriptsig to make the transaction T valid. In 0860 the user broadcasts the transaction T to the Bitcoin network to be included in a mined block.

An Alternate Embodiment 2 of the disclosure has the following attributes:
Works for cryptocurrency assets such as Bitcoin.
Standard non-volatile memory (not tamper-proof)
Software RNG. Microcontroller has a non-volatile memory for storage of a random pool and generate pseudo-random private-keys, adding entropy from timed events, A/D sampled voltage lectures, sampled EM power and entropy provided by the user.
Passive e-ink display that shows at all times the current Firmcoin balance.
Made in flexible electronics, covered by a transparent sheet of plastic.
Gives “change” by creating and signing a Bitcoin transaction with the “change”. The Firmcoin stores assets of different denominations (e.g. 1, 2, 4, 8, 16), each one corresponds to an unspent transaction output, where all assets share a single asset private-key. The transaction has a set of transaction inputs (corresponding to unspent outputs) whose amounts that add up to the change amount, a user supplied “fee” input, and a single output to a user provided address. Before the transaction is created, the asset associations are broken and the balance is updated as evidence of payment.
Also gives “change” by storing assets of different denominations (e.g. 1, 2, 4, 8, 16), each one corresponds to an unspent transaction output, where each output is associated with a different asset private-key. The “change” is given by sending a set of associated asset private-keys to the user. Before the asset private-keys are sent, the asset associations are broken and the balance is updated as evidence of payment.

No subliminal Channels

A subliminal channel is a way a device can send to a third party information regarding its private-key without the device owner being aware. The Firmcoin is provided with the firmware source code that let users verify that the firmware code is free from covert channels. But it cannot be ruled out that the hardware manufacturers of the components in the Firmcoin may have modified their chips to include such channels. Also there is the possibility that an attacker may be able to replace the original firmware from a Firmcoin and replace it with a counterfeit code. This is avoided by some of our by software attestation already mentioned, but still we provide several layers of security, so that if one layer fails, the other layer provides a safety net.

First, an embodiment of a Firmcoin cannot communicate with the outside world without user intervention. The Firmcoin does not have a battery, nor any wireless interface with the exception of the NFC, which operates at low proximity ranges. So we can assume that if a Firmcoin has a subliminal channel, then the channel must be present in one of the existent protocols that a Firmcoin supports that interact with the outside world. Currently an embodiment of the Firmcoin supports only 2 protocols that may induce the owner to make public some information given by the Firmcoin:

A. The extraction of the Bitcoin ECDSA public key (Cpub).

B. The signing of a transaction using the Bitcoin ECDSA private-key (Cpriv).

Both protocols require that the user presses one of the Firmcoin buttons to enable them, so it is not possible to remotely power the Firmcoin and execute the protocols without physical intervention.

Protections in protocol A

The leakage of private information in the public key requires that the public key is created with this information hidden inside. The protocol for creating a private/public key-pair is a two-party protocol where the Firmcoin cannot force any private-key with higher probability than a random key. Every key has exactly the same probability, and hence, a Firmcoin cannot hide information in the public key. The protocol is as follows:

1. The Firmcoin chooses a random keypair (Cpriv,Cpub)

2. The Firmcoin sends Cpub to the user

2. The user selects a random integer t from [1, n−1].

3. Let k be t*Cpub. The new private-key pair is (t*Cpriv,k).

4. The user queries the Firmcoin for the public key value and its serial number Sn and verify that the public key informed is indeed k.

5. Now the user should either save the value k along the serial number Sn or immediately load funds to the public key k.

If the user does not save these values or does not load funds immediately then the Firmcoin may rollback to (Cpriv,Cpub), so the interaction with the user would have been worthless.

To load funds at a later time to a Firmcoin, the user must query the Firmcoin for its serial number, lookup the public key and compare this public key with the one informed by the device. If the user does not have the serial number stored in its database, then a new key-pair must be generated before loading the funds.

Protections in protocol B

The signing of a transaction (by the Firmcoin) using the private-key is also a special two-party protocol. A ECDSA signature consist of the tuple (r,$). All known subliminal channels in ECDSA consist of hiding some information in r. s is computed deterministically from d_A, z and r (except from a single bit, which is the sign of y_1). Our protocol guarantees that r is indeed random.

This is the standard ECDSA signing protocol:

1. The signer calculates e=HASH(m), where HASH is a cryptographic hash function, such as SHA-1.

2. Let z be the L_n leftmost bits of e, where L_n is the bit length of the group order n.

3. The signer selects a random integer k from [1, n−1].

4. The signer calculates the curve point (x_1, y_1)=k*G.

5. The signer calculates r=x_1 (mod n). If r=0, go back to step 3.

6. The signer calculates s=k̂{−1}(z+r d_A) (mod n). If s=0, go back to step 3.

7. The signature is the pair (r, s) which is sent to the user.

This is our protocol

1-4. These steps are similar to the standard protocol.

3. The signer selects a random integer u from [1, n−1].

3.1. The signer calculates Q=u*G

3.2. The signer calculates h=HASH(Q). This is a commitment to Q.

3.3. The signer sends h to the user.

3.4. The user selects a random integer t from [1, n−1].

3.5. The user sends t to the signer.

3.6. The signer sends Q to the user.

3.7. The user verifies that HASH(Q)=h. If not equal, then the signer is cheating.

3.8. The signer calculates k=t*u.

4-7. These steps are similar as the standard protocol.

8. The user calculates the curve point (x_2, y_2)=t*Q.

9. The user verifies that r=x_2 (mod n). If not equal, then the signer is cheating.

This protocol guarantees that the r value is chosen uniformly random from the set of x-coordinates of curve points, and at the same time guarantees that the user cannot arbitrarily force this value.

It must be noted that the protocol should not be repeated unlimited times if it fails. If failure occurs after step 3.5, and not before step 6, because of the signer not responding properly (either providing and invalid message or by not responding at all), then a new iteration of the protocol may allow the signer to leak some information. If the signer fails n times before finishing the protocol properly, then a side channel that hides approximately log 2(n) bits may have been tried. For an 256-bit ECDSA private-key, we would not recommend executing the protocol more than 16 times if is continuously fails, limiting the amount of information leakage to 4 private bits.

### Alternate Embodiment 3

This is an embodiment (herein ‘FirmChips’) are meant to be used as semi-private gambling tokens for brick-and-mortar casinos, to replace casino chips. They can store Bitcoins or other cryptocurrencies. Each Firmchip is NFC and Bluetooth low-energy (BLE) enabled (although a single communication means may suffice) and has a IR-LED and a visible light LED. Each Frimchip could be powered by RF or by a inductive coupling (also known as wireless charging) with the game table. A table of a game in he casino have one or more NFC or BLE (or both) master transceivers so the table can detect the presence of any chip on the table, by scanning and query the chip for funds. When you lay a Firmchip in the roulette table, a small lateral LED may start blinking on the firmchip. Also the table may detect the presence of a Firmchip by pressure or any other methods of multi-touch, such as Capacitive Technologies, Surface Capacitive Technology or Near Field Imaging (NFI), Projected Capacitive Touch (PCT), Mutual capacitance, Self-capacitance, In-cell: Capacitive, Resistive Technologies, Analog Resistive, Digital Resistive or In-Cell: Resistive, Optical Technologies, Optical Imaging or Infrared technology, Rear Diffused Illumination (DI), Infrared Grid Technology (opto-matrix) or Digital Waveguide Touch (DWT)™ or Infrared Optical Waveguide, Frustrated Total Internal Reflection (FTIR), Diffused Surface Illumination (DSI), Laser Light Plane (LLP), In-Cell: Optical, Wave Technologies, Surface Acoustic Wave (SAW), Bending Wave Touch (BWT), Dispersive Signal Touch (DST), Acoustic Pulse Recognition (APR) or Force-Sensing Touch Technology. The croupier checks that all your coins are flashing, and additionally he can check in a monitor the amount laid over each square is correct, because the table has already communicated with each one of the laid chips and queried each Firmchip for funds. If a chip is empty or counterfeit, the monitor tells this to the croupier. Also it is possible that the FirmChip emits a modulated visual or infra-red signal transmitting the information (amount, name) of the chip, so that the croupier can clearly verify the funds on every Firmchip using an augmented reality systems, such as a Head-mounted, Eyeglasses, Contact lenses, vitual retina, EyeTap, or displays. The augmented reality system would project the information regarding amount of funds on every chip near the FirmChip. Also the augmented reality system could compute the total number of funds of all Firmchips that are laid in a stack and project the result on top of the top of the stack. Using cumulative funds the croupier can compute faster the amount of money wagered on a table box. It is also possible that the system automatically takes a photograph of the Firmchip and analyzes the image identifying the Firmchip (e.g. type, manufacturer, printed amount) and then automatically compares this to the information provided by a visual or infra-red data channel, detecting possible counterfeit Firmchips. Also the table itself can be a big LCD screen, so the time the chip is placed, it immediately tells the money balance over the square. If the player wins, the croupier pays the user with additional preloaded firmchips, or instantaneously loads empty firmchips taken from a box. It is also possible that chips can be added an identifier to track the owner over the casino. The cost of the chip is unimportant, since players will gladly pay the initial cost to buy them in order to be free to play in any casino, at any time.

When the player wants to cash out the chips, they just need to put them near their smartphones, and the smart-phone runs a software that allows the transfer of the cryptocurrency stored in the Firmchip their Bitcoin accounts (called wallets), and the Firmchips become empty. Player can also go away with the firmchips, to use them in another time, or to cash them out later. Players are able to play more privately than buying the chips with a credit card since no record of the buy is registered in the credit card company.

### Additional Embodiments

A1. The Firmcoin, before sending the asset private-key to the user, enters a special internal state called “no-funds”. The private-key is NOT immediately wiped. You can query the device for the private-key as many times as you want until you're satisfied the transmission has no errors. Then you send the Firmcoin a command “wipe” and the Firmcoin will wipe the private-key. The Firmcoin will never go back to the state “funded” after the state “no-funds” without going through the state “create-new-key”.

A2. Anyone can load a user-provided certificate to the Firmcoin to try to prove the Firmcoin has coins loaded, the Firmcoin will accept any certificate and store it in non-volatile memory. The Firmcoin can have many user provided certificates. Third party companies or non-profit foundations can provide certification of funds. Nevertheless, the Firmcoin will only visually indicate to the user the presence of a certification for certificates issued by the manufacturer (or an approved subsidiary).

A3. The user can query the Firmcoin with a NFC-enabled smartphone and the Firmcoin will tell the user if it has assets associated or not, and provide you with the digital certificates to prove this fact stored in non-volatile memory.

A3.1. An LED flashes when it has assets associated, when the user touches it. In this embodiment, the user trusts the manufacturer.

A3.2. A smart-phone is loaded with a special application that carries the UXTO database set of a cryptocurrency (and the user tries to update UXTO database at least once each day).

A Firmcoin will only respond that it has funds (associated assets) if the transactions that fund the Firmcoin are at least one day old.

A3.3. A smart-phone is loaded a special application that allows to take a photograph the Firmcoin and checks its random features against a small database of physical features you can download from the servers of the Firmcoin manufacturer.

A3.4. The Firmcoin proves it has a private-key related to a certain public key (without the Firmcoin disclosing the private-key).

A3.5. The manufacturer provides access to an online database which can track which addresses are associated with each Firmcoin.

A3.6. The manufacturer provides a service for users to upload the photographs of a Firmcoin and automatically check the authenticity of the Firmcoin photographed against high definition images taken during the manufacturing process.

A4. Following are three methods to reload assets (coins):

1. The user sends the public key x to a Firmcoin server (or any other server most people trust), and the server returns you a signed message “I certify that the public key x has y funds”. Then the user loads this certificate into the Firmcoin.

2. The user provides the Firmcoin with a block-chain branch of at least 144 blocks (an average 1 day of Bitcoin blocks) with the current difficulty, where the first block contains a transaction that funds the Firmcoin, along with the Merkle tree. This can be done privately, and anonymously. The firmcoin verifies and may accept this message as proof of association. For other cryptocurrencies, more or less number of blocks may be required.

3. To load funds into the Firmcoin anonymously, the user can provide a block-chain branch to the Firmcoin (just as in the method 2) and ask a Certification authority to provide you a “checkpoint” at the last one block of the block branch. A checkpoint is a signed message that states “I certify that the block at height k hash the hash x”. Then you load the certification into your Firmcoin. The Firmcoin will store this certificate. If the certification authority is the Firmcoin issuer, the Firmcoin will indicate the certificate is present visually.

A6. The generation of a new key is a multi-party process. The Firmcoin first creates the private-key in the hardware, then the hardware tell the user the public key. Then the user provides a user-chosen random or pseudo-random multiplication factor to the hardware and then the hardware multiplies both the private and the public key.

Then the hardware manufacturer cannot know the private-key. This is not new and some other people have proposed similar methods (like adding two keys). A variant is that the public key is not immediately revealed to the user, but a commitment to the public key is. After the user provides the user-chosen random or pseudo-random multiplication factor, the commitment is opened and verified by the user.

A7. When a user gives the Firmcoin to the other party in order to pay, he is giving any evidence or tamper. If an attacker has manufactured a counterfeit device, then he's giving the proof of the criminal act to the other party, so the other party can go legally against the attacker. This is a critical difference between the Firmcoin ant any other off-line payment system based on personal devices (PCs, smartphones, smart-cards, etc.)

Also the day a counterfeit device appears on the market, from that day on the Firmcoins will no longer be able to be verified off-line, but that doesn't mean they are useless. They still can be extracted of their private-keys. They can be reloaded and used as asset/BTC cold storage. So the incentive to an attacker is very low: he can just steal some very few BTC until everybody knows there are counterfeit devices in the market. No one will invest in manufacturing a special chip for such a low-reward attack.

A8. The Firmcoin has two capacitive buttons. You have to press only one to redeem the private-key. If you press both, then the private-key cannot be retrieved for a few seconds.

A9. Firmcoin do not have any master key, so there is nothing to extract in one Firmcoin that let you crack another FirmCoin. If you physically break your Firmcoin, nobody will accept it as payment.

A10. Passive side channel attacks try to compromise some information sent by a side channel such as RF without breaking the device. These kinds of attacks are based on the fact that the devices performs cryptographic operations using private-keys. Most vulnerabilities discovered require forcing the device to repeatedly do the same operation over and over in order to reduce the signal-to-noise ratio of an output signal. A Firmcoin can execute a private-key proof of knowledge operation. An attacker may try to attack that function with a side-channel technique. And this may be the weakest point of the strong Firmcoin security. Currently, to prevent side-channel attacks, the Firmcoin can have as many as four protective measures:

A. It uses a side-channel protected modular exponentiation algorithm

B. It uses randomization techniques to make it difficult to predict where an operation is taking place.

C. It limits the frequency of proofs the Firmcoin can execute, currently at 1 every 5 seconds (after the power is applied, you must wait 5 seconds before requesting such a proof).

D. It uses an industry standard tamper-proof micro-controller.

E. The manufacturer can remove the private-key proof of knowledge feature if power analysis tests show information leakage is possible.

Further embodiments regarding Software Attestation and Hardware-assisted Attestation

The disclosure presents a method and apparatus for attestation of software stored on any kind of storage medium accessible to a target computing device. The method relates both to the fields of software-based attestation and hardware-based attestation. An attestation method is a computer protocol that can detect if certain software stored on certain type of storage has been tampered, by sending to the attested device one or more queries and evaluating the device responses to the queries. A change in the kind of storage storing the software is also considered a tamper case. For example, the verifier may try to attest that a certain kernel is stored in RAM, and reject if the same kernel is stored on hard-disk. Software-base attestation means that the attested computing device does not provide any built-in method to assist the attestation procedure. In contrast, in hardware-based attestation the attested computing device provides a specific functionality built-in to help the attestation protocol. This disclosure relates to both software-based and hardware-based attestation. Some protocols allow the attestation to be performed remotely, which means sending the challenges/responses through a public network. Remote attestation requires the verifier to receive authenticated messages from the target computing device, so the computing device must be able to securely store secrets, which in turns require a Trusted Computing Module (TCM). Therefore Remote Attestation is always hardware-assisted. Nevertheless, we propose the first hardware-assisted method that does not rely on secrets stored on the target device, and so does not need for special tamper-proof storage. If the communication with the target computing device can be guaranteed to be authentic, such as when the verifier is connected directly by wire to the target device, then remote attestation is also possible for software-based methods. The methods proposed are not invasive, which means that the attestation is done over existent communication interfaces, as opposed to other attestation methods that may require physically opening the attested computer and probing the attested device.

Software-based attestation aims at verifying the software integrity of (typically) resource-constrained embedded devices where the software is stored in non read-only memory. Any software running on the attested device different from the expected software will be called malware. Malware will try to cheat the verifier to believe the target device is running the authentic software. Software attestation cannot rely on stored secrets (such as cryptographic keys) since if the attacker has manage to install malware on the target device, then the malware can also access those secrets. Also by definition software-based attestation cannot rely on dedicated trusted hardware. Generally the attested software is stored on non-volatile memory, nevertheless software on volatile memory may also need to be attested. All prior software attestation techniques rely on a Verifier requesting the device to build a integrity checksum of the attested software and send the integrity digest (sometimes also called checksum) back to the Verifier, who tries to estimate the number of machine instructions executed by the target device during the generation of the integrity digest by measuring the time taken by the target device from the request to the return the digest to the verifier. The integrity sum used may be a simple additive checksum, a CRC, a special-purpose computation, a cryptographic hash digest, a MAC digest or a digital signature. All previous software attestation methods are based on the premise that, in order to hide from the integrity digest generation routine, the malware has to detect when the integrity digest computation routine is accessing a modified part of the software, and provide fake memory values, brought from another part of the memory, or computed on-the-fly. This requires at least one bound checking instructions. If memory addresses values update the integrity digest state in a pseudo-random order provided by the verifier, then the bound checking instructions must be part of the integrity check memory fetch loop, and the bound checking instructions must be executed for each value fetched from memory, which in turns adds a low but constant time to the whole integrity digest computation inner function [20]. For example, in [21] one of these methods called Pioneer is proposed. The authors claim the best possible malware increases a certain checksum computing time in at least 1.22%. The problem with this techniques is that unpredictable latency and jitter in communication with the target device may prevent accurate time measurements by the verifier. For example, operating systems impose unpredictable latencies to user applications due to task switching. The Pioneer paper solves this problem by proposing that the verifier runs a specially modified kernel that accurately time-tamps input and output packets. But patching the kernel is not always possible. In general, to distinguish the real time taken by the checksum function from the time measured by the verifier, noise must be filtered out. Generally some averaging method is performed, either by executing the protocol multiple times, or by check-summing the memory many times in the same protocol run. A user-application round-trip jitter of 50 msec is not uncommon in Windows operating systems I/O communications as measured by user applications. A method of multiple checksum passes, with a 1.5% detection threshold would take at least 4 seconds to accurately detect a 1.22% drift, and even then there is still the possibility of false negatives due to abnormal network latency, congestion or packet loss. Taking into account a minimal 0.25 msec latency, as described by the authors of the paper, the Pinoeer method requires the execution of 2,500,000 instruction in the check-summing function to reliably detect malware. If the target device is a low-end 1 mips micro-controller, such as in sensor networks that consume very little power, it requires at least 2.5 seconds.

Still another problem with timing-only based methods is that the target computing device must cease do execute any house-keeping routines during the attestation protocol, since any additional workload would signal a false negative. This precludes the use of the these attestation methods in always-online real-time devices. We present the SPAT software-based attestation method that allow reliable attestations with much shorter interruptions of real-time activities. We also present ISOPAGE, a simple improvement in the CPU of the target computing device that allows attestation using SPAT during normal operation and keep running hard real-time tasks with none or minimal interruptions.

### ADDITIONAL REFERENCES

[20] A. Seshadri, A. Perrig, L. van Doom, and P. Khosla. SWATT: Software-based attestation for embedded devices. In Proceedings of IEEE Symposium on Security and Privacy, May 2004.
[21] Pioneer: verifying code integrity and enforcing untampered code execution on legacy systems, Arvind Seshadri, Mark Luk, Elaine Shi, Adrian Perrig, Leendert van Doom, Pradeep Khosla,SOSP '05 Proceedings of the twentieth ACM symposium on Operating systems principles, Pages 1-16, ACM New York, N.Y., USA ©2005

Software Attestation: Overview to the solution of the Disclosure

The disclosure provides a method (SPAT) that precludes malware from passing successfully an attestation protocol by:

a. providing malware no place in memory or external storage to hide OR

b. amplifying considerably the time it takes to a malware to perform integrity checksum computations.

The SPAT method requires that the original software is stored in a practically-incompressible representation. A binary string is practically-incompressible if it is target-incompressible, practically-compact or both. A target-incompressible data string is a data string for which any compressed representation plus the decompressing program code (together the “derived data”) requires more space than the target-incompressible data string. In the limit case when a different data of equal size containing a decompressor program that when executed is able to output the target-incompressible data exists, then data is not target-incompressible. This is a theoretical property of the data, but it is very hard to prove. Instead most of the time we rely on the practically-compact property. A practically-compact data string is data string which, if it is compressed into shorter string containing a decompression program (“derived data”), then time required by the target device to decompress the data (with limited temporary memory resources) is much more than the attestation protocol time, and though it can be detected easily (or in the extreme, it can take infeasible computing time). Although is also theoretically difficult to show that the property holds for any derived data, for some data strings we can assure it with overwhelming confidence. If all the target device available storage (including the attested part and volatile memory) has practically-incompressible data, a verifier can attest the target device by asking the target device to give a raw dump of all accessible memories. Only if the attested software is authentic the dump arrives before a predefined time and the dump contents match the expected content, the target device is considered to has authentic software.

Software Attestation: Target-incompressible and practically-compact properties by examples

Clearly a random data string of sufficient length is almost always target-incompressible and practically-compact. Let i=H(x(i)), where H is a cryptographic hash function and x(i) is the preimage of i, then the data string x(1) . . . x(n) for a sufficient high n is not target-incompressible. To prove it, we create a program that, for each i, finds the preimage. A bound in computation time is not required for the target-incompressible property. Nevertheless the string x(1) . . . x(n) is practically-compact. if the hash function is well constructed, the function that computes the preimages of sequential indexes should be indistinguishable from a uniformly random variable. Then the string x(1) . . . x(n) should look statistically random and it is highly improbable that x(1) . . . x(n) can be compressed just by luck. Then the only way to compress x(1) . . . x(n) is by using the fact that x(i) values are the pre-image of small ordinal values.

Also a maximum compressed data string is practically-compact by definition, because the definition requires that, in order not to be practically-compact a string needs to have a shorter representation.

Software Attestation: Practically compact representations of data: from theory to practice

The limitation of temporary resources (RAM and CPU) means that certain functions like LZW decompression cannot be performed without a huge time penalty if no scratch memory is provided. LZW decompression requires hash/dictionary memory, with a standard minimum of 2Kbytes, and compression ratio is proportional to the hash/dictionary size. So a highly compressed data string may be practically-compact if the temporary memory given to the target device during the attestation protocol is lower than 128 bytes, even if there exists an alternative compressed representation with higher compression ratio.

If the system designed is not satisfied with the security margin of compressing the original data, then we can increase the security margin considerably. As previously explained, a cryptographic hash function H can be used to create practically-compact data, but we also need that this data can be easily converted in our original machine-code data (or any other data type) in a representation that is useful for executing or processing the “original data”. We'll present several methods to create practically-compact data strings from an original data string, using an asymmetric-time function. An asymmetric-time function is a function, that for a subset of its inputs, is invertible, but computing the inverse of an element is much slower than evaluating the function on an element. Computing an Asymmetric-time function in one of the directions is “practically-slow”. Here “practically-slow” is only defined in relation with attestation time. The term “practically-slow” in this context means that the verifier will easily detect that an asymmetric-time function is executed in the practically-slow direction during attestation. Asymmetric-time functions can be built from hash functions, one-way permutations, T-functions and trap-door permutations. Ideally the function should preserve size and generate outputs that cannot be distinguished from a statistically uniform random variable. If size is not preserved, then the target device must have enough non-volatile storage to store the expanded data. We show examples of useful asymmetric-time functions.

To be sure that the target device does not have free space to hide software, then we must also fill the unused non-volatile memory with practically incompressible data (called padding) and also we must fill the volatile memory of the target device (generally RAM) with practically incompressible data. Padding can be filled during system design, while volatile memory must be filled during the attestation protocol.

To summarize, if we want the software stored on the attested memory to be practically incompressible for an attacker, then the content, the padding and the volatile memory must be practically incompressible for the attacker. Since the content contains by definition some information, it has lower than maximum entropy, and so it is theoretically compressible. We must make sure that either:

1. The content cannot be compressed much (because it is already compressed)

2. The time it takes to decompress something into the content exceeds a bound set by the system designer (time bound b)

3. The compression/decompression routine size is higher than the size gained by compressing the content.

4. The volatile memory required for decompression in not available during the attestation protocol.

Next, the disclosure presents some practical examples of asymmetric-time functions.

Software Attestation: Asymmetric-time functions: Domain-reduced Hash Functions

A domain-reduced hash function is a hash function where the domain is restricted to some reduced set of values. Suppose we wish to attest a data string stored in 32 Kbytes of FLASH of a target computing device running at 80 mips. Let a(1) . . . a(n) (n=1024) be the machine-code data string that we wish to re-encode in a practically-compact string d(1) . . . d(n), where each a(i) and each d(i) block is 4 bytes in length, and all a(i) blocks are different (if they are not, the string a(i) is previously compressed using a standard compression library, and as a result there should be no repeated blocks). Let T(j)=(H(j) mod 2̂32) for (0<=j<2̂32). We define MIN_INDEX(x)={minimum j such that T(j)=x}. We set d(i)=MIN_INDEX(a(i)). To compute d(1) . . . d(n) efficiently, we build a hash table T⁻¹ such that T⁻¹ [x]=MIN_INDEX(x), by iterating j through from 0 to 2̂32−1 and setting T⁻¹[H(j)]:=j, if T⁻¹[H(j)] is empty. Then for each index i we set d(i):=T⁻¹[a(i)].

There is no guarantee that the resulting d(i) values will be lower than 2̂32. For any i, there exists a 1.2% probability that a d(i) value will be greater than 2̂32. This problem will be referred as Expected Range Overflow (ERO). ERO arises because hash functions are not bijective and there may be collisions. Nevertheless, is highly probable than the resulting d(i) will have no more than a few additional bits. To store the d(i) values in a packed representation we should indicate the term bit length and store only the meaningful bits, so we need bit packing routines. To avoid bit packing, the overflow bits can be stored in an additional table. There are other solutions to the ERO problem. For example, suppose that MIN_INDEX(a(i)) overflows, then one of the four bytes of the value a(i) can be xor-ed with a random byte r(i) before hashing so that the resulting d(i) value has no more than 32 bits. A record pair (i,r(i)) can be stored for each modified a(i) value in order to apply the inverse modification after hashing in boot time. We call this technique domain value perturbation.

But one of the disadvantage of using the MIN_INDEX function is that it creates a small bias towards lower index values, and so in principle there may be a way to compress the string d(1) . . . d(n).

Software Attestation: Asymmetric-time functions: Truncated Hash Functions

A truncated hash function is a hash function from a reduced domain to a reduced range. For example, let H′(x)=x mod 2̂40, for (0<=x<2̂32). H′ is a truncated hash function. Suppose we wish to attest a data string stored in 32 Kbytes of FLASH on a target computing. Let a(1) . . . a(n) (n=1024) be the machine-code data string that we wish to re-encode in a practically-compact string d(1) . . . d(n). Again, each a(i) block is 4 bytes in length, but each d(i) block is 5 bytes in length. All a(i) blocks are different (if they are not, the string a(i) is pre-compressed). Let define RAND_INDEX(x)={random value j (j<=0j<2̂40) such that H′(j)=x}. We set d(i)=RAND_INDEX(a(i)). To efficiently compute d(1) . . . d(n), use build a hash table T⁻¹ such that T⁻¹[x]={y such that H′(y)=x}, by iterating j through from 0 to 2̂40-1 and including in the set T⁻¹[H(j)] the value j. Then for each index i we set d(i):=a random element of the set T⁻¹[a(i)].

Now there is no bias towards zero in the d(i) values, but there still exists the probability that, for some i, no RAND_INDEX value is found. This probability can be made negligible by choosing a function range one or more bytes greater in length than the domain byte length. Nevertheless if case special is found for a certain i, a perturbation of the a(i) value can avoid such special case. After running the d(i)->a(i) transformation of the block, the a(i) block is reestablished to the original value by undoing the perturbation.

Software Attestation: Asymmetric-time functions: Mixing highly non-linear T-functions with bit-shuffles

A way to achieve an asymmetric function is by building a one-way permutation. One way to build one-way permutations is mixing invertible, non-algebraic and highly non-linear T-functions with bit-shuffling operations [x10] [x11] [x12] [13].

For example, let T(x)=x+(x̂2 v 5). Let S1 . . . Sn be n fixed random permutations that perform bit-shuffles. Then F(x)=T(Sn(T(Sn−1(T( . . . S1(x)))))) is a bijective asymmetric-time function for high enough n value.

Also MDS matrices (optimal invertible linear mapping of diffusion) may be used to build Asymmetric-time functions.

Software Attestation: Asymmetric-time functions: Number-theoretic Asymmetric-time functions

Another way of archiving a practically-compact data is by using standard algorithmic assumptions regarding number theoretic problems. One of these assumptions is that current modular exponentiation algorithms are the fastest possible, so there will not be any fundamental improvement in modular exponentiation speed. One standard cryptographic algorithm is the Pohlig-Hellman cipher, which is based on modular exponentiation. Let p be a large prime number of k bits length, let b+i=x(i)̂3 (mod p), where b is an arbitrary base (k−1)-bit value. If p is a prime chosen at random, normally the inverse of this function will require the exponentiation to a number of approximately k bits. Then x(1) . . . x(n) is a practically-compact data string,

Practical example: Suppose we wish to attest a data string stored in 32 Kbytes of FLASH of a target computing device running at 80 mips. Suppose we take k=1026, and p is a safe prime number randomly chosen where p is bigger than 2̂1025 but lower (2̂1025+2̂512). Let e=3. Let j be the inverse of e mod (p−1). Let a(1) . . . a(n) (n=256) be the machine-code data string that we wish to re-encode in a practically-compact string d(1) . . . d(n), where each a(i) block and each d(i) block is 128 bytes in length, and all a(i) blocks are different. Then to build the data to attest, each a(i) is converted into a big integer value, then a base value b is added (b is a fixed randomly chosen 1024 bit value), and the result is elevated to the third power mod p. We have:

d(i)=(a(i)+b)̂j(mod p).

The data string d(i) . . . d(n) is the data that will be attested. At boot time, each a(i) term is computed as a(i)=d(i)̂e-b (mod p). Suppose it takes approximately 5 msec to compute each term a(i) from the corresponding term d(i). Then the boot time is approximately 12.8 seconds. Computing the term d(i) from the corresponding a(i) by elevating to d requires more than 300 times the opposite computation, so it takes more than 1.5 seconds. Suppose the checksum routine takes 50 msec to checksum 32 Kbytes. Then the verifier sets a threshold of 100 msec to expect a response, and reject the target it it takes more than threshold time to emit the response. Then is clear that an attempt to compute d(i) from a(i) during the attestation protocol will be easily detected. The higher the amount of memory to attest, the higher must be the prime bit length.

Software Attestation: Asymmetric-time function: Public-key cryptosystems

Another way of archiving a practically-compact data is by using strong number theoretic assumptions established by cryptography standards. Strong public key cryptosystems can guarantee that decryption is infeasible without knowing a certain private-key. A strong public key cryptosystem, when the private-key is not available to the attacker, is therefore an extreme asymmetric-time function.

Practical example: Suppose we wish to attest a data string stored in 32 Kbytes of FLASH of a target computing device running at 80 mips. We'll use the RSA encryption method. To build the practically-compact data string, new RSA keys (d,e,n) are generated, where e=2̂16+1 is the public-key, n is a 1025-bit modulus and d is the private-key. Let a(1) . . . a(n) (n=256) be the machine-code data string that we wish to re-encode in a practically-compact string d(1) . . . d(n), where each a(i) and each d(i) block is 128 bytes in length, and all a(i) blocks are different. Each a(i) is converted into a big integer value and a fixed random base value is added, Let d(i)=(a(i)+b)̂d (mod n). The data string d(i) . . . d(n) is the data that will be attested. At boot time, each a(i) term is computed as a(i)=d(i)̂e-b (mod n). The private-key d is destroyed. To avoid the ERO problem, a modulus value can be searched that has a number of zero bits after the leading 1 bit. If n has z zeros bits after the leading 1, then the overflow probability of an encryption is 1/2̂z. Perturbation of inputs, as described before, can also be used to avoid overflow. Also standard RSA padding can be used, with the only drawback of increasing the amount of storage required. The ElGamal cryptosystem, the LUC cryptosystem and the Rabin cryptosystem can also be used.

One of the disadvantages of using a public-key cryptosystem is that if the attacker colludes with the system designer, the attacker will be able to cheat the symmetric-time function and perform the practically-slow direction much faster. One solution is use a modulus whose size is big enough such that a single full-size modular exponentiation takes enough time that can be detected by the verifier. Practical performance results vary, but for low-end microcontroller a 512-bit modular exponentiation is more than enough (see table).

PIC18F452@40 Mhz requires 120 seconds [x7].

dsPIC30F3013@30 Mhz requires 15 s.[x7].

ATmega128 @ 8 MHz it requires 5.37 seconds. [x8].

A CC1010 @ 14.7456 MHz requires 53.33 seconds.[x8].

If using an accelerated micro-controller, such as the MAXQ30 @ 65 Mhz, a 1536 exponent will lead to at least a 187 msec computation time. [x9]

For any of the asymmetric-time functions described, one can prevent a(i) values from unexpectedly repeating by mixing the a(i) value with the previous processed value d(i−1) before processing the a(i) value. The mixing can by xor, addition or other operation more suitable for the asymmetric-time function. This is similar to the CBC block chaining method of block-ciphers.

Software Attestation: Restricting the properties of attested data for greater security

The defined properties (target-incompressible and practically-compact) can be more restrictive by specifying that a slight grater size of the compressed data is also disallowed. We define n-target-incompressible data similar as before, we also consider a derived data with n more bytes than uncompressed data. Corresponds, an n-practically-compact data is a data that considers a derived data n bytes longer than the uncompressed data, and has the same limit on the decompression time. A n-target-incompressible data will always be target-incompressible, but not the other way round. In practice we'll always work with the more restricted versions of the properties for small n value, since we must protect the system from possible leaks of free memory space available to the target device that were not considered by the system designer. For instance, we may consider that all processor registers may be used by malware, and set n equal to the number of bytes that the processor registers can store.

Software Attestation: Raw Dump vs Checksum vs Cryptographic Hash

Most of existent attestation protocols receive a challenge and send a short response that consist of an integrity check code. Also most methods rely on integrity checking functions with special properties, such as implementing a certain mathematical function in the fastest possible way. This precludes the use of standard well-studied cryptographic hash functions or MACs for the purpose of computing the integrity code, because the code of standard hash functions is so complex that is almost impossible to be sure a certain implementation is the fastest possible for a certain target device. Also these methods cannot generally send a raw dump of the memory as prove of integrity, because the output communication channel does not generally provide enough bandwidth to transmit each memory value as it is read from memory. Nevertheless the SPAT method does not have this constraint, since, even if it limits the response time, the security of the method relies on higher timeouts, and the system can be designed so that timeouts can even be set to years. So if the communication channel bandwidth is such that the whole memory can be dumped in less than a few seconds, is preferably to implement the attestation protocol in that way that the target device sends the raw memory contents. This is also the simplest implementation. If the channel is a low level hardware interface, such as UART, the number of program instructions required for the loop should can be as low 8 machine instructions (one main loop with an inner loop to wait for the UART to be ready) and consume only one word of processor register memory. Assuming 2 bytes per word, that is 18 bytes, In this case, the system should be designed as 18-practically-incompressible. If the dump is sent in the same order that it is received, the verifier must check that no byte is received until all the random data has been sent, to avoid using the communication buffers or the verifier itself as temporary storage. Another simpler possibility is that the dump is sent in reverse order, so that the first byte to send by the target device is always the last byte having arrived to it.

There are systems where is not desirable that the whole memory can be dumped, for instance, because of information security concerns. Also it can be the case that the communication channel is slow (such as NFC), noisy or the target device frequently reboots. Then it is preferable to compute an integrity check of the memory instead of dumping it. To prevent a malware from repeating a previous response (reply attack) the attestation protocol must be designed as challenge-response. The integrity check routine must have the properties that the result is highly dependent on a challenge value, and it does not allow any pre-computation without the challenge. Any standard secure cryptographic hash functions, such as SHA-2 will do. But at the same time the integrity check routine must be short and use very little temporary memory to prevent compression. Also the integrity check function must be included (as machine-code representation) in the attested software. For example, an x64 implementation of SHA-256 requires approximately 250 bytes of program code and 100 bytes of RAM, totaling 350 bytes. A more compact hashing function may be selected. There are many lightweight hash functions proposed in literature, such as PHOTON, SQUASH and ARMADILLO, or the Salsa20 Core. Also the XTEA encryption function is short and uses no additional temporary memory so is a good candidate to build a lightweight hash function: the first key is set to the challenge value and a 64-bit block of memory is encrypted. Afterward the key is rotated adding the previous ciphertext as key and a new block is encrypted and the process is repeated. Other standard methods are Davies-Meyer and Matyas-Meyer-Oseas. The final ciphertext is a 64-bit hash digest. This XTEA hashing function requires 24 bytes of temporary memory and can be implemented in a 8-bit AVR micro-controller with 100 instructions (224 bytes total). An x66 implementation requires 45 instructions and 24 bytes of temporary storage, totaling 124 bytes [x6]. These lightweight integrity check functions should be secure since it is highly unlikely they can be compressed (see following section on average decompression code sizes).

To summarize, the higher the memory consumption of the challenge-response routine (either in program size or in temporary storage) the higher the probability than an attacker manages to create a malware that contains a compressed representation of the original challenge-response, a decompression routine, and a second routine that performs the challenge-response in a malicious way.

As an additional security measure, the challenge value can be computed with fair coin-flips by both the verifier and the target device. This prevents the target device from cheating the verifier by forwarding the challenge to another similar but authentic computing device secretly, and performing a man-in-the middle attack.

Software Attestation: ROM storage of the Challenge-Response routine

If the target device has ROM, the SPAT method can benefit and increase the security margin. The routine that implements the Challenge-Response can be stored in ROM and do not use RAM for program storage. This in turns allows the full RAM to be filled with random or pseudo-random data by the verifier, preventing any attempt compress code and rely only on the security of the asymmetry-time function. Also, if ROM is available, it can include a standard boot-loader that creates the original representation of the practically-incompressible data string by transforming data read form non-volatile memory. This way, the hardware manufacturer can provide the SPAT attestation method off-the-shelf, with little hardware resources. Another advantage of ROM is that it allows normal house-keeping activities of the processor to be active during the attestation protocol, by storing the controlling routines also in ROM. The attestation protocol will still be secure as long as the ROM content is practically-incompressible. For most machine-code programs, the security threshold should be around 500 bytes.

Using ROM is not an optimum solution, since those routines won't allow upgrades in the future. The disclosure presents an alternative hardware assisted attestation method that requires minimal hardware modification.

Software Attestation: Software-unfriendly Hardware-friendly functions (SUHF)

There are some functions that are very easy to be computed by hardware but require many operations to be performed by software using standard instruction sets. We call these functions software-unfriendly hardware-friendly functions (or SUHF). For example, let y=F(x) be a function that permutes the bits of y under a random mapping, but where each bit is shifted a different number of positions or at least most of the shifts are distinct taking into account circular shifts. Clearly this function can be implemented efficiently in hardware, as it does not require any additional gates (only proper tracing and layering). In contrast performing this function in software generally requires at least 3 instructions per shifted bit (one shift, one and-masking and one or-ing with the result). Using precomputed tables the operations can be optimized, but we can limit the degree of optimization the software can obtain by choosing the SUHFs carefully. The SUHFs may also not be functions but operations and have an internal hidden state that may use as input. Nevertheless this does not improve the overall security.

One technique to improve the performance of bit-permutations in software is by computing many operations in parallel using bit-slices. Nevertheless we can design an integrity check function that applies F sequentially over the computations based on previous results, so that there no gain in using parallel permutations. One of the desired properties that we'll require on SUHF's is that they preserve entropy as most as possible. Ideally a SUHF's should be a bijection.

One possibility is that the SUHF function G(x) is built on a T-function T(x) combined with a bit-shuffling B(x) where G(x)=B(T(x)). Let n be the word size. Let x[i] be the i-bit of X.

The T-function Y=T(x) can be built such that:

y[i]=x[i] xor R(i), for i in [0 . . . n−1]

For i in [4 . . . n−1]

R(i) is a boolean circuit that outputs a single bit, using 3 random basic gates (AND,OR,NAND,NOR) on four random input bits at indexed B(i,0), . . . , B(i,3)

Random bit indexes are chosen such that B(i,j)<=i (this makes the function triangular)

Each circuit R(i) has the structure R(i)=G2 (G0(B(i,0), B(i,0)), G1(B(i,2), B(i,3))), where G0, G1 and G2 are the random gates.

B(i,j) are taken with the property that displacements between gate inputs (abs(B(i,0)-B(i,1)) and abs(B(i,2)-B(i,3)) are randomly uniformly distributed. This prevents using shift opcodes to accommodate in the same position many inputs together to perform many simultaneous gate evaluations using a single AND/OR instruction.

For i in [0 . . . 3]

R(0) is built with one NOT or no gate operating on x[0].

R(1) is built with 1 basic gate operating on x[0] and x[1].

R(3) is built with 2 basic gates operating on x[0], x[1] and x[2].

The depth of this SUHF function is only 2, and it requires no more than n*4 basic gates, plus n xor gates. N should be at least 64 to prevent the use of precomputed tables.

If we do not need the SUHF to be invertible, we can use a one-way hash function as long as we mix the result with the input to maintain most of the input entropy. For example, let x[b] be the b-bit of x, let G be the following function from a 16-bit unsigned integer to a 16-bit unsigned integer:

G(x)=((x[11] OR x[5])<<0) OR

((x[5] OR x[11])<<1) OR ((x[3] OR x[6])<<2) OR

((x[0] AND x[1])<<3) OR ((x[7] OR x[12])<<4) OR

((x[14] AND x[9])<<5) OR ((x[4] AND x[2])<<6) OR

((x[9] OR x[13])<<7) OR ((x[12] AND x[8])<<8) OR

((x[15] OR x[7])<<9) OR ((x[2] AND x[4])<<10) OR

((x[10] AND x[3])<<11) OR ((x[13] OR x[10])<<12) OR

((x[8] AND x[15])<<13) OR ((x[6] AND x[14])<<14) OR

((x[1] OR x[0])<<15)

This function combines input and output bit permutations plus the evaluation of 16 gates. It requires only 16 gates to be performed in hardware. Each gate inputs are taken such that almost all distance between inputs bit positions are used and almost all distances between input bit positions and output bit positions are used, in order to avoid software from using a single shift or circular shift instruction to shift the inputs of several bits together. This means that, in order to evaluate this function in software, it takes approximately 4 instructions per bit (2 shifts, the gate operation and OR-ing the result), or 64 instructions per function evaluation. To preserve entropy, we define M(x)=x XOR G(x).

Other functions that are slow in software are bit-expansions. Suppose that F takes a 16-bit number and transforms it into a 32-bit number. Each input bit is duplicated in resulting number, but output bits are shuffled. Then performing this expansion in software requires at 3 or 4 standard machine instructions per bit (depending on the bit state). For example, one of the branches will use a bit-test, (untaken) conditional-jump, OR result with mask, and inconditional-jump, and the other a bit-test, (taken) conditional-jump, and OR result with mask.

One have one or many SUHFs, then a suitable checksum routine can be constructed by mixing the SUHFs with other confusion and diffusion operations (such as T-functions) to construct good compression functions. If the SUHF already provides diffusion or diffusion, then only the missing operation (diffusion or confusion) may be added. A compression function is the standard building block of cryptographic hash functions.

Software Attestation: The ISOPAGE Method

Next, the disclosure presents a method to allow attestation of software to be performed even when the target device is running house-keeping routines, since it does not require the target device to store all the original memory in a practically-incompressible representation nor it requires the target device to fill its RAM with pseudo-random data. Only a small part of the original software (the COAR, as explained below) should be practically-incompressible.

To use the ISOPAGE method we need assistance of special built-in hardware functions, on an improved target device, containing and improved CPU. We briefly describe the improvements of the CPU. The improved CPU has a special hardware module (that may be external o internal to the CPU) that performs one or more SUHFs, such as the ones discussed in the previous section. Also these modules may be accessible by extended instructions of the processor instruction set, or available though memory mapped registers or though in/out machine instructions.

To use the SUHFs, the software first has to enable them. When the SUHFs are enabled, a certain page of a RAM is considered isolated. Here we use the term “page” in a broad sense, and any memory area of any size, continuous or disjoint may be regarded as a “page”. Nevertheless, memory permissions are generally enforced in “pages” in standard CPUs, so using pages allows to integrate the method more easily with standard CPUs. The isolated page can be the page containing the current instruction pointer, a page specified by programmable registers or a fixed page of RAM. If the improved CPU has MMU, the isolated page is prevented from being swapped to disk, and it is locked on in RAM.

When the SUHFs are enabled, any read attempt to an address outside an isolated page from within the page will result in a zero value read or a processor exception being thrown. Optionally write attempts to an address outside an isolated page from within the page may end in no write performed, or a processor exception being thrown. This is optional since these writes do not pose a high security risk to the method. Also optionally, any read or write attempt from code running outside the isolated page to the isolated page results in a processor exception, or no operation performed. This restriction is only needed if normal house-keeping interrupts for which the ISR reside outside the isolated page should be enabled during attestation. The protections prevents both an doing an instruction fetch and an operator fetch on a memory cell or memory mapped device outside the isolated page boundary. Also disabling and re-enabling the SUHFs is penalized so that the user cannot easily switch isolated pages fast. Several penalization methods are possible:

a. When the SUHFs is disabled, an internal timer is reset and enabled, and the SUHFs won't be able to be re-enabled until the timer expires. The application code may have a register to query the state of the SUHFs in order to know if they are ready before telling the verifier to send the challence value.

b. When the SUHFs are disabled, a pseudo-random n-bit value is stored in a KEY register, which cannot be read by the program code. To enable the SUHFs, the value of the KEY register must be written in the INKEY register. Only if there is a match the SUHF's are enabled. The SUHF-enabling routine must iterate thought all possible key values until it finds a match in order to enable the SUHFs. An average of 2̂(n−1) instructions will be required to re-enable the SUHFs.

c. When the SUHFs are enabled, the SUHFs are still temporarily inaccessible, and an internal counter is set to a known top value. Afterward, writing or reading a shadow COUNTER register decrements the counter value. The SUHFs become usable only when the counter becomes zero.

The improved target CPU, when attestation is required, executes a Core Attestation Routine (COAR) generally provided with the attested software. Any part of or all the COAR may be stored in ROM. Storing parts of the COAR in ROM allows the COAR to be smaller and hence have more chances to be practically-incompressible or the COAR may contain additional routines. If preferable that the parts stored in ROM to be standard building blocks with proven security, such as a SHA-2 routine or the integrity check routine. If all the COAR is stored in ROM, then the isolated page can be set to be in the ROM itself, and all temporary memory usage must be done using the processor registers.

A COAR that can disable interrupts is given as the following example:

Disables hardware interrupts.

Enables the SUHFs (I/O registers and I/O ports cannot be accessed now.)

Checks that interrupts are disabled, if not, aborts.

Computes an integrity check of the all or part of the isolated page (using one or more passes), starting from a verifier-provided challenge value, and using the SUHFs in the integrity check computation, usually using at least one SUHF after each fetched byte or word from the isolated page memory.

Disables the SUHFs (I/O registers and ports are now available again)

Sends the integrity check digest to the verifier

Performs a new integrity check function (different from the previous one. Not using the SUHFs) over (at least) any interrupt handling routine that was active before the COAR began execution. If interrupt handling routines call library code, this code should also be included in the integrity check. Also any data that is used by the ISRs must be checked for correctness, to prevent benign ISR use malicious data and be commanded by the data to perform an attack. Optionally also add to the integrity check the code of an additional integrity checking function (this function can reside on any page of memory)

Verify that the integrity check digest is correct. If not correct, send an error message to the verifier

Re-enable interrupts

Optionally Jump to the additional integrity check function so it can perform an integrity check of the remaining memory areas that need to be attested.

If the additional integrity check digest is correct, send the verifier an positive answer. If not, send an error message to the verifier

The interrupts are only enabled when the ISRs are checked for correctness, but before all the programs in memory (e.g. the operating system) is checked. This reduces the latency of interrupts but still may add considerably delay. the If the target device requires to attend hard real-time tasks during attestation then the COAR should not disable interrupts, and hardware should provide additional properties to allow concurrent execution of real-time tasks and the COAR. One of the possible implementations to provide task switching between the COAR and other tasks it is the following:

The SUHFs are controlled a flag: ATTEST. This flags may be stored the processor status word. The flag is cleared by default.

When the ATTEST flag is set to true, the instruction pointer MUST be withing the isolated page. If not, the ATTEST flag is not set to true, and possibly an exception occurs.

Any intent to re-enable the ATTEST flag while it is true, will not perform any action.

The SUHFs are enabled only if:

ATTEST flag is true

The timer/counter to delay switching on/off the SUHFs has elapsed.

The instruction pointer is within the isolated page.

If ATTEST flag is true, and the instruction pointer is withing the isolated page, any attempt to read or write outside the isolated memory page is forbidden. This prevents the COAR from reading data outside the isolated memory page.

If ATTEST flag is set to true, and the instruction pointer is outside the isolated page, any attempt to read or write inside the isolated memory page is forbidden. This prevents interrupt handling routines from communicating data to the COAR.

Some microcontroller architectures (such as the PIC18 family) have an internal hardware stack that is used when an interrupt occurs. The internal stack holds the return address, status word and work registers and this stack is inaccessible to the software, and so it cannot be used to communicate information from the ISRs to the COAR. In these only architectures the following additional properties are required:

Additional properties of architectures with hidden internal stack:

When an interrupt occurs, the previous value of the ATTEST flag is saved into the internal stack. After an ISR finishes, the ATTEST flag is restored from the internal stack. After the ISR returns, the ATTEST flag in the internal stack is set to zero, to prevent using the return-from-interrupt opcode to enable the ATTEST flag.

In other architectures (such as x86) the stack is allocated in RAM, and both the CPU and the ISR handle saving and restoring part of the CPU state to and from the stack in RAM. To prevent the use of registers and stack during interrupts to communicate information from the ISRs to the COAR in these architectures, some other protection measures are applied. First, if access to forbidden memory while ATTEST is enabled results in a a processor exception being thrown and the ATTEST flag to be set to false immediately. This prevents the use of the SUHFs for some time, since re-enabling the SUHFs, as discussed before, require to wait for some time. Second, when enabling the SUHFs, the stack pointer must be within the isolated page. If not, an interrupt would force the CPU to store the return address outside the isolated page, which would result in an processor exception being thrown. We could implement in the CPU a new hidden stack for interrupts when ATTST is true, and force the CPU to backup and restore all registers there on interrupt entry and exit respectively, but this requires many changes on the CPU microcode. So instead of forcing the CPU to provide all the CPU state saving and restoring built-in, we propose a software-only solution using an interrupt proxying method.

Suggested method to implement the ISOPAGE method on hard realtime systems implemented in architectures with stack in RAM:

The interrupt vector table has a “mirror” table, which is used only when ATTEST flag is true and the instruction pointer is within the isolated page.

The ATTEST flag is of the status word which is pushed on the stack during interrupt context saving.

Before setting ATTEST to true, all enabled interrupt vectors are saved in a table in the isolated page. The mirror table is filled with vectors that point to entry points within the page that will become isolated. For each of this entry point there is a special Proxy-ISR routine.

If an interrupt occurs the instruction pointer is within the isolated page, the CPU will read the mirror table and jump to the address of a Proxy-ISR routine stored within the isolated-page. The Proxy-ISR routine pushes all registers on the stack, restores the interrupt vectors, sets the stack pointer to a preconfigured stack outside the isolated page, and issues a software interrupt for the corresponding interrupt vector.

When the CPU executes the software interrupt, the ATTEST flags is true, the source instruction pointer is within the isolated page but the jump address is outside the isolated page, all CPU registers (except for the instruction pointer) are cleared, the interrupt vector is read from the original vector table (not the mirror table) and execution continues normally. The page barrier is crossed without any exception being thrown. The only information passed from to COAR to the outside pages is normally the status flags and the previous instruction pointer (e.g. EFLAGS and CS:IP in an x86 device)

When the original ISR is over, an return-from-interrupt will be executed. The processor will restore the instruction pointer and then try to restore the status flags from the stack. If it detects ATTEST is true, the source instruction pointer (return-from-interrupt) is outside the isolated page and the restored jump address is within the isolated page, then the CPU clears all CPU registers and continues normally. This will result in jumping to the instruction following the software interrupt call in the Proxy-ISR routine. The routine finally restores the state of the COAR registers, the interrupt vectors and executes another return-from-interrupt opcode. This will return to the COAR code, in the state it was before the interrupt occurred.

Note that manually pushing a status register, a return address and executing a return-of-interrupt opcode may be used to command the CPU to set the ATTEST flag. This could be used as an attack vector to jump to any location within the isolated page. This in turn can be used to send information from outside the isolated page to the isolated page, since a malicious COAR routine may interpret each different jump location as a different value to be transmitted. One way to prevent this attack is to force the return address of an interrupt to be a fixed relative address within the isolated page (e.g. the first, last or a middle address), when the ATTEST flag is true. Without loss of generality we'll assume that any software interrupt executed within the isolated page that does not lie on the first instruction of the isolated page results in a processor exception. This means that the values pushed on the stack when the software interrupt is called (generally the status word and the return address) contains no information, since the status word will contain all bits in fixed a default (zero or one) state with the exception of the ATTEST flag in true, and the return address will always match the following instruction on the base address of the isolated page.

Last, as described in the Pioneer paper, the COAR routine may mix operations with the instruction pointer and processor registers values with the computed integrity check value inside the integrity check routine as an additional protective measure against an attacker modifying registers in unknown ways.

TABLE 2
Summary of actions performed by the CPU for different cases.

| Cases when ATTEST | | | |
|---|---|---|---|
| is true. | Source address | Jump Address | Action |
| Write | Outside LP | Inside LP | Forbidden |
| Write | Outside LP | Outside LP | Allowed |
| Write | Inside LP | Inside LP | Allowed |
| Write | Inside LP | Outside LP | Preferably Forbidden, but may be |
| | | | Allowed |
| Read | Outside LP | Inside LP | Preferably Forbidden, but may be |
| | | | Allowed |
| Read | Outside LP | Outside LP | Allowed |
| Read | Inside LP | Inside LP | Allowed |
| Read | Inside LP | Outside LP | Forbidden |
| Return-from-interrupt | Outside LP | Inside LP | Perform normally but, before restoring |
| | | | execution, clear all registers (except for |
| | | | the instruction pointer) |
| Return-from-interrupt | Outside LP | Outside LP | Perform normally |
| Return-from-interrupt | Inside LP | Outside LP | Throw processor exception, clear |
| | | | ATTEST flag. |
| Return-from-interrupt | Inside LP | Inside LP | Perform normally |
| Hardware interrupt | Inside LP | Inside LP | Read vector from mirror table, perform |
| | | | normally |
| Hardware interrupt | Inside LP | Outside LP | Throw processor exception, clear |
| | | | ATTEST flag. |
| Hardware interrupt | Outside LP | Inside LP | Throw processor exception, clear |
| | | | ATTEST flag. |
| Hardware interrupt | Outside LP | Outside LP | Read vector from original table, perform |
| | | | normally |
| Software-interrupt | Inside LP | Outside LP | Read vector from original table. |
| | | | If instruction address is at offset zero of |
| | | | the isolated page, clear all registers (*) |
| | | | and perform normally. |
| | | | If instruction address is not at offset |
| | | | zero, throw processor exception, clear |
| | | | ATTEST flag. |
| Software-interrupt | Inside LP | Inside LP | Read vector from mirror table. |
| | | | Perform normally |
| Software-interrupt | Outside LP | Outside LP | Read vector from original table. |
| | | | Perform normally |
| Software-interrupt | Outside LP | Inside LP | Throw processor exception, clear |
| | | | ATTEST flag. |

(*) The cleared registers includes all flags in the status word with the exception of the ATTEST flag.

If the relation in checksum time of a software-based integrity check routine and the SUHF assisted routine is N, then as long as the interrupt handling code does not consume more (N−1)/N fraction of the CPU, the COAR code will be able to be successfully attested. If we use the SUHFs multiple times for each memory value fetched in the integrity check loop, then we can increase the N value almost as much as the number of instructions required to perform the SUHFs in software (assuming executing a SUHF takes a single machine instruction on the improved CPU). For a 16-bit device, a value of N=50 may be easily accomplished, and this gives almost 98% of free processor time for house-keeping activities during the execution of the attestation protocol.

A possible attack is that code execution outside the isolated page transmits data to the isolated page by encoding the data in time intervals using a timer, so that when the timer overflows and the associated ISR is called, the COAR has measured the same time and so can decode the value sent. The COAR cannot read timer registers (I/O instructions and memory peripheral mapped registers are forbidden) but can measure the time elapsed by using a register as a free-running counter, manually incrementing it every few instructions. Time is used as a side-channel to pass information from the outside of the isolated page to the isolated page. We'll see that this method is inefficient, and we'll show how to prevent this attack even more. Suppose that the timer accuracy equates the instruction time. Then this method is inefficient, since it requires that, in order to pass k-bits, at least 2′1 bits instructions have elapsed. Suppose that entering the proxy-ISR, decoding the time value, packing the bit-value into a word and leaving the proxy-ISR consumes only 4 instructions. Then the most efficient way of transmitting information requires 32 instructions per byte sent. If the target architecture word size is 32 bits, and the SUHF is executed after each memory word fetched, then transmitting information using the time side-channel requires at least 128 instructions per 32-bit word sent. Assuming that the integrity check loop consumes 30 instructions (including the SUHF), then the malicious code will require 158 instructions to perform the same task, which leads to N=5.2. To prevent this attack even more, we can make the integrity check loop operate with the SUHF over some of the previously unused additional registers after each memory word is used. The COAR code will set initial values to these additional registers. Since the CPU will clear all registers returning from an interrupt into the isolated page, then those registers will need to be restored every time. If the number of additional registers is A, then the cost of sending each bit separately will rise to 4+A. In the x86 device, assuming a single register is used as a counter, the number of additional registers can be set to 11 (EBX,ECX,EDX,ESI,EDI,CS,SS,DS,ES,FS,GS). Then each value may be forced to take 15 instructions to be transmitted. In this example case, the optimum is to send 3 bits at a time (a delay from 0 to 7 cycles), which in turns makes a malicious side-channel integrity checking routine use 253 instructions, setting which leads to N=8.4. Also it is possible that the additional registers modify their value on each loop according to different functions, so that it is necessary to backup them restore them in each interrupt. This leads to an optimal of 4 bits per value sent, and a 336 instruction per loop, which leads to N=11.2. Of course, adding additional registers and push/pops also increases the interrupt latency for any real interrupt that should be handled during attestation.

Other attack vectors may involve transmitting information out of the target device from outside the isolated page, and receiving the information within the isolated-page. This is prevented, not allowing any I/O register or DMA page to lie within the isolated page, nor allowing I/O instructions (such as IN or OUT) within the isolated page.

Software Attestation: The ISOPAGE Method on Multi-Core systems

On multi-core systems, isolated page protections must apply for all processors. Also disabling and re-enabling interrupts must apply to all processors at once. For simplicity, only one processor must be allowed to set the ATTEST flag. An oversimplification would be to allow a single core to execute during attestation. A more appealing solution is to allow multiple cores running during attestation, but disallow the code in the isolated page to read or write other processor registers and to communicate with other processors using side-channels such as measuring the time is takes to execute an instruction that locks the memory bus, or access the cache. To prevent any possible leak, conflicting instructions should be disabled when executing code in a isolated page.

Nevertheless still a problem persist. Once the ATTEST flag is disabled in the COAR, other processors running malware may write to the isolated page and alter the integrity check. Then before disabling the ATTEST flag, the remaining processors must be either set to a predefined initial state, or the code running on those processors must be checksummed. If the other processors are running code that is not kernel code (not ring 0) then it is easy to attest those processes by checking that the memory access permissions (generally controlled by a MMU) does not allow those processes to access the isolated pages (after the isolation protection barriers are lifted by setting ATTEST to false), but this in turn requires that no kernel call (RING 0) operation is performed by the other processors during attestation.

To simplify attesting a multi-core system, and allow all cores running in ring 0 simultaneously, we'll restrict to the case where the kernel is either non-blocking or the blocking points in the kernel leave always leave the kernel data structures in a coherent state. Also we'll improve the CPU by introducing a two-level page isolation method. There are two isolated pages (LP1 and LP2). LP2 starts where LP1 ends. When ATTEST is true, and code runs in the LP2, the code can freely access any memory location. Nevertheless, if ATTEST is true, the other pages cannot read or write to any of them (LP1 and LP2). The COAR code instruction pointer can cross or jump from LP1 to LP2, but the SUHFs are automatically disabled once the instruction pointer is on LP2. Also, if ATTEST is true, then only the code that runs in LP2 can:

halt and resume other processors

unlock write-locked pages.

This is an example of a COAR for a multi-core target device which requires interrupts to be enabled during attestation. We assume that each kernel interrupt handling routine (both software and hardware) has a kernel optionally blocking point in the last instruction of each kernel ISR.

[In LP1] Enable interrupts for all processors.

Enables the SUHFs by setting ATTEST to true (the SHUFs must be ready to be enabled, internal enable delays must have elapsed).

Computes an integrity check of the all or part of the isolated pages (LP1 and LP2), starting from a verifier-provided challenge value, and using the SUHFs in the integrity check computation.

Jumps to an entry point in LP2

[In LP2] Disables the SUHFs (I/O registers and ports are now available again)

Sends the integrity check digest to the verifier

Halt all other processors.

Write-lock each page containing code and ready-only data to be attested. This prevents the other processors from re-writing those pages.

Resume all other processors.

Performs a new integrity check function over interrupt handling routines and any previously isolated code page or read-only page that needs to be attested.

Verify the correctness of the integrity digest by comparing to a stored or previously received value. If incorrect, then send an error message to the verifier and abort.

Ask the remaining processors to block on the any kernel blocking point. Waits until all other processors are either running out of the kernel, or in a kernel blocking point.

Halt all other processors. Check that all other processors are either in blocking points or out of the kernel.

Verify the coherency of the all the global kernel data and local processor data. If data is not considered safe, send an error message to the verifier and abort.

Resume all the processors

Send the verifier a positive answer.

This COAR only disables interrupt handling between step 13 and step 15 and between step 7 and step 9. Attested code pages first are write-locked and them checksummed to allow code checksuming to be performed while interrupts are enabled.

Software Attestation: Properties of a good Integrity check function for the isolated page Method

There are some properties that we may ask for the integrity check function to enhance the security. The method of the disclosure does not require the integrity check function to have a Time-optimal implementation as in {pioneer}. Nevertheless the implementation of the integrity check function should be near optimal; otherwise the adversary could use a faster implementation of the integrity check code and use the time saved to compute manually the SUHFs. Unfortunately, it is an open problem to devise a proofs of optimality of generic code. To achieve a near time-optimal implementation, appart from the SUHFs, we use simple instructions such as add and xor that are challenging to implement faster or with fewer operations. Moreover, the integrity check code is structured as code blocks such that operations in one code block are dependent on the result of operations in the previous code block. This prevents operation reordering optimizations across code blocks.

We also try to code the integrity check function with a instruction sequencing to eliminate empty issue slots. Most modern CPUs are superscalar, i.e., they issue multiple instructions in every clock cycle. If our integrity check code does not have a sufficient number of issuable instructions every clock cycle, then one or more instruction issue slots will remain empty. An adversary could exploit an empty issue slot to execute additional instructions without overhead. To prevent such an attack, we arrange the instruction sequence of the integrity check code so that the processor issue logic always has a sufficient number of issuable instructions for every clock cycle.

One way to enforce the integrity check routine has not been modified is by mixing the CPU state as inputs to the integrity check function. The integrity check code is self-checking, i.e., it computes a checksum over its own instruction sequence. The adversary can modify the integrity check code so that instead of checking its own instructions, the adversary's integrity check code computes an integrity check over a correct copy of the instructions that is stored elsewhere in isolated page. It is obvious that when the adversary performs this attack the adversary's Program Counter (PC) value or the data pointer value or both will differ from the correct execution. But since the isolated page is practically-incompressible, no copy of the integrity check code could exists on the isolated page. Nevertheless, we can add an additional layer of protection by making the adversary suffer an execution time overhead on this attack by incorporating both the PC and the data pointer value into the integrity check intermediate values.

The integrity check function code must be iterative. The integrity check code consists of three parts; the initialization code, the computation loop and the epilog code. The most important part is the computation loop. Each computation loop reads one memory location in the isolated page and updates the running value of the integrity check using the memory value read, some CPU state information, and the result of the execution of at least one SUHF over a previous computation state. The update operation should be such as to prevent the precomputation of steps without the knowledge of the previous input state, so the operations must be highly dependent on the inputs. Then, the adversary won't be able to forge a correct integrity check digest without doing each computation step in sequence.

The integrity check function should be preferably strongly-ordered. A strongly-ordered function is a function whose output differs with high probability if the operations are evaluated in a different order. A strongly-ordered function requires an adversary to perform the same operations on the same data in the same sequence as the original function to obtain the correct result. We can use a strongly ordered function consisting of alternate add and xor operations with two advantages: First, this prevents parallelization, as at any step of the computation the current value is needed to compute the succeeding values. Second, the adversary cannot change the order of operations in the checksum code to try to speed up the checksum computation. In addition to using a strongly ordered integrity check function, is preferable to bit-shuffle the intermediate state of the integrity check function. One possibility is to do bit rotations. Nevertheless, since SUHFs functions perform bit-shuffling very cheaply, it is preferably to let the SUHFs do the bit-permutations.

The integrity check function should have a small code size. The size of the integrity check loop needs to be small for two main reasons. First, in some target devices the code needs to fit into the processor cache to achieve a fast and deterministic execution time. Second, since the adversary usually has a constant overhead per iteration due to the use of SUHFs, the relative overhead increases with a smaller integrity check computation loop.

The integrity check function should have a low variance of execution time. Code execution time on modern CPUs is non-deterministic for a number of reasons. We want a low variance for the execution time of the integrity check code so that the verifier can easily find a threshold value for the correct execution time. The integrity check code should have enough CPU time resources running with a high CPU priority. Also the target device should be designed such that real-hard real-time tasks that run concurrently with the integrity check code do not take a CPU share higher than the (N−1)/N, where N is the ratio between the software only integrity check time and the SUHFs assisted integrity check time.

The integrity check function should be keyed. To prevent the adversary from pre-computing the integrity check before making changes to the verification function, and to prevent the replaying of old integrity check digest values, the integrity check needs to depend on a unpredictable challenge sent by the verifier, or agreed with fair coin-flip protocols. We suggest how to achieve this in two ways. First, the integrity check code may use the challenge to seed a Pseudo-Random Number Generator (PRNG) that generates inputs for computing the integrity check. Second, the challenge may also be used for the integrity check initial state, initializing it to a deterministic yet unpredictable value.

As in Pioneer, we suggest using a T-function as the PRNG [x10]. A T-function is a function from n-bit words to n-bit words that has a single cycle length of 2̂n. That is, starting from any n-bit value, the T-function is guaranteed to produce all the other 2̂n−1 n-bit values before starting to repeat the values. The T-function we use is x:=x+(x̂2 v 5) mod 2̂n, where “v” is the bitwise-or operator. Since every iteration of the checksum code uses one random number to avoid repetition of values from the T-function, we have to ensure that the number of iterations of the checksum code is less than 2n when we use an n-bit T-function. We suggest using n=64 to avoid repetition and precomputation. A Message Authentication Code (MAC) could be used for the integrity check function. But MAC functions may pose some drawbacks, the code and temporary data of current standard cryptographic MAC functions is typically large, which is against our goal of a small code size and temporary memory use to allow the integrity check code to be practically-incompressible and fit in the isolated page. Also, MAC functions have much stronger properties than what we require. Nevertheless, if the target device provides an hardware implementation of a MAC or it has a software implementation of a MAC in ROM, then this is of course preferable to any more simpler home-made construction.

Last, we may require that the Integrity check function performs a pseudo-random memory traversal of the attested data, where the pseudo-random function is build using the SUHFs. As previously stated, one way is by using method that generates all required memory addresses in a cycle, but in pseudo-random order, and without a shortcut to compute a certain index without computing all predecessors, with a T-function. We've said that transmission of data from code running outside the isolated page to code inside the isolated page is forbidden or inefficient. But we may want to protect if any of the page protection barriers fail. The use of pseudo-random memory traversal adds an additional protection layer. Suppose:

the order in which the memory contents is dictated by the pseudo-random function

the pseudo-random function can only be computed efficiently within the isolated page code.

Any attempt to transmit part of the authentic isolated page data in bulk (more than one data at the time) from code running outside the isolated page will require a list of addresses computed withing the isolated page code. Note that all the authentic data cannot be transmitted in bulk since the size of authentic data should be almost the size of the isolated page (minus some temporary memory cells). Since a routine that receives data from the outside of the isolated page require some code, then the free space that could be used as an I/O buffer is event smaller.

Then the code running withing the isolated page would need to transmit the list of memory cells required to code outside the isolated page. Then we've almost duplicated the required communication bandwidth. Still another protective layer would be to make the pseudo-random function

If we drop the need for the pseudo-random traversal function to generate all possible addresses before repeating, we can build a pseudo-random traversal function that depends on the intermediate states of the integrity check digest. Then, we increase the number of computation loops so that each memory cells will be read at least once with high probability. Then we stop any possible attack that transfers data from outside the isolated page to the isolated page in bulk, since to decide which data bytes to be send require the evaluation of the SUHFs on the previous data byte. We can use the result of the Coupon Collector's Problem to guarantee that the integrity check code will read every memory location of the verification function with high probability, despite the pseudo-random memory access pattern. If the size of the verification function is n words, after n*ln(n) memory reads, the probability that all memory location have been accessed is 0.5.

### ADDITIONAL REFERENCES

[x6] http://nayuki.eigenstate.org/page/tiny-encryption-algorithm-in-x86-assembly
[x7] https://sites.google.com/site/ortegaalfredo/pic18rsa
[x8] Comparing Elliptic Curve Cryptography and RSA on 8-bit CPUs, Nils Gura, Arun Patel, Arvinderpal Wander, Hans Eberle, Sheueling Chang Shantz
[x9] http://www.maximintegrated.com/app-notes/index.mvp/id/5145
[x10] A. Klimov and A. Shamir, “A New Class of Invertible Mappings,” Workshop on Cryptographic Hardware and Embedded Systems (CHES), 2002.
[x11] A. Klimov and A. Shamir, “Cryptographic Applications of T-functions,” Selected Areas in Cryptography (SAC), 2003.
[x12] A. Klimov and A. Shamir, “New Cryptographic Primitives Based on Multiword T-functions,” Fast Software Encryption Workshop (FSE), 2004.
[x13] Block Ciphers and Hash Functions, Alexander Klimov and Adi Shamir

Software Attestation: SPAT Definition

Let A be the original software ready to be machine-executed or interpreted by the code. We'll describe the most secure system setup, where A is both compressed and passed though an asymmetric-time function. The SPAT setup stages are shown in the FIG.ure.

Software Attestation: Generic SPAT Setup

Let R be the attestation challenge-response protocol implementation routine for the target device role. Let A′=R∥A.

If A′ is not target-incompressible:

Choose a compression method to highly compress A′ and to allow efficient decompression of A′ in the target device. Let D be the decompression routine. Let C=Compress(A′). Let A″=(D∥C).

Repeat the previous step with D (instead of A′), until the decompression routine it itself target-incompressible, adding the additional decompressing routines, and compressing the previous decompression routines.

Create a practically-compact representation of the original data by computing D=f(A″), where f is asymmetric-time function as previously defined.

Create a boot-loader code L. Set E=(L∥D)

If there is non-volatile storage space that will not be used to store E and will not be used for other purposes, create a pseudo-random padding P. (See next section for a description of the pseudo-random padding function)

Let F=(E∥P)=(L∥f(D∥Compress(R∥A))∥P).

Upload F into the target device non-volatile memory so that B is executed on device cold boot.

Software Attestation: Basic SPAT attestation protocol (protocol P0):

Verifier cold resets the target device (optional for greater security)

[Phase 1] Verifier sends random data to target device in order to fill volatile storage space

The target device fills volatile storage space with random data received.

[Phase 2] The target device sends a raw dump of all memory to verifier (including non-volatile and volatile memory, excluding read-only memory).

The verifier validates the received dump and the elapsed time.

Software Attestation: Generic SPAT attestation protocol using a checksum function (reduced use of communication channel bandwidth):

Verifier cold resets the target device (optional for greater security)

[Phase 1] Verifier sends random seed to target device

The target device fills storage space that is not used to store F (the “other” storage) with pseudo-random data derived from seed. This step is not always necessary.

[Phase 2] Verifier sends challenge string C to target.

Target device computes checksum of the data string F, starting with C, and sends the checksum to the verifier.

Verifier validates the received checksum value and elapsed time.

[Phase 3] Verifier sends challenge string C′ to target.

Target device computes checksum of “other” storage (with the exception of memory required by any of the previous steps), starting with C′.

Verifier validate the received checksum value and elapsed time.

If the verifier has control of when the device is powered-up, then he can just power-up the device just before doing the challenge-response verification protocol described before. Then the device has not time for precomputation. USB devices, for example, can be disconnected and re-connected by software. If there is no control of when power-up occurs, we can achieve the same initial state. We add a protocol phase 1 to verify that the device has not done any precomputation to respond to the challenge in a shorter time, and thus has an advantage to finish the attestation protocol before time bound b. This is useful if the attested software is not a sufficiently slow asymmetric-time function or it is not using an asymmetric-time function at all. The precomputation we want to prevent is the re-compression of A into C into after A is decompressed from C′ (where C′ is a compressed representation of A created by the attacker off-line). This is done by asking the device to store a random string whose size matches the device RAM (with the exception of some scratch registers) and then asking the device to retrieve the same string (and making sure that there are no information buffered in the connection layer before asking for the string). The memory filled must includes all volatile memory, with the exception of the memory required to execute the check-summing step. To prevent the use of the communication buffers as temporary memory, then we can ask the device to return the string in reverse order, or we can use the Space-PRNG function described in a following section.

To summarize, phase 1 and phase 3 can be skipped on certain target devices where all these conditions are met:

a. The verifier can force the target device to do a cold reset (wiping out all RAM) before the attestation protocol is executed.

b. All non-volatile memory is part of the attested memory data F.

c. The attestation protocol time is considered as starting from the cold boot time for design all properties.

d. The non-attested memory has an read time greater than the attestation protocol time.

Phase 2 can be combined with Phase 3 if the same checksum allows computing checksum from the storage of F and “other” storage sources.

Software Attestation: Phases 1 and 3

At least three alternatives are provided for this protocol stage. In the first alternative, the target device cannot distinguish the pseudo-random data from truly random data, and therefore the pseudo-random data is sent uncompressed. The memory filling excludes the (generally small) subset of processor registers and RAM memory that may be required by the checksum routine to be performed. But the memory filling includes all I/O buffers and R/W registers of peripherals accessible from the CPU. If a certain R/W register is excluded for any technical reason (such as having an unacceptable effect on hardware), then the restriction value n must be incremented accordingly. In certain cases, some external storage memories, such as hard-drives, can be completely excluded. To allow exclusion, the target computing device must have the following properties:

a. The write-read round trip time is much higher than the attestation protocol time.

b. The storage controller uses an I/O buffer (generally DMA) of size higher or equal than n, where n is practical tolerance value of the n-target-incompressible and n-practically-compact properties of the attested data.

c. The verifier accept a cheating probability of 2̂−(n*8) or less.

These requirements for exclusion of phase 1 precludes attacks where the target device issues a write command at the beginning of the attestation protocol and saves the I/O buffer to external storage, then uses the external storage to retrieve all or part of the attested software from external storage, and finally retrieves back the original pseudo-random filling of the I/O buffer. Also this precludes the attack where the target device pre-issues a read command (before the attestation protocol begins) in order to receive attested data during the attestation protocol. If n is small (e.g. 1 byte) then a malware can let the peripheral overwrite the pseudo-random value that will be stored in the I/O buffer, by pre-issuing a read command and afterward try to guess the previous value by choosing any value. For instance, if the I/O buffer is a single byte, the malware may have a 0.39% chance of cheating the verifier.

The pseudo-random data is going to be resent to the verifier at the last stage of the protocol, to prove the filled memory was not used to hold other data. This in turns implies that a malware won't be able to hide itself in the unattested memory. This only leaves the attested memory cells to hide the malware. If the attested memory is n-target-incompressible, then by definition malware won't be able to hide even if it has n additional free cells (e.g. some registers). The only choice for the malware is to compress all or a part of the attested software and leave some free space to hold the modified parts. But if the attested software is practically-compact, the only way to compress it is by using the original data representation, and throwing away the corresponding a part of the attested data. But then, when the attestation procedure required to checksum this part of the attested data, the data won't be ready in memory. Because of the time restriction imposed by the practically-compact property of the attested data, the malware won't be able to generate the attested data fast enough to feed the checksum function and respond on time to the verifier. Thus, malware cannot exists. A single checksum of all the attested software is enough to detect malware. Therefore the SPAT reduces attestation time and provides no possible false negatives or false positives.

The second alternative sub-protocol to fill the target device unattested memory is to transmit only a seed and let the target computing device itself compute the pseudo-random data to fill the required memory. This is advantageous when the target device has a fast processors with slow or noisy communication interfaces and low non-attested RAM. We present two sub-protocols, and two PRNG functions for the second protocol, which is generally superior. In the first sub-protocol, the memory is filled with pseudo-random data produced with one-pass of a CSPRNG, then the target device emits a cryptographic hash of the data in reverse order with multiple passes. If the per-block hash computing time can be detected by the verifier, then the verifier checks that the time it takes by the target device to provide the hash digest is less than (m+1)*h, where m is the number of blocks hashed and h is the hash function time. If the per-block hash computing time cannot be detected, then the verifier asks the target device to perform k passes hash passes on the data, so the time delta k*h can be differentiated from communication jitter. For example, suppose 1 Ghz target device communicating with the verifier over a 115.2 Kbps RS232 link, with 0.2 msec of random jitter, having 1 Mbyte of memory to attest in Flash and 128 Mb of RAM. Suppose we use SHA-256, the hashing block size is 64 bytes, and the target device can hash 800 k blocks/sec. Sending 128 Mbytes of pseudo-random data will take 3.1 hours. In contrast, setting a 0.4 msec threshold limit for response acceptance, verifying the 128 Mbytes containing pseudo-random data by executing the previously described reverse hash protocol requires hashing the RAM 320 times, resulting on a protocol time of 14.9 minutes only. This may still seem excessive.

A better sub-protocol is that the pseudo-random filling is produced by the attested device. This reduces communication if the padding is being supplied by the verifier. The PRNG then must require much time or space to disallow the computation on-the-fly of a block during the attestation protocol. Two functions Time-PRNG and Space-PRNG are presented in following sections.

Software Attestation: Phase 2

This is the core attestation phase. If the device has RF o any non cable communication capability, then the prover has to make sure that the device is not receiving or sending data to other devices not being tested. If the device supports NFC communication only, then the prover must make sure that there not other devices that could collude with the device under test within the NFC reach range. If the device supports a longer range of non cable communication, such as Bluetooth, then the device must have a mechanical switch to turn off these links, or the device must be forced by the hardware to communicate only with a single destination at the time (the verifier).

The properties of target-incompressible and practically-compact data are very difficult to prove for machine code. It can only be proved for very small programs (e.g. 30 instructions in length) and can be reasonably justified (without formal proof) for programs of slight more size (e.g. upto 200 bytes). For greater sizes, machine code can be made practically-compact in most cases by choosing another representation of the data, and transforming it into the machine representation at boot time, or on-the-fly. One of such representations is built by considering the machine data as a set of n-byte blocks, and solving all hash pre-images of a n-byte byte practically one-way function, which should be bijective when restricted to the possible block values encountered. The resulting data string will be called the preimage representation. The SPAT method is well-suited when the target device has a non-volatile memory to store the preimage representation, and a volatile memory to machine code representation where machine code is executed. Standard computers already work like this. High-end microcontrolers also provide ways to execute programs both in Flash and in RAM, so FLASH data can be transferred to RAM during boot time. During this boot process, the one-way function can be applied to each block. During attestation, the RAM should be filled with pseudo-random with the exception of the checksum routine. Nevertheless if the target device can be forced to a cold reset which wipes out RAM externally before the attestation protocol is executed, then the RAM can be kept intact, since a malware in the target device won't be able to profit from the available RAM.

The preimage representation can also be used when the target device is a low-end micro-controller that only executes code from Flash (such as the PIC18 family). For these cases the code is stored both in pre-image representation and machine representation in Flash. When attestation protocol takes place, the machine representation is erased (filled with pseudo-random data) with the exception of the checksum routine, which it itself also subject to attestation. The machine representation is restored after the protocol is over. The same happens if the software to attest is in RAM, and code is executed from RAM, then the attested software may also need to be preserved in preimage representation in RAM. During the attested procedure only the attestation routine is left in machine representation. Since the checksum code is small (e.g. approximately 200 byte) some guarantees can be given about the target-incompressible of the checksum routine.

Also additional security measures, such as computing the checksum using a pseudo-random order, and compressing the machine code before generating the preimage representation can increase considerably potential unknown attack vectors.

Accordingly, the disclosure outperforms other solutions, particularly when the computing device has the following properties:

The verifier can communicate with the computing device (the target device provides message-origin authentication)

The computing device has software which the verifier wishes to attest. This software is stored non-volatile storage.

The attested software is stored in memory that has a relatively uniform access time, throughput an latency, so reads of different parts of the attested memory do not add noticeably jitter to the verifier.

The computing device has an amount of volatile storage known in advance by the verifier.

The computing device has an amount of non-volatile storage known in advance by the verifier.

At least one of the these two conditions hold:

The non-attested software that resides in non read-only memory has an access-time which is higher than the access time taken by the attestation protocol.

The non-attested software that resides in non read-only memory can be freely overwritten during the attestation process.

The unused storage space of the storage shared with attested software can be freely overwritten during the attestation process.

Memory can be completely read by the target device in less time than the attestation procedure time.

At least one of the this two conditions hold:

The computing device has a single communication interface and the verifier is able to detect if, during the attestation protocol, the computing device is trying to transmit to or retrieve information from a third device.

The computing device communicates an I/O buffer of length greater than a threshold and communication round trip time of sending to and receiving data from a third party is greater than the attestation protocol time.

As an example of a device where all these conditions hold:

An ARM COREX micro-controller running at 80 mips

The attested data is held in Flash in a preimage representation.

The device has a bootloader in Flash that transforms the preimage representation to machine code to be executed in RAM.

The communication interface between the verifier and the target device is RS232.

The attested software is 100 Kbytes in length.

The checksum routine requires 40 instructions per byte processed.

The checksum requires therefore 4M instructions, or 50 msec.

Also the disclosure provides the only available method to provide attestation for running systems without using private-keys or a TCM, if the target computing device CPU is improved with the ISOPAGE method.

Software Attestation: Formal definitions

These definitions by no means can be taken as the single possible interpretation of the terms used in this patent application. They only serve as one possible coherent interpretation useful for theoretical characterizations.

Let ARC be a target computing architecture. Let Comp(M) be a compression of the string M under an compression algorithm C. Let Dec(W) be the decompression of the string W under the decompression algorithm Dec, so that M=Dec(Comp(M)). Let size (M) be the size in bits of a string M. Let Dec_{ARC}=MinPrg(Dec,n) be the shortest program written for the architecture ARC that perform the decompression function Dec associated with Comp for the architecture ARC, using no more temporary memory than n bytes. Let time(Dec_{ARC}, M,n) be the time it takes for the decompression routine Dec_{ARC} to decompress M in the architecture ARC when the memory resources are limited to n temporary memory bytes. The time can be given in the number of CPU clocks, in seconds or in the number of instructions cycles executed.

Def: A binary string M is n-target-incompressible in the architecture ARC, if for every pair of algorithms Comp and Dec:

size(MinPrg(Dec,n)∥Comp(M))>size (M)+n

Def: A binary string M is target-incompressible if its 0-target-incompressible

Def: an implemented function f is a binary data string that contains the machine-code that implements the function f by reading the input from memory and writing the output to memory.

Def: a z-blind binary string x is a string which can be created by someone who does not know or cannot obtain the binary data z nor any subset of the data longer than the feasibility threshold, in reasonable time. The threshold depends on the current state of the art of brute-forcing z or applying any algorithm to obtain z from other public data. For symmetric cryptosystems, the threshold should be around a length of 80 bits. We assume that if the creator manages to guess z by brute-forcing then he knows it. Respectively a z-blind implemented function f_{ARQ} is a function whose machine-code representation is z-blind.

Def: A binary string M is n-practically-compact in a hardware architecture ARC, execution time bound b and secret binary strings z, if for any z-blind compression function Comp such that size Comp(M)<size (M) and where Comp(M) is z-blind, and for any associated implemented z-blind decompression function Dec_{ARC} such that Dec_{ARC}(Comp(M))=M:

time(Dec_{ARC}, M,n)>b

The bound b is chosen for each architecture ARC by the firmware code writer (the Designer) so it takes more time to decompress a modified firmware than the time that is given to the device to respond to a challenge (or the time from cold-boot until the time of the challenge response).

Def: A binary string M is practically-compact if it is 0-practically-compact

Def: binary string M is n-practically-incompressible, for an execution time bound b, and secret string z, if at least one of these two conditions is met:

M is n-target-incompressible

M is n-practically-compact

The secret string z represents any private-key or private seed used by the system designer to build the practically-compact representation of the original data. For the definitions to make sense, we must make sure that the attacker does not have access to z. Comp(M) must be z-blind to prevent the definition to allow the encoding of a brute-forcing algorithm in the compression function, since we're not restricting the set of compression functions to the ones that can be practically implemented on standard computing architectures.

Def: binary string M is practically-incompressible if it is 0-practically-incompressible

Def: Let PI(A,b,z) be the set of all strings that are practically incompressible for the architecture A, the time bound b and the secret string z.

We can say “M is practically incompressible in a hardware architecture A and a time bound b and secret information z” simply as: M is in PI(A,b,z).

Suppose we have three types of users: Verifier, Designer, Attacker. We say that a user U has access to the string x if the string is readily available from storage a memory in constant time and the user U does not need to break a security assumption, nor to an infeasible number of steps to obtain x. Now suppose each user U has access to some secret binary string z(U). The Verifier does not have access to the Designer secrets. The Attacker has access to the verifier secrets but not to the Designer secrets. So we may extend the definition of practically incompressibility of binary strings that belong to users. We can say “M is practically-incompressible for user U (and for architecture A, and time bound b)” if M is in PI(A,b,Z), where Z is concatenation of secret binary strings of the remaining users that are not shared nor can be feasibly derived from Z(U).

Software Attestation: Attacker Colludes with Designer

In some circumstances it may be a possible that the attacker colludes with the Designer. To analyze the consequences of this attack, we must assume that the original memories (essentially the program in firmware) is not itself malicious. So we assume that the designer publishes the firmware source code and binaries so everyone can verify the correctness of the software.

Now if we want to M to be practically incompressible for the designer, then we must make sure that there is no hidden compressible information. Preventing hiding information in program memory (“opcodes”) is more easy, since it is generally sufficient to show the high-level source code compiles to the assembler program (deterministic compilation) or to show that every instruction of an assembler program has a clear meaning, with non-random arguments. If the source code of the assembler opcodes is available, along with the required compiler, then everyone can verify that the opcodes does not hold hidden information as long as the source does not. And it is very easy to audit the source code looking for hidden compressible information (it must reside in initialized constants, probably long vectors of values for an unknown functionality, by means of “steganography”).

But attention should be paid to the original memories padding. Padding should have been created in such a way that either:

1—It is incompressible algorithmically (a property called “Algorithmically random sequence”)

2—Use a public verifiable source of random.

3—Is can be compressed, but the time it takes to decompress it is greater than the bound b.

The use of an algorithmically random sequence like Chaitin's halting probability Ω, should be discarded, since creating such sequence is uncomputable. The second is practical. For example, one could take the last 1000 numbers that won the national lottery. The disadvantage is that the users should have access to the historical records of the national lottery to verify the correctness of the firmware. The third has the advantage that it does not require external information, we'll shown in a following section how Space-PRNG can provide a padding string with that property.

Software Attestation: Practical Considerations

Several variants of the scheme can be created depending on the properties of the target device. Here we explore the most relevant.

Software Attestation: Using neither compression nor an asymmetric-time function to achieve practical-incompressibility

The property of data to be practically incompressible is difficult to prove, because it involves finding the smallest executable code fragment that outputs a certain binary string. And this problem, in an unbounded memory and time setting, is undecidable. Nevertheless we can answer if a certain memory is practically uncompromisable with very high confidence. Most part of the non-volatile memory of the a device is used by the program memory. Compression of program memory varies depending the CPU architecture, compression algorithm, decompression performance, and decompression program size. Also, there are compression algorithms specially adapted to executable code compression. In [1] it is claimed that GZIP offers a reduction in the largest reduction of the software size, on average by a factor of 0.44. In [3] compression factors as low as 0.23 are accounted for x86 code. Also [1] the unpacker size varies from 1.5 to 8 KBytes. Other authors [2] made a LZ decompressor fit in 300 bytes, using hand-optimized assembler x86 code (although an equivalent C routine compiled for a PIC 8-bit micro-controller requires more than 2 KBytes). Suppose our device has 400 bytes of FLASH memory that is used to store our original authentic program, which it is made purely of machine opcodes, without any constant variable or tables. Suppose that the best compression ratio for machine code for a certain device ever achieved by a compressor program is 0.4 (final data size is 40% of the original data size). Suppose that this best compressor also has the smallest unpacker size of 300 bytes. And also suppose the unpacker can unpack 400 bytes in less than 1 second. Then the unpacker plus the compressed data will require 460 bytes for storage. Clearly the original program is not practically compressible. For this architecture, almost any firmware will be practically incompressible. But 400 bytes is not realistic for a state-of-the-art microcontroller flash memory size. There is a solutions to make a binary string M practically incompressible by using compression

Software Attestation: Using only compression without an asymmetric-time function to achieve practical-incompressibility

Although there may not appear to be a good reason not to use an asymmetric-time function, a designer may decide not to, for instance to save program memory space. Suppose the target device architecture has the following properties:

A—Can decompress code to RAM and execute it on the fly OR

B—Has enough RAM memory to store the decompressed representation of the attested-memory.

For B the target device should allow the execution from both non-volatile and volatile memory. The attested data containing the program must be stored in a compressed form in non-volatile memory, and this memory is uncompressed into the volatile memory at start-up or when execution of some part is required. Many microcontrollers allow for storing code in FLASH, copy it to RAM, and execute it there, in order to avoid the performance penalty of fetching each instruction from FLASH memory.

As previously described, the solution is to store the compressed form of the original string A, along with the unpacker code (and with enough padding to fill the memories) in non-volatile memory (the string F), and uncompressed it to volatile memory when it is necessary to execute it.

If the compression ratio achieved by the designer compression program is not optimal, then still an attacker has to manage to achieve a higher ratio and store the attacker unpacker program (along with any other malicious code) in the free space left by the difference of space freed. But now, to be able to respond to the verifier challenge to send the attested memory, the memory must hold the attackers decompression routine and the original compression routine (which must produce a result that matches exactly the original compressed form). This is actually more challenging, since the designer may have used a 500 KBytes program, running on a 1 GHz CPU, left running over a whole day, and using 1 Gb of RAM to compress the plain original memories A into a string D of its lowest possible size. Then the attacker must reproduce this compression in a microncontroller in a few seconds, running a 80 Mhz CPU, with a program of minimal size, and almost no RAM memory. It may be the case that compressing under this limited resources produces a compressed string D′ that does not differ much from the original string D, and so an ad-hoc compression method could turn D′ into D, but this is highly improbable.

Also it is possible that the attacker reuses the same decompression routine (or parts of this routine) and uses a more powerful algorithm to compress A offline before deploying it. Nevertheless, it still needs to add the re-compression routine, which was not present in A before.

Let's show an example, suppose that A (the uncompressed authentic memory) is 32 Kbytes long, and the device designer achieved a compression ratio of 0.40, and the designer unpacker size is 2 Kbytes. Then A compressed is only 32*0.4+2=14.8 Kbytes. The remaining space is filled with practically incompressible padding. Suppose that the attacker manages to compress A using a new algorithm developed by the attacker, achieving a 0.39 compression ratio. Then the resulting compressed string is (32+2)*0.39=13.26 Kbytes. The attacker also has to add the re-compression routine. Suppose the re-compression routine is 2 Kbytes long. Then the attacker would require 15.26 Kbytes to store the counterfeit replacement for A, which is impossible since the space to hold A was restricted to 14.8 Kbytes.

It is important that the designer chooses the optimal existent technology to compress the memory A, since any significant improvement would render the protection worthless. Also important the time taken to compress M is generally not as important, as long a the decompression is fast. For example, the PAQ8HP8 algorithm outperforms almost any competitor, although the compression running time can be as 600 times slower than other standard algorithms [4]

Also it is important to note that if an attacker manages to compress A more than the designer can, and an effective attack is executed, and then the designer may be able to access the counterfeit device and explore its memory content. If the attacker uses a new algorithm for the unpacking routine, then the designer may be able to reverse engineer the unpacking routine and possibly provide the same level of compression for the next release of the device, rendering any new attempt to attack much more difficult for the same attacker.

Last, it is also important that the decompression routine provided by the designer is stored in uncompressed form. If this routine is big enough (say more than 1 Kbyte), then it could be possible to compress the decompression routine using an algorithm that requires a much shorter decompression routine. In that case, the designer must decompress in two stages: first decompress the second decompression routine using a first shorter decompression routine, and then decompress the remaining content using the second decompression routine.

Software Attestation: Using only an asymmetric-time function to achieve practical-incompressibility

Compression may need to be eliminated to reduce boot time. If compression is not applied before applying the “hard” direction of the asymmetric-time function at design time, then the designer must assure that no two input blocks of the asymmetric-time function repeat. If input blocks repeat, then output blocks will be equal or equivalent, and therefore the resulting string will be statistically compressible. To prevent repetitions, input blocks can be rearranged, inserting empty gaps or NOPs to make blocks slightly different while keeping the program functionality intact. Also block chaining can be used. As a third option simple random perturbations can be applied to differentiate the blocks, but this requires a perturbation-restore routine to be executed after the “fast” direction of the asymmetric-time function is executed at boot time.

Software Attestation: Private Storage

Some devices may be storing private binary strings which do not want to overwrite during the attestation protocol. If the private binary strings size is less than few hundred bytes, then it is possible that the memory holding these private strings is left untested. The designed count he private storage size in the n value of the n-practically-incompressible property of the attested data during system design. If the private memory has a higher size, them the target device can encrypt the private data and send the encrypted private data (with the exception of the encryption keys) to the verifier to be stored temporarily during the attestation protocol. The data will be sent back by the verifier to the target device after the protocol is over, when the target device will check the integrity of the private data, decrypt it, and store it again in the required storage.

Software Attestation: Variants of the Basic Protocol

Now we'll show variants of the protocol phase 2 that allows a device (“prover”) to prove a user (“verifier”) that the firmware and additional memories stored on the device are authentic (they have not been tampered). The verifier uses a trusted computer to receive and verify the responses sent by the device. Also the verifier either knows the contents of the authentic memories, or has a hash of each block of those memories, provided by the designer. This gives us two possible protocols:

Software Attestation: Protocol PA (the verifier has a copy of the original memories)

Let M′ be the original binary string that should be found on the target device. This corresponds to the string F in the generic setup and generic attestation protocol (it is only a change of nomenclature)

Let M be the string that consist of the attested non-private memories of the token, concatenated in the same predefined order as the M′.

Let P be the strings contained in the unattested memory that must be filled with padding.

Let P′ be the padding of unattested memory as computed by the verifier.

3—The verifier chooses a random binary string C (the challenge) and sends C to the token. it waits a predefined short amount of time for the answer, such as 1 second.

2—The device computes R=Hash(C∥M∥P), where R is the response. The device sends R to the verifier.

3—The verifier (who has knowledge of M′, because it is provided by the designer) computes R′=Hash(C∥M′ ∥P′). Then the verifier compares R and R′. IF they are unequal, the firmware has been modified.

4—The verifier verifies that the response received is within the time bound b. If not, then the firmware cannot be considered authentic, and the test should be repeated.

As previously stated, P represents the memory buffers that are specially manufactured to hold private data, but are not holding private data at the moment, and must also be filled with padding and must be appended to M.

If the response is not received within the specified time, the test can be repeated. If it fails multiple times, then the firmware is assumed to have been tampered.

Software Attestation: Protocol PB—Designer keeps original binary string secret

It may be the case that the designer does not want to make the original memory content of the target device public, and the attested binary strings are kept private. We'll show protocols that allow the verifier to prove the memories have not been tampered without the knowledge of the original memories content. Instead of M′, the designer gives the verifier a long binary message Q′ where the size of Q′ is greater or equal than the size of the original memories. The verifier will use M′ instead of Q′ to compute it is own checksum.

The message Q′ has the following properties:

1. As the original memories, Q′ cannot is practically-incompressible.

2. Q′ has the same properties as a cryptographic hash message digest of M′ (it should be infeasible to obtain M′ from Q′, and Q′ should be indistinguishable from random)

3. Can be computed by the device using M′ as input, where the code to compute Q′ from M′ either resides in ROM, is fixed in hardware modules, or is contained in M′ itself.

The protocol is exactly the same as protocol A, but instead R is computed as R=Hash(C∥Q∥P) (an also R′ is computed in a similar way).

We'll give three possibilities for the algorithm to compute Q from M:

B1) To build the message D, it is broken into blocks of fixed length in the following sequence: D(1) . . . D(n).

Let M[i] be the binary string M divided in fixed-length blocks suitable to be inputs of a hash function.

Then Q(i)=Hash(M[i])

Note that block-chaining is not required. Since M is practically incompressible, there is a very low probability of two different blocks of M being equal (M[i]=M[j] for i< >j). Then it won't be possible to an attacker to try to create a code book to infer properties of M.

2) Let k=private-key, stored in the device ROM or in M′ or computed as k=Hash(M)

Then Q=CTR-Encrypt(k,M), with a zero IV.

3) Use a hash function with unlimited digest length, such as SHA-3 (Keccak). Let S be a Keccak hash digest of M, with the same length as M.

S=Keccak-hash (M)

Q=Bit-xor(M,S)

If the token is battery-powered, than all volatile memories must be included in M, because they may contain program memory temporarily. If the token/device is not battery-powered, then volatile memory can be excluded from the check as long as the verifier is assured that the device was powered-off and no communication with other devices has taken place before the proof protocol begins. It is also possible to assure the volatile memory is unused by the protocol D described later.

Software Attestation: Protocol PC

1. The verifier chooses a random string C of length v and sends C to the device.

2. The device computes h=ReverseHash(C) and sends h to the verifier

3. The verifier computes h′=ReverseHash(C) and verifies that h=h′

It is clear that the microcontroller must store the values C[0] . . . C[d−2] somewhere in order to hash the block C[d] and so all previous values in RAM must be overwritten with C[0] . . . C[d−2].

The same protocol can be used to prevent an attacker provided decompression and compression routines to use any RAM. By executing the protocol B between the step 2 and 3 of protocol C, and by keeping the last block of C hidden until step 3, we force the firmware to either waste all RAM, or to copy the string C temporarily to non-volatile memory. Both compression and decompression routines require the use of RAM tables. State-of-the art compression algorithms may require much more RAM memory than decompression routines, in the order of megabytes.

Software Attestation: Protocol PD

1. The verifier chooses a random string E of length v and sends almost all E to the device, with the exception of the last block of length h of E (e_last). h should be not less than 80 bits.

2. Execute the protocol B.

3. Send e_last to the device

4. The device computes h=ReverseHash(E) and sends h to the verifier

5. The verifier computes h′=ReverseHash(E) and verifies that h=h′

6. Re-verify the time bound b for the executed protocol. Abort if used time is greater that bound b.

To implement these protocol you have to known well your target micro-controller architecture. There are three types of architectures:

Architecture allows the execution of code from normal RAM and Flash.

Architecture does not allow the execution of code from normal RAM, but executes code non-volatile memory only, such as a FLASH memory.

Architecture allows the execution of code from normal RAM and not from any other type of non-volatile memory, such as Flash

If architecture allows the execution of code from normal RAM and Flash memory (case 1), then the firmware should be practically-incompressible, with the exception of the protocol PD. Code should be uncompressed and copied to RAM, with the exception of the routine that implements the protocol PD, that should be run directly from Flash memory. During the execution of the protocol, all volatile memory should be filled with random.

If architecture allows the execution of code from normal RAM and not Flash (case 3), then the firmware should be practically-incompressible, and the constant v should be the total number of volatile bytes available not counting the bytes required for the uncompressed routine for the protocol PD. During the execution of the protocol, all volatile memory should be filled with random except for a small area of memory that stores the protocol PD routine. All the remaining parts of the firmware should remain uncompressed in the non-volatile memory.

If the architecture does not allow the execution of code from normal RAM (case 2), then clearly the firmware that contains the opcodes should not be left in machine-representation. Nevertheless we can still use the time bound to distinguish between a device that reads the Flash memory and hashes it and a device that reads the Flash memory, uncompress it and hashes it. The best way to increase the time difference between these two processes is by requiring the Flash memory to be hashed in a random order. The resulting protocol is similar to protocol PD but instead of calling protocol PA, it calls protocol PA′. This protocol hashes almost all the memory in a random order. Since high ratio decompression requires the knowledge of a dynamic context, it requires compression to be carried out in blocks. If not, then a fixed compression context would be necessary and that context would have to be stored in the non/volatile memory itself.

Let MaxNVM be the amount of non-volatile memory. We will require a pseudo-random function R with a seed size greater than the log 2(MaxNVM) (it doesn't need to be cryptographically secure RNG). A normal LCG with 32-bits seed will do. Another possibility is replacing R by a pseudo-random permutation function such as using a generator of the F₂ₘ field, where 2̂m is equal to MaxNVM.

Software Attestation: Protocol PA′

The device informs the verifier how much of the private memory is using.

The verifier checks that this in fact the device is expected to use that amount of private memory.

The verifier chooses a random binary string C (the challenge).

The verifier chooses a random seed s, a length l and sends (C,s,l) to the token. It waits a predefined short amount of time for the answer, so it can distinguish between an decompression process and a normal memory fetch process.

The device seeds the function R with s, s to obtain 1 values in the range [0 . . . MaxNVR−1] when needed, where The random values are not precomputed (since there is no memory to store them) but computed on-the-fly.

The device computes R=Hash(Q∥M∥P), where R is the response, and Q is a stream of bytes where each byte is taken from the non-volatile memory where the byte indexes are taken from R as explained. The device sends R to the verifier.

The verifier (who has knowledge of M′, because it is provided by the token issuer) computes Q, and R′=Hash(Q∥M′ ∥P′). Then the verifier compares R and R′. If they are unequal, the firmware has been modified.

The verifier verifies that the response received is within the time bound b. If not, then the firmware cannot be considered authentic, and the test should be repeated.

The length 1 should be chosen by the user so that almost all the memory is checked with high probability and the process time is amplified enough to distinguish between the two processes. Generally one would have 1>=2*MaxNVM.

If you want 1=MaxNVM or very close to, then you should use a pseudo-random permutation to cover all the elements in non-volatile memory. Generally a few rounds of a fast block encryption algorithm will do, since we don't need the cryptographic properties (e.g. TEA). It is best if you choose a cipher with a light key schedule and the key is provided by the verifier or you strip the key schedule off, and the verifier provides the expanded key directly. This is an example algorithm of how to do a random permutation:

Let A[i] be a permutation of [0..255] specified by a table indexed by
i.
Let X(0), ..., X(n−1) an initial assignment of n byte values.
Let Y(0), ..., Y(n−1) an initial assignment of n byte values.
PseudoPerm
n*8 bit Pseudo-Random Permutation Generation Algorithm
This Permutation Generation Algorithm is a multi-word bijective
triangular function.
Fixed by verifier: A : Permutation; X, Y :array of byte
Input: i :integer
Temporary vars: Tmp :array of byte
Output: B(0), ..., B(n−1) interpreted as a single n*8 bit integer

number, where B(0) is the less significant byte

1. For each 0<=j<=n−1 do:
1.1. Tmp[j] = Y[j] XOR A[X(j) XOR ((i>>(8*j)) & 0xff)]
2. B(0) = Tmp[0]
3. For each 1<=j<=n−1 do:
3.1. B(j) = B(j−1) XOR Tmp[j]

If the memory to verify is not an exact power of 2, then you can choose the lowest power of two higher than the memory size, and take the division remainder over the memory size. Some memory words will be read twice, but that's not a problem.

To summarize, these are examples of architectures (without hardware assisted isolated-page) where the SPAT attestation method excels. For all architectures the best protocol in terms of security is protocol PD, but some other simpler protocol may be used as shown in the last column.

TABLE 3
Architectures and Protocols

| | | | Can the | | |
|---|---|---|---|---|---|
| | | | software | | |
| | FLASH | RAM | power- | Communication | |
| | MEMORY | MEMORY | down the | channel | |
| CPU | SIZE | SIZE | device? | bandwidth. | Recommended protocol |
| any | Medium | Medium | any | High | Use generic setup |
| | (<100 | (<100 | | (>100 | Use protocol P0 |
| | Kbyte) | Kbyte) | | Kbyte/ | |
| | | | | sec) | |
| any | Small | Small | any | low | Use generic setup |
| | (<1 Kbyte) | (<1 Kbyte) | | | Use protocol P0 |
| any | Small | any | any | low | Store M uncompressed. |
| | (<1 Kbyte) | | | | Use practically incompressible padding |
| | | | | | Verify execution time bound b. |
| | | | | | Use protocol PA |
| Very | any | any | any | low | Store M uncompressed |
| slow | | | | | Use practically incompressible padding |
| | | | | | Verify empty RAM before main protocol. |
| | | | | | Check that the device responds withing a tight |
| | | | | | time bound b. |
| | | | | | This prevents on-the-fly |
| | | | | | compression/decompression. |
| | | | | | Use protocol PA |
| any | any | Small | yes | low | Store a practically-incompressible M in FLASH |
| | | (<512 bytes) | | | Use practically incompressible padding |
| | | | | | Verify execution time bound b. |
| | | | | | Use protocol PB |
| any | any | any | any | low | Store a practically-incompressible M in FLASH |
| | | | | | Use practically incompressible padding |
| | | | | | Verify execution time bound b. |
| | | | | | Use protocol PD |

Software Attestation: Time-PRNG

Time-PRNG is a method to create practically incompressible padding by making padding compression/decompression take too long. We start by dividing the padding in blocks, where each block size corresponds to the size of the message digest of a standard cryptographic hash function, such as SHA-2. Let pad[i] be padding block i. Then pad[i] is constructed as pad[i]=Hash^{N}(i), where Hash^{N}( ) is the application of the cryptographic hash function N times (where each application except for the first one is applied to the previous hash digest). N must be large enough that the time taken to generate pad[n] exceeds the time given to the device to send the response. For example, N can be made so the CPUs in the target device takes at least 1 minute to compute each padding. Since the target device computing processing power may be much lower than a general purpose computer processing power, a computer can verify that the designer provided padding was generated as specified in a few seconds of computer processing without actually storing the padding.

Software Attestation: Space-PRNG

The Space-PRNG function works on fixed sized blocks, and creates a pseudo-random data string in k-passes, where each pass builds each block as a hash digest of a subset of the blocks from the previous pass (plus some optional additional salt data), with the exception of the first pass that is generated from a random seed provided by the verifier. Also each block in each non-final pass must be at least used at the first block of a hash digest of the following pass. This way there is no subset of the blocks nor intermediate hash function states that can be used from a pass to compute the following pass. A good option is that each block is computed as the hash of all the blocks of the previous pass starting with the block at the same block index in memory (considering the memory of each pass as a circular buffer). As result, if b blocks are hashed, to generate on-the-fly a block of the resulting the data, it is required either to compute at least that block hash digest, which requires access to additional b blocks in memory (the blocks from the previous pass), which is worse for the attacker than storing the block digest itself. As a result, to attest that the target device has stored the result of k-Space-PRNG sequence, the verifier only needs to verify that the sequence has been generated and that the target device does not have enough time to regenerated it again during the attestation protocol. Taking the previous example as reference, suppose also that the phase 2 steps of the attestation procedure take 50 msec to complete, then the memory should take at least 50 msec in being filled by Space-PRNG. If the expected jitter is 10 msec, taking k=4, the filling would take 163 msec, which is satisfactoy.

Software Attestation: Comparison between ISOPAGE and other hardware-assisted attestation methods

### FURTHER REFERENCES

[1] Efficient Sensor Network Reprogramming through Compression of digest Executable Modules (http://www.sics.se/˜adam/tsiftes08efficient.pdf)
[2] http://fgiesen.wordpress.com/2011/01/24/x86-code-compression-in-kkrunchy/
[3] http://www.maximumcompression.com/data/exe.php
[4] http://en.wikipedia.org/wiki/PAQ)

In the following description, the system involving a target computing device with the ISOPAGE method will be described. The target device comprises a communication channel with the verifier, with integrated RAM and FLASH memories. The FLASH memory of the microcontroller is used to store the firmware. The microcontroller is programmed in firmware with routines to:

receive a challenge value though an I/O interface.

Setup an environment where the COAR can run by loading the COAR intro a memory area, storing the challenge value on registers, and jumping to an entry point in the COAR.

Execute a COAR routine which contains code to enable SUHFs, setup the protection barriers to create an isolated page around the COAR, and computes an integrity digest of some memory.

Execute a boot loader that reads data from FLASH memory, process the data with an asymetric-time routine in the “fast” direction, uncompress the data and stores the resulting data on RAM.

Execute a system initialization program on RAM.

To summarize, we show a software attestation method (SPAT) and hardware assisted software attestation method (ISOPAGE). They can be described as:

An apparatus comprising a target computing device configured to provide a software attestation protocol where the attested software is practically incompressible.

An apparatus comprising a target computing device with access to memory and access to communication means configured to provide a software attestation protocol where the attested software protocol consist of: receiving data from the communication means;

filling the volatile memory with the received data;

sending a dump of all the memory of the target computing device.

An apparatus comprising a target computing device with access to non-volatile memory configured to provide a software attestation protocol and a second computing device configured to attest the first computing device, where

the second device sends a challenge value to the first device;

the first device derives from the challenge value a seed of function that iteratively generates addresses of the non-volatile memory;

the first device derives from the challenge value a and a prefix value;

the first device computes a hash of: the prefix value concatenated with the contents of the cells of the non-volatile memory at the addresses generated by the function that iteratively generates addresses of the non-volatile memory.

An apparatus comprising a target computing device with access to non-volatile memory configured to provide a software attestation protocol and a second computing device configured to attest the first computing device, where

the second device sends a challenge value to the first device;

the first device derives from the challenge value a seed of function that iteratively generates addresses of the non-volatile memory;

the first device derives from the challenge value a and a prefix value;

the first device computes a hash of: the prefix value concatenated with the contents of the cells of the non-volatile memory at the addresses generated by the function that iteratively generates addresses of the non-volatile memory.

An apparatus comprising a target computing device with access to non-volatile memory configured to provide a software attestation protocol where

the target computing device receives a challenge value;

the target computing device uses the challenge value to generate a function that iteratively generates addresses of the non-volatile memory;

the target computing device derives a prefix value from the challenge value;

the target computing device computes an integrity digest of: the prefix value concatenated with at least all or a subset of the contents of the cells of the non-volatile memory at the addresses generated by the function that iteratively generates addresses of the non-volatile memory;

the integrity digest is transmitted

An apparatus comprising a target computing device having a special-purpose hardware module, where the target computing device is configured to provide a software attestation protocol stored in an isolated memory area where:

the software running on the isolated memory area cannot read outside the isolated memory area;

the software running on the isolated memory can communicate with a special-purpose hardware module that performs a known operation without secret keys;

One of the apparatus defined above where the software running outside the isolated memory area cannot receive information from the special-purpose hardware module;

the software running outside the isolated memory area cannot write to the isolated memory area

One of the apparatus defined above where a normal memory area can be selected as the isolated memory area and the isolated memory area can be deselected and become a normal memory area.

One of the apparatus defined above where the software running on the isolated memory area cannot communicate with any I/O peripheral, nor it can read other storage except the isolated page itself.

One of the apparatus defined above where the target device has a hashing routine stored in ROM which can be called from software running in the target device.

One of the apparatus defined above where the apparatus is configured to execute a boot loading routine which reads memory cells from non-volatile memory, operated over the read values using the “fast” direction of an asymmetric-time function, and store the results of the operations on RAM.

One of the apparatus defined above where the apparatus has access to ROM, and the boot routine is stored in ROM.

One of the apparatus defined above where the special-purpose hardware module performs a function on an input value provided and outputs another value available to the code running on the isolated page, where the function can be performed in hardware in a single instruction clock.

One of the apparatus defined above where there is a second isolated memory area that has the property that the software running outside the second isolated memory area cannot write to the second isolated memory area.

One of the apparatus defined above where the target device has an integrity digest digest computing routine stored in the isolated page.

One of the apparatus defined above where the target device has an integrity digest computing routine stored in ROM which can be called from software running in the target device.

An apparatus comprising a target computing device with access to memory and access to communication means configured to provide a software attestation protocol where the attested software protocol consist of:

receiving a seed from the communication means;

filling the volatile memory with pseudo-random data derived from the received seed;

sending a dump of all the memory of the target computing device.

An apparatus comprising a target computing device with access to memory and access to communication means configured to provide a software attestation protocol where the attested software protocol consist of:

receiving data from the communication means;

filling the volatile memory with the received data;

sending a integrity digest of all the memory of the target computing device thought the communication means

A method to produce a practically-incompressible data by transforming a work data with at least the following operations:

inserting a challenge-response routine into the work data;

transforming the data by passing it though the “slow” direction of an asymmetric-time function;

The method defined above where these additional operations are performed on the data:

compressing the work data in any previous transformation stage;

inserting a decompression routine into the work data;

A method defined above where an additional operation is performed on the work data which consists of inserting a boot loader routine that uses the an asymmetric-time function in the “fast” direction into the work data;

A method defined above where an additional operation is performed on the work data, which consists of inserting a pseudo-random or random padding into the work data.

Exemplary Computer System

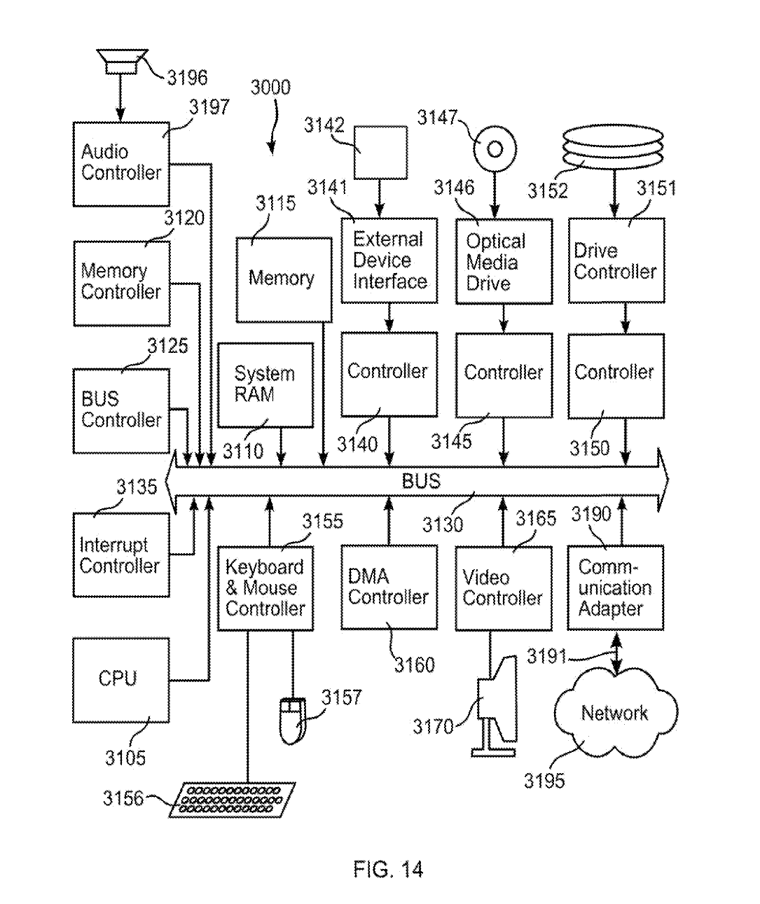

FIG. 14 illustrates the system architecture for a computer system 3000, such as a process controller, or other processor on which or with which the disclosure may be implemented. The exemplary computer system of FIG. 14 is for descriptive purposes only. Although the description may refer to terms commonly used in describing particular computer systems, the description and concepts equally apply to other systems, including systems having architectures dissimilar to FIG. 10. Computer system 3000 can control temperatures, motors, pumps, flow rates, power supplies, ultrasonic energy power generators, and valves, using actuators and transducers. One or more sensors, not shown, provide input to computer system 3000, which executes software stored on non-volatile memory, the software configured to received inputs from sensors or from human interface devices, in calculations for controlling system 200.

Computer system 3000 includes at least one central processing unit (CPU) 3105, or server, which may be implemented with a conventional microprocessor, a random access memory (RAM) 3110 for temporary storage of information, and a read only memory (ROM) 3115 for permanent storage of information. A memory controller 3120 is provided for controlling RAM 3110.

A bus 3130 interconnects the components of computer system 3000. A bus controller 3125 is provided for controlling bus 3130. An interrupt controller 3135 is used for receiving and processing various interrupt signals from the system components.

Mass storage may be provided by DVD ROM 3147, or flash or rotating hard disk drive 3152, for example. Data and software, including software 400 of the disclosure, may be exchanged with computer system 3000 via removable media such as diskette, CD ROM, DVD, Blu Ray, or other optical media 3147 connectable to an Optical Media Drive 3146 and Controller 3145. Alternatively, other media, including for example a media stick, for example a solid state USB drive, may be connected to an External Device Interface 3141, and Controller 3140. Additionally, a device 100 in accordance with the disclosure may be connected to computer system 3000 through External Device Interface 3141, for example by a USB connector, BLUETOOTH connector, Infrared, or WiFi connector, although other modes of connection are known or may be hereinafter developed. A hard disk 3152 is part of a fixed disk drive 3151 which is connected to bus 3130 by controller 3150. It should be understood that other storage, peripheral, and computer processing means may be developed in the future, which may advantageously be used with the disclosure.

User input to computer system 3000 may be provided by a number of devices. For example, a keyboard 3156 and mouse 3157 are connected to bus 3130 by controller 3155. An audio transducer 3196, which may act as both a microphone and a speaker, is connected to bus 3130 by audio controller 3197, as illustrated. It will be obvious to those reasonably skilled in the art that other input devices, such as a pen and/or tablet, Personal Digital Assistant (PDA), mobile/cellular phone and other devices, may be connected to bus 3130 and an appropriate controller and software, as required. DMA controller 3160 is provided for performing direct memory access to RAM 3110. A visual display is generated by video controller 3165 which controls video display 3170. Computer system 3000 also includes a communications adapter 3190 which allows the system to be interconnected to a local area network (LAN) or a wide area network (WAN), schematically illustrated by bus 3191 and network 3195.

Operation of computer system 3000 is generally controlled and coordinated by operating system software, such as a Windows system, commercially available from Microsoft Corp., Redmond, Wash. The operating system controls allocation of system resources and performs tasks such as processing scheduling, memory management, networking, and I/O services, among other things. In particular, an operating system resident in system memory and running on CPU 3105 coordinates the operation of the other elements of computer system 3000. The present disclosure may be implemented with any number of commercially available operating systems.

One or more applications, such as an HTML page server, or a commercially available communication application, may execute under the control of the operating system, operable to convey information to a user.

All references cited herein are expressly incorporated by reference in their entirety. It will be appreciated by persons skilled in the art that the present disclosure is not limited to what has been particularly shown and described herein above. In addition, unless mention was made above to the contrary, it should be noted that all of the accompanying drawings are not to scale. There are many different features to the present disclosure and it is contemplated that these features may be used together or separately. Thus, the disclosure should not be limited to any particular combination of features or to a particular application of the disclosure. Further, it should be understood that variations and modifications within the spirit and scope of the disclosure might occur to those skilled in the art to which the disclosure pertains. Accordingly, all expedient modifications readily attainable by one versed in the art from the disclosure set forth herein that are within the scope of the present disclosure are to be included as further embodiments of the present disclosure.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. A method for constructing a token representing a right, the method comprising the steps of:
[1.1] constructing an enclosure adapted, when in a closed condition, to be easily susceptible to visible damage upon any attempted intrusion into the enclosure; and
[1.2] enclosing within the enclosure:
[1.2.1] a memory adapted to store:
[1.2.1.1] a unique key; and
[1.2.1.2] an association indicia adapted to be set in selected one of a first state representing an association of the key with the right and a second state representing a disassociation of the key with the right;
[1.2.2] a communication facility adapted to receive a selected command and to transmit a response;
[1.2.3] an indicator visible from outside the enclosure, adapted to display a selected one of a first state if the association indicia stored in the memory is in the first state, and a second state if the association indicia stored in the memory is in the second state; and
[1.2.4] a computing device coupled to the memory, the communication facility and the indicator, the computing device being adapted to perform, in response to the command, the steps of:
[1.2.4.1] reading the key from the memory;
[1.2.4.2] transmitting the response via the communication facility, the response comprising a function of the key; and
[1.2.4.3] setting the association indicia stored in the memory to the second state;
[1.2.5] a power facility adapted to supply operating power to the processor, the memory, the communication facility and the indicator;
wherein the token guarantees the association of the key with the right if and only if the indicator displays the first state and the enclosure displays no visible damage indicative of an attempted intrusion.

46. The method of claim 45, further including the steps of.
[1.3] forming inside the enclosure a substantially unique, multi-dimensional pattern of particles detectable from outside the enclosure;
[1.4] recording a first view of the pattern from a selective perspective;
[1.5] storing, outside the enclosure, the recording the first view of the pattern; and
[1.6] selectively comparing a second view of the pattern to the stored recording of the first view of the pattern to detect differences therebetween indicative of an authenticity of the enclosure.

47. The method of claim 45 wherein in step [1.2.1] the memory is further characterized as non-transitory.

48. The method of claim 45 wherein in step [1.2.2] the communication facility is further characterized as adapted wirelessly to receive the selected command and to transmit the response.

49. The method of claim 45 wherein in step [1.2.2] the communication facility is further characterized as adapted electrically to receive the selected command and to transmit the response.

50. The method of claim 45 wherein the power facility comprises a selected one of a battery and a radiated energy harvester.

51. The method of claim 45 wherein the indicator comprises a selected one of a light emitting facility, a sound emitting facility, and a tactile emitting facility.

52. The method of claim 45 wherein the key comprises a selected one of an internally generated code, an externally generated code, and a private key of a selected public-private key pair.

53. The method of claim 45 wherein the communication facility is prevented from transmitting a function of the key if the association indicia is in the first state.

54. The method of claim 45:
wherein the memory is further characterized as adapted to store a selected certificate of association indicative of the association of the key with the right;
wherein the communication facility is further characterized as adapted to receive the certificate of association; and
wherein the computing device is further characterized as being adapted to perform, in response to the certificate of association, the steps of:
[1.2.4.4] storing in the memory the received certificate of association;
[1.2.4.5] storing in the memory the association indicia in the first state; and
[1.2.4.6] selectively transmitting the stored certificate of association via the communication facility.

55. The method of claim 45:
wherein the communication facility is further characterized as being adapted to receive a challenge and to transmit a proof of possession of the key in the memory; and
wherein the computing device is further characterized as being adapted to perform, in response to the challenge, the steps of:
[1.2.4.7] calculating the proof of possession as a function of the key and the challenge; and
[1.2.4.8] selectively transmitting the calculated proof of possession via the communication facility.

56. The method of claim 45:
wherein step [1.2] is further characterized as enclosing within the enclosure a confirmation input facility adapted to be activated from outside the enclosure; and
wherein the computing device is further characterized as being adapted to perform, only in response to an activation of the confirmation input facility, a selected one of steps [1.2.4.1], [1.2.4.2], [1.2.4.3], and, in addition, to perform the further step of:
[1.2.4.9] calculating a function of the key.

57. A token adapted to practice the method of any of claims 45 to 56.

58. An electronic system comprising a token according to claim 57.

59. A computer readable medium including executable instructions which, when executed in a processing system, causes the processing system to perform according to step [1.2.4] of claim 45.
